(19) United States
(12) Patent Application Publication
(10) Pub. No.: US 2024/0295484 A1
(43) Pub. Date: Sep. 5, 2024

(54) METHOD AND DEVICE FOR HIGH-THROUGHPUT SINGLE-FILE FOCUSING OF POLYDISPERSE PARTICLES

(71) Applicant: The University of Hong Kong, Hong Kong (CN)

(72) Inventors: Kevin Kin Man TSIA, Hong Kong (CN); Chak Man LEE, Hong Kong (CN)

(21) Appl. No.: 18/582,156

(22) Filed: Feb. 20, 2024

Related U.S. Application Data
(60) Provisional application No. 63/486,053, filed on Feb. 21, 2023.

(51) Int. Cl. G01N 15/1409; G01N 15/10; G01N 15/14; G01N 15/1404; G01N 15/149

(52) U.S. Cl. CPC G01N 15/1409; G01N 2015/1006; G01N 2015/1413; G01N 15/149; G01N 2015/1493

(57) ABSTRACT

A high-throughput single-file focusing system and methods for polydisperse particles are provided. The system includes a microfluidic device for pre-focusing the polydisperse particles and a high-aspect-ratio (HAR) rectangular structure coupled to the microfluidic device. The microfluidic device includes a fluidic channel configured to localize distributions of the polydisperse particles in a cross-sectional area of the fluidic channel. The dimensions of the fluidic channel are configured to generate a converging secondary flow having four spiral vortices that drives the polydisperse particles to flow inward following a spiral path to be concentrated into a center of each spiral vortex such that the polydisperse particles are focused by the converging secondary flow without any inertial force. The coupled HAR rectangular structure receives the pre-focused polydisperse particles and further confines the particles to form a single file on its mid-plane.

### CROSS-REFERENCE TO RELATED APPLICATION

This application claims the benefit of U.S. Provisional Application Ser. No. 63/486,053, filed Feb. 21, 2023, which is hereby incorporated by reference in its entirety including any tables, figures, or drawings.

### BACKGROUND OF THE INVENTION

In many microfluidic device developments and applications, particle focusing in continuous fluidic flow plays a critical role in enabling downstream particle manipulation and analysis at high precision and efficiency. Traditionally, active focusing methods, such as hydrodynamic focusing, enable high-precision particle ordering but at the expense of complex fluidic control systems. On the other hand, a passive focusing method, called inertial focusing (IF), orders particles in a microchannel purely by a pressure-driven high-speed fluid flow.^{[1,2]} This simplicity has galvanized burgeoning applications of inertial microfluidics in different arenas, including life science research, biomedical diagnostics/treatments, and biotechnology.^{[2]}

So far, IF has shown distinct promise in applications that demand high-throughput particle separation based on sizes, such as isolation of cancer cell^{[3,4]} and malaria parasites^{[5,6]} from body fluid. This success is made possible by its unique and inherent property—dispersed positioning of particles according to their sizes, which is termed dispersion. This effect results from the two fundamental forces in IF that involve the interactions between fluid, particles, and microchannel (i.e., shear-gradient-induced, and wall-induced lift forces). Consequently, the particle size strongly influences the equilibrium positions (foci) of the inertial force field—resulting in dispersion, i.e., particles with different sizes are focused at different positions^{[7-9].} This dispersion is shown in different forms according to the channel designs. In the context of single-file focusing (equivalently single-plane focusing), it can be given by a straightforward geometry, a long rectangular pipe that has a cross-sectional aspect ratio (AR) largely deviated from unity.^{[8,9]} The dispersion results in focusing large particles into a single plane at the center of the long walls while focusing small particles into the same plane with spurious streams near the short walls.^{[8,9]} State-of-the-art microfluidic approaches with more complex designs incorporate additional force fields, such as secondary flow drag force and viscoelastic force, to shape the dispersion.^{[10,12]} The fact that secondary flow can be simply introduced by tailoring the channel geometry (for example, serpentine^{[13-17]}, spiral^{[18-21]}, expansion-contraction (or known as multi-orifice)^{[22-26]}) makes it the most popular option. The dispersion in these existing approaches results in a precise separation of particle according to their sizes. In other words, polydisperse particles are separated according to their sizes into multiple files instead of focused into a single file. This size-dispersion phenomenon, which is inherent to the majority of advanced IF systems (for example, the ones based on secondary flow), on one hand, results in a high precision of sorting polydisperse particles by sizes, nevertheless on the other hand sacrifices the precision of focusing them into a single file.^{[27,28]} As a result, the existing IF systems are not robustly free of dispersion. It remains challenging for IF to benefit the real-life scenarios where heterogeneous (or polydisperse) particle analysis or manipulation based on size alone could be ineffective or even irrelevant.

In the cases where all polydisperse particles should be unbiasedly processed, particularly high-definition particle analysis (for example, imaging flow cytometry^{[29]}) and particle filtration (for example, microplastic removal^{[30]}), size-sensitive IF would instead introduce analytical bias and compromise the filtration yield, respectively. Notably, the dramatic shift in advanced microfluidic imaging flow cytometry applications directs toward high-throughput and high-resolution morphological profiling of cells.^{[29]} The acquisition of its enabler, high-resolution images, necessitates a tightly localized focusing that encloses heterogeneous cells into the imaging depth-of-field—which has a thickness of only a few micrometers. The dispersed particle focusing phenomenon common in the current inertial microfluidic-based imaging flow cytometry thus inevitably deteriorates the yield of high-quality (in-focus) images.

### BRIEF SUMMARY OF THE INVENTION

There continues to be a need in the art for improved designs and techniques for method and devices for high-throughput single-file focusing of polydisperse particles.

Embodiments of the subject invention pertain to a microfluidic device for focusing polydisperse particles suspended in a particle-carrying fluid into a single file. The microfluidic device comprises a fluidic channel configured to localize distribution of the polydisperse particles in a cross-sectional area of the fluidic channel and thereby establish a size-dispersion that can be compensated by a downstream inertial focusing. The fluidic channel is formed to have either a plurality of high-aspect-ratio (HAR) symmetric orifice structures connected in series by HAR rectangular structures, or a plurality of HAR alternating asymmetric orifice structures connected in series by HAR rectangular structures. Moreover, dimensions of the fluidic channel are configured such that a converging secondary flow having four spiral vortices is generated. Further, each of the spiral vortices drives the polydisperse particles to flow inward following a spiral path to be concentrated into a center of the spiral vortex such that the polydisperse particles are focused by the converging secondary flow without any inertial force. The fluidic channel has a length between 1 mm and 100 mm, preferably, the length of the fluidic channel is in a range of 40 mm and 100 mm; the polydisperse particles have diameters ranging from 6 μm to 40 μm; and the polydisperse particles are carried by a fluid flowing at a volumetric throughput ranging between 2.4 mL/hr and 30 mL/hr.

According to an embodiment of the subject invention, a high-throughput single-file focusing system for polydisperse particles suspended in a particle-carrying fluid is provided, which comprises the microfluidic device described above for pre-focusing the polydisperse particles; and an extended HAR rectangular structure coupled to the microfluidic device, receiving the pre-focused polydisperse particles and further confining the polydisperse particles to form a tight single file on a mid-plane of the extended HAR rectangular structure. The dimensions of the microfluidic device and dimensions of the extended HAR rectangular structure are configured to have corresponding predetermined ratios. A focusing efficiency greater than 95% is obtained.

In certain embodiments of the subject invention, a system for continuous particle filtration/enrichment comprises a high-throughput single-file focusing device for polydisperse particles suspended in a particle-carrying fluid comprising a microfluidic structure for pre-focusing the polydisperse particles comprising a fluidic channel configured to localize distributions of the polydisperse particles in a cross-sectional area of the fluidic channel; and an extended HAR rectangular structure coupled to the microfluidic structure for pre-focusing, receiving the pre-focused polydisperse particles and further confining the polydisperse particles to form a single file on a mid-plane of the extended HAR rectangular structure; wherein the high-throughput single-file focusing device comprises a plurality of outlets, each coupled with a isolated fluidic channel in-series to control resistance ratios between the outlets. Moreover, the high-throughput single-file focusing device is configured to deplete a mixture of microspheres of a monodisperse sample and a polydisperse sample. The monodisperse sample includes particles having a diameter of about 6 μm. The polydisperse sample has particles having diameters ranging between 6 μm and 30 μm. A filtration efficiency of about 97.5% and a filtration efficiency of about 97.4% are obtained for the monodisperse sample and the polydisperse sample, respectively.

In some embodiments of the subject invention, a system for in-depth particle analysis comprises a high-throughput single-file focusing device for polydisperse particles suspended in a particle-carrying fluid; and a high-speed imaging system coupled with the high-throughput single-file focusing device; wherein the high-throughput single-file focusing device comprises a microfluidic structure for pre-focusing the polydisperse particles comprising a fluidic channel configured to localize distributions of the polydisperse particles in a cross-sectional area of the fluidic channel; and an extended HAR rectangular structure coupled to the microfluidic structure for pre-focusing, receiving the pre-focused polydisperse particles and further confining the polydisperse particles to form a single file on a mid-plane of the extended HAR rectangular structure. The particles include five types of human cells, including peripheral mononuclear cells (PDMSs), a leukemia cell line (HL60), two lung cancer cell lines (H1975, H2170) and a breast carcinoma (MB231). Sizes of the cells of the samples range from 5 μm to 30 μm. Further, the cells have heterogenty of size both among cell types and within each cell type. Five probability distributions of the cell sizes have means ranging from 7.5 μm to 15.9 μm with corresponding standard deviations (STDs) ranging from 0.9 μm to 2.2 μm.

### BRIEF DESCRIPTION OF THE DRAWINGS

FIG. 1 is a schematic representation of overview design of a dispersion-free inertial focusing (DIF) system for co-planar focusing of polydisperse particles, according to an embodiment of the subject invention.

FIGS. 2A-2C show implementation of the DIF system, wherein FIG. 2A is a schematic representation of converging secondary flow for particle localization with a table comparing the simulation results of a converging and a circulating secondary flow induced by a HAR symmetric orifice and a HAR half arc, respectively, wherein for each geometry, five streamline plots show the induced secondary flows at 5 different flow rates, a sequence of scatter plot visualizing the evolution of particle distribution upon accumulating the corresponding secondary flow at 0.5 m/s; wherein FIG. 2B is a schematic representation of in-scale schematic of the DIF system that employs a periodic HAR symmetric orifice geometry to induce secondary flow focusing (SFF) for the particle localization. With the pre-focusing, particles ranging from 6 μm to 40 μm can be focused into a single file. A zoom-in view of the border shows the geometry of both stages, which are detailed in two boxes. Scale bar=2 mm; wherein FIG. 2C shows proof-of-concept experiment, wherein to visualize focusing mechanism of the DIF system, trajectories of fast-flowing 6 μm and 15 μm fluorescent microspheres are captured in 3D at three downstream positions using a commercial confocal microscope and the inertial focusing by a HAR channel, which demonstrates a dispersion of single file, is also shown for comparison, according to an embodiment of the subject invention.

FIGS. 3A-3F show dispersion of single-file focusing by DIF (Left) and standard IF (Right), including trajectories of 6 different sets of fast-flowing fluorescence microspheres, each with different size, were individually captured by fluorescence microscopy, wherein FIGS. 3A-3B show focusing mechanism of DIF having images captured at 6 downstream positions at the flow rate of 18 mL/hr to visualize the evolution of focusing pattern in DIF system, wherein the intensity profiles at the locations indicated by white dotted lines in FIG. 3A are plotted in FIG. 3B, wherein FIG. 3C-3F show consistency across particle sizes having images captured at different volumetric flow rates (Q) at the downstream distance of 40 mm in DIF system of FIG. 3C and HAR rectangular straight channel of FIG. 3E, wherein the intensity profiles at the locations indicated by white dotted lines in FIG. 3C and FIG. 3E are plotted in FIG. 3D and FIG. 3F, respectively, with a scale bar of 20 μm in FIGS. 3A, 3C, and 3E, and a scale bar of 5 μm in FIGS. 3B, 3D, and 3F, according to an embodiment of the subject invention.

FIGS. 4A-4E show results of evaluation of the dispersion-suppression efficiency of DIF by ultrafast imaging, according to an embodiment of the subject invention.

FIGS. 5A-5E are schematic representations of Application I: High-throughput microfiltration based on a DIF microfilter, wherein FIG. 5A shows design of the DIF microfilter, wherein the outlet of the DIF filter system is tailored for streamline division along vertical direction and thus depletion of the single file. Three isolated channels, each with a different length, are connected to the three outlets of the DIF filter system through plastic tubing as remote resistors to control the division, wherein FIG. 5A(i) shows the equivalent electrical circuitry model and FIG. 5A(ii) shows the side view of the designed streamline division; wherein FIG. 5B shows COMSOL simulation of single file depletion, wherein a 10 μm-thick section is designed to be guided to the outlet 2 for depletion, wherein FIGS. 5C-5E show filtration results of monodisperse and polydisperse samples, two sets of particle suspensions, monodisperse and polydisperse, underwent filtration, the monodisperse one comprising 6 μm particles and the polydisperse one comprising 6, 10, 15, 20, 25 and 30 μm particles, wherein FIG. 5C shows particle flow trajectories captured at the outlet; wherein FIG. 5D shows fluorescent images of samples from different outlets; and wherein FIG. 5E shows event rate of samples from different outlets counted using flow cytometry, according to an embodiment of the subject invention.

FIGS. 6A-6F are schematic representations of Application II: High-throughput imaging flow cytometry based on the DIF system, wherein FIG. 6A shows experimental setup and workflow, wherein five types of biological cells are individually injected into the DIF system at 18 mL/hr pump rate and imaged by an ultrafast laser scanning system at the downstream at 10 MHz scanning rate with <3 μm depth of focus (DOF), wherein a continuous image segment is reconstructed from the recorded serial data stream for each cell type and then, high-resolution single-cell images are cropped from the segment for the subsequent image-based feature extraction and data analysis; wherein FIG. 6B shows continuous image segments, wherein five segments from PBMC, HL60, H1975, H2170 and MB231 are shown with a scale bar=50 μm; wherein FIG. 6C shows single-cell images, wherein ten single-cell images, representative in size, are shown for each cell type with a scale bar=10 μm; wherein FIG. 6D shows size distributions, wherein a violin plot embedding a boxplot visualizes the broad and skewed size distribution of each cell type, wherein the black arrows point to outliers of all distributions (black circles), wherein the distributions are also quantified in (mean±std); wherein FIG. 6E shows high-dimensional distributions by size-uncorrelated features; wherein the data distributions in the high-dimensional space of 34 size-uncorrelated features is reduced to 3D by tSNE and shown in a scatter plot; and wherein FIG. 6F shows the classification accuracy of cell types, wherein a bar plot shows the accuracy of using size (red), size-uncorrelated (blue) and all (gray) features quantified by the AUC of ROC curve, wherein Wilcoxon signed rank test is used to verify the statistical significance of difference between different sets of feature, wherein ** and *** denote p<0.01 p<0.001, respectively, according to an embodiment of the subject invention.

FIGS. 7A-7I are schematic representations of Application II: High-throughput imaging flow cytometry based on the DIF system, wherein FIG. 7A shows experimental setup and workflow, wherein fluorescent-labelled HL60s are spike into unlabeled PBMCs at a 1:49 ratio to form a mixture, wherein the high-throughput imaging flow cytometry captures the image and fluorescence signal from all single-cells individually for subsequent data analysis, wherein FIG. 7B shows continuous image segments, wherein three segments from PBMC, HL60 and mixture are shown, wherein the arrow indicates HL60 in the mixture, with a scale bar=50 μm, DIC=differential interference contrast, BF=bright-field, QP=quantitative phase, Fluo=fluorescence, wherein FIG. 7C shows histogram of fluorescence signal of three samples, wherein n=30,000; wherein FIG. 7D shows histogram of size of three samples, wherein n=30,000; wherein FIG. 7E shows a size vs. fluorescence scatter plot, the red dotted line shows the fluorescence threshold set for digitally labelling cell types, and the black dotted line box encloses a subset of PBMC and HL60 that crosstalks in size; wherein FIG. 7F shows high-dimensional distribution by size-uncorrelated features, wherein the data distributions in the high-dimensional space of 78 size-uncorrelated features are reduced by t-SNE and shown in a 3D scatter plot; wherein FIG. 7G shows single cell images of cells crosstalked in size, ten representative images of cells boxed in FIG. 7F are shown for each type, with a scale bar=10 μm; wherein FIG. 7H shows classification accuracy of cell types, wherein a bar plot shows the accuracy of classifying all and crosstalked PBMC and HL60 using size (red), size-uncorrelated (blue) and all (gray) features quantified by the AUC of ROC curve; wherein FIG. 7I shows correlation to size of all features, a bar plot showing the correlation to size of against feature rank, the average correlation to size of top and bottom 10% ranked features are shown, according to an embodiment of the subject invention.

FIGS. 8A-8B show simulation results of secondary flows induced by a HAR symmetric orifice, according to an embodiment of the subject invention.

FIGS. 9A-9B show simulation results of secondary flows induced by a HAR half arc, according to an embodiment of the subject invention.

FIGS. 10A-10B show simulation results of secondary flows induced by a LAR symmetric orifice, according to an embodiment of the subject invention.

FIGS. 11A-11B show simulation results of secondary flows induced by an HAR alternating orifice, according to an embodiment of the subject invention.

FIG. 12 shows projected views of particle flow trajectories acquired using a confocal microscope (Top: 6 μm particle; Bottom: 15 μm particle), according to an embodiment of the subject invention.

FIGS. 13A-13C show design of a DIF filter system, the filter is designed to deplete ⅙ of input fluid in the middle of the channel cross-sectional area, which corresponds to about 8.9 μm thick layer according to the parabolic flow profile, wherein FIG. 13A shows overview of the DIF filter system, wherein FIG. 13B shows zoom-in view of the end of DIF filter system, and wherein FIG. 13C shows equivalent electrical circuit model, according to an embodiment of the subject invention.

FIGS. 14A-14D show flow cytometry results of monodisperse sample from the input port, wherein FIG. 14A shows scatter plots of forward scattering signal (FCS) vs. green fluorescence signal (FITC-A); wherein FIG. 14B shows scatter plots of forward scattering signal (FCS) vs. side scattering signal (SSC-A); wherein FIG. 14C shows histograms of green fluorescence signal (FITC-A); and wherein FIG. 14D shows statistics of gating results, according to an embodiment of the subject invention.

FIGS. 15A-15D show flow cytometry results of monodisperse samples from the enrichment port; wherein FIG. 15A shows scatter plots of forward scattering signal (FCS) vs. green fluorescence signal (FITC-A); wherein FIG. 15B shows scatter plots of forward scattering signal (FCS) vs. side scattering signal (SSC-A); wherein FIG. 15C shows histograms of green fluorescence signal (FITC-A); and wherein FIG. 15D shows statistics of gating results, according to an embodiment of the subject invention.

FIGS. 16A-16D show flow cytometry results of monodisperse sample from the depletion port; wherein FIG. 16A shows scatter plots of forward scattering signal (FCS) vs. green fluorescence signal (FITC-A); wherein FIG. 16B shows scatter plots of forward scattering signal (FCS) vs. side scattering signal (SSC-A); wherein FIG. 16C shows histograms of green fluorescence signal (FITC-A); and wherein FIG. 16D shows statistics of gating results, according to an embodiment of the subject invention.

FIGS. 17A-17D show flow cytometry results of polydisperse sample from the input port; wherein FIG. 17A shows scatter plots of forward scattering signal (FCS) vs. green fluorescence signal (FITC-A); wherein FIG. 17B shows scatter plots of forward scattering signal (FCS) vs. side scattering signal (SSC-A); wherein FIG. 17C shows histograms of green fluorescence signal (FITC-A); and wherein FIG. 17D shows statistics of gating results, according to an embodiment of the subject invention.

FIGS. 18A-18D show flow cytometry results of polydisperse sample from the enrichment port; wherein FIG. 18A shows scatter plots of forward scattering signal (FCS) vs. green fluorescence signal (FITC-A); wherein FIG. 18B shows scatter plots of forward scattering signal (FCS) vs. side scattering signal (SSC-A); wherein FIG. 18C shows histograms of green fluorescence signal (FITC-A); and wherein FIG. 18D shows statistics of gating results, according to an embodiment of the subject invention.

FIGS. 19A-19D show flow cytometry results of polydisperse sample from the depletion port; wherein FIG. 19A shows scatter plots of forward scattering signal (FCS) vs. green fluorescence signal (FITC-A); wherein FIG. 19B shows scatter plots of forward scattering signal (FCS) vs. side scattering signal (SSC-A); wherein FIG. 19C shows histograms of green fluorescence signal (FITC-A); and wherein FIG. 19D shows statistics of gating results, according to an embodiment of the subject invention.

FIG. 20 shows effects of varying axial (z−) position and numerical aperture (NA) on images, wherein three MB231 cells are captured at different axial (z−) positions under three different magnifications (M) and numerical aperture (NA), wherein the Rayleigh range are 1.27 μm, 1.73 μm and 6.91 μm for 60×, 40× and 10× magnifications, respectively, and green triangles indicates images in focus, according to an embodiment of the subject invention.

FIG. 21 shows 20×phase-contrasted microscopic images of four cancer cell lines, with a scale bar=100 μm, according to an embodiment of the subject invention.

FIGS. 22A-22B show correlation analysis of 41 imaging features, wherein these features are extracted from the bright-field image and the corresponding binary mask, details of features can be referred to Tables 4-5, the first four features (length, width, area and volume) directly relate to particle size, wherein FIG. 22A shows correlation matrix and FIG. 22B shows binary matrix demonstrating correlations having magnitude >0.7, wherein the red box encircles the region referring to size-correlated, according to an embodiment of the subject invention.

FIGS. 23A-23B show correlation analysis of 86 imaging features, wherein These features are extracted from the bright-field and quantitative phase images and the corresponding binary mask, wherein details of features can be referred to Tables 4-5, the first four features (length, width, area and volume) directly relate to particle size, wherein FIG. 23A shows correlation matrix, and wherein FIG. 23B shows binary matrix demonstrating correlations having magnitude >0.7, and wherein the red box encircles the region referring to size-correlated, according to an embodiment of the subject invention.

FIG. 24 is a schematic representation of a microfluidic chip with annotation defining geometrical terms used herein, according to an embodiment of the subject invention.

FIGS. 25A-25B are schematic representations of the particle movement by inertial focusing across the cross-sections of rectangular pipes with difference cross-section aspect ratios (ARs) to show effects of polydispersity on inertial focusing, wherein FIG. 25A shows inertial focusing of monodisperse particles at a cross-section with: (i) a unity AR, and (ii) an extreme AR; and wherein FIG. 25B shows inertial focusing of polydisperse particles at a cross-section with an extreme AR, according to prior art.

FIG. 26 is a schematic representation showing the principle of single-file focusing based on secondary-flow focusing as a prior particle distribution confinement, wherein cross-sections at different stages are also shown to visualize the particle migration in DIF, according to an embodiment of the subject invention.

FIGS. 27A-27C show exemplary embodiments of DIF, wherein a 3D drawing of a rectangular pipe illustrates particle distributions in different stages of DIF and cross-sections at different stages are also shown to visualize the particle migration in DIF, according to an embodiment of the subject invention.

FIGS. 28A-28B show sheath-assisted single-stream focusing, wherein FIG. 28A includes in-scale diagram showing a comparison of two microchannels with and without secondary flow focusing (SSF); and wherein FIG. 28B shows a side-by-side performance comparison in focusing polydisperse particles into single stream at different total pump rates and pump rate ratios, wherein fluorescent streak images are captured in the downstream by an inverted microscope with a 20× objective lens, and wherein particle streams that correspond to residuals (out-of-focus) are indicated by white arrows, according to an embodiment of the subject invention.

FIGS. 29A-29C show the rationale and the method of DIF, according to an embodiment of the subject invention.

FIGS. 30A-30E show benchmarking results of the dispersion of state-of-the-art IF and the dispersion of the DIF according to an embodiment of the subject invention.

FIGS. 31A-31B show inertial force field of a HAR rectangular channel by DNS wherein FIG. 31A shows a streamline plot of the force field at various conditions, and wherein FIG. 31B shows the corresponding zoning view, according to an embodiment of the subject invention.

FIG. 32 is a projected view of particle flow trajectories acquired using a confocal microscope, wherein Top: 6 μm particle; and Bottom: 15 μm particle, according to an embodiment of the subject invention.

TABLE 1
Focusing Efficiency of DIF at Various
Particle Sizes and Flow Rate

| | Volumetric flow rate (mL/hr) | | | | | |
|---|---|---|---|---|---|---|
| Particle size (μm) | 2.4 | 6 | 12 | 18 | 24 | 30 |
| 6 | 95.6 | 95.8 | 96.7 | 95.7 | 93.9 | 94.7 |
| 10 | 99.8 | 99.9 | 100.0 | 100.0 | 99.5 | 99.6 |
| 15 | 99.8 | 99.7 | 99.9 | 99.6 | 99.9 | 99.8 |
| 20 | 99.6 | 99.5 | 99.5 | 99.8 | 100.0 | 100.0 |
| 25 | 97 | 98 | 95 | 100 | 98 | 100 |

TABLE 2
Focusing Efficiency of HAR channel at
Various Particle Sizes and Flow Rate

| | Volumetric flow rate (mL/hr) | | | | | |
|---|---|---|---|---|---|---|
| Particle size (μm) | 2.4 | 6 | 12 | 18 | 24 | 30 |
| 6 | 60.1 | 66.1 | 71.0 | 67.8 | 65.6 | 58.3 |
| 10 | 84.2 | 93.7 | 82.5 | 77.8 | 74.7 | 84.4 |
| 15 | 99.1 | 98.3 | 98.7 | 98.8 | 89.8 | 83.4 |
| 20 | 99.2 | 99.9 | 99.6 | 99.0 | 100.0 | 100.0 |
| 25 | 98 | 96 | 98 | 98 | 99 | 100 |

TABLE 3
Area under Curve (AUC) of Receiver-operating-characteristic
(ROC) Curve Analysis Between 5 Types of Cells

| | Siz-correlated | Size-uncorrelated | All |
|---|---|---|---|
| PBMC vs. HL60 | 0.9969 | 0.9978 | 1.0000 |
| PBMC vs. H1975 | 0.9987 | 0.9991 | 0.9989 |
| PBMC vs. H2170 | 0.9982 | 0.9982 | 1.0000 |
| PBMC vs. MB231 | 0.9980 | 0.9998 | 1.0000 |
| HL60 vs. H1975 | 0.9175 | 0.9355 | 0.9247 |
| HL60 vs. H2170 | 0.9030 | 0.9366 | 0.9442 |
| HL60 vs. MB231 | 0.9401 | 0.9884 | 0.9900 |
| MB231 vs. H1975 | 0.6698 | 0.8957 | 0.7800 |
| MB231 vs. H2170 | 0.7378 | 0.9354 | 0.9426 |
| H1975 vs H2170 | 0.6578 | 0.7962 | 0.8713 |

TABLE 4
Feature Equation Table

| Feature name | No. | Abbreviation | Equation |
|---|---|---|---|
| Length | 1 | | Lₘₐⱼₒᵣ |
| Width | 2 | | Lₘᵢₙₒᵣ |
| Area | 3 | A | Lₚᵢₓ² · Nₚᵢₓ |
| Volume | 4 | V | $\frac{4}{3} π \cdot {( \frac{{L}_{minor}}{2} )}^{2} \cdot ( \frac{{L}_{major}}{2} )$ |
| Circularity | 5 | | 4πA/P |
| Eccentricity | 6 | | Lₑₗₗᵢₚ/Lₘₐⱼₒᵣ |
| Aspect Ratio | 7 | | Lₘᵢₙₒᵣ/Lₘₐⱼₒᵣ |
| Orientation | 8 | | θₘₐⱼₒᵣ |
| Attenuation | 9 | | ∫∫_{A}(1 − OD(x,y))dxdy/Nₚᵢₓ |
| Density | | | |
| Amplitude | 10 | σ_{OD}² | ∫∫_{A}(OD(x,y) − OD)²dxdy/(Nₚᵢₓ − 1) |
| Variance | | | |
| Amplitude | 11 | | ∫∫_{A}(OD(x,y) − OD)³dxdy/(Nₚᵢₓ · σ_{OD}³) |
| Skewness | | | |
| Amplitude | 12 | | ∫∫_{A}(OD(x,y) − OD)⁴dxdy/(Nₚᵢₓ · σ_{OD}⁴) |
| Kurtosis | | | |
| Peak | 13 | | max{OD(x,y)} |
| Amplitude | | | |
| Peak | 14 | | min {OD(x,y)} |
| Absorption | | | |
| Amplitude | 15 | | {OD(x,y)} − min {OD(x,y)} |
| Range | | | |
| BF Entropy Mean | 16 | ODₑₙₜ | $\frac{\int {\int }_{A} {OD}_{ent} ( x , y ) dxdy}{{N}_{pix}}$ |
| BF Entropy | 17 | σ_{ODent}² | ∫∫_{A}(ODₑₙₜ(x,y) − ODₑₙₜ)²dxdy/(Nₚᵢₓ − 1) |
| Variance | | | |
| BF Entropy | 18 | | ∫∫_{A}(ODₑₙₜ(x,y) − ODₑₙₜ)³dxdy/(Nₚᵢₓ · σ_{ODent}³) |
| Skewness | | | |
| BF Entropy | 19 | | ∫∫_{A}(ODₑₙₜ(x,y) − ODₑₙₜ)⁴dxdy/(Nₚᵢₓ · σ_{ODent}⁴) |
| Kurtosis | | | |
| BF Entropy | 20 | | {ODₑₙₜ(x,y)} − min{ODₑₙₜ(x,y)} |
| Range | | | |
| BF Entropy | 21 | | max{ODₑₙₜ(x,y)} |
| Peak | | | |
| BF Entropy | 22 | | min{ODₑₙₜ(x,y)} |
| Min | | | |
| BF Entropy | 23 | | \sqrt{(x_{ODent,cen} − x_{cen})² + (y_{ODent,cen} − y_{cen})²}· Lₚᵢₓ |
| Centroid | | | |
| Displacement | | | |
| BF Entropy Radial Distribution | 24 | | $\frac{\int {\int }_{A} r \cdot {OD}_{ent} ( r , θ ) drd θ}{\int {\int }_{A} {OD}_{ent} ( r , θ ) drd θ}$ |
| BF STD Mean | 25 | OD_{STD} | $\frac{\int {\int }_{A} {OD}_{STD} ( x , y ) dxdy}{{N}_{pix}}$ |
| BF STD Variance | 26 | σ_{ODstd}² | $\frac{\int {\int }_{A} {( {OD}_{STD} ( x , y ) - \underline{{OD}_{STD}} )}^{2} dxdy}{{N}_{pix} - 1}$ |
| BF STD Skewness | 27 | | $\frac{\int {\int }_{A} {( {OD}_{STD} ( x , y ) - \underline{{OD}_{STD}} )}^{3} dxdy / {N}_{pix}}{{σ}_{ODstd}^{3}}$ |
| BF STD Kurtosis | 28 | | $\frac{\int {\int }_{A} {( {OD}_{STD} ( x , y ) - \underline{{OD}_{STD}} )}^{4} dxdy / {N}_{pix}}{{σ}_{ODstd}^{4}}$ |
| BF STD | 29 | | {OD_{STD}(x,y)} − min{OD_{STD}(x,y)} |
| Range | | | |
| BF STD Peak | 30 | | max{OD_{STD}(x,y)} |
| BF STD Min | 31 | | min{OD_{STD}(x,y)} |
| BF STD | 32 | | \sqrt{(x_{ODSTD,cen} − x_{cen})² + (y_{ODSTD,cen} − y_{cen})²}· Lₚᵢₓ |
| Centroid | | | |
| Displacement | | | |
| BF STD Radial Distribution | 33 | | $\frac{\int {\int }_{A} r \cdot {OD}_{STD} ( r , θ ) drd θ}{\int {\int }_{A} {OD}_{STD} ( r , θ ) drd θ}$ |
| BF Fiber | 34 | | \sqrt{(x_{ODfiber,cen} − x_{cen})² + (y_{ODfiber,cen} − y_{cen})²}· Lₚᵢₓ |
| Texture | | | |
| Centroid | | | |
| Displacement | | | |
| BF Fiber Texture Radial Distribution | 35 | | $\frac{\int {\int }_{A} r \cdot {OD}_{fiber} ( r , θ ) drd θ}{\int {\int }_{A} {OD}_{fiber} ( r , θ ) drd θ}$ |
| BF Fiber Texture Pixel > Upper Percentile | 36 | | $\frac{Number of pixels in {OD}_{fiber} ( x , y ) > 75 th percentile}{{N}_{pix}}$ |
| BF Fiber Texture Pixel > Media n | 37 | | $\frac{Number of pixels in {OD}_{fiber} ( x , y ) > median}{{N}_{pix}}$ |
| BF Fiber Mean | 38 | OD_{fiber} | $\frac{\int {\int }_{A} {OD}_{fiber} ( x , y ) dxdy}{{N}_{pix}}$ |
| BF Fiber Variance | 39 | σ_{ODfiber}² | $\frac{\int {\int }_{A} {( {OD}_{fiber} ( x , y ) - \underline{{OD}_{fiber}} )}^{2} dxdy}{{N}_{pix} - 1}$ |
| BF Fiber Skewness | 40 | | $\frac{\int {\int }_{A} {( {OD}_{fiber} ( x , y ) - \underline{{OD}_{fiber}} )}^{2} dxdy / {N}_{pix}}{{σ}_{ODfiber}^{3}}$ |
| BF Fiber Kurtosis | 41 | | $\frac{\int {\int }_{A} {( {OD}_{fiber} ( x , y ) - \underline{{OD}_{fiber}} )}^{4} dxdy / {N}_{pix}}{{σ}_{ODfiber}^{4}}$ |
| Dry Mass | 42 | MDₜₒₜₐₗ | $\frac{λ}{2 πα} \int {\int }_{A} MD ( x , y ) dxdy$ |
| Dry Mass | 43 | DMD | ∫∫_{A}DMD(x,y)dxdy/Nₚᵢₓ |
| Density | | | |
| Dry Mass | 44 | σ_{DMD}² | ∫∫_{A}(DMD(x,y) − DMD)²dxdy/(Nₚᵢₓ − 1) |
| Variance | | | |
| Dry Mass | 45 | | ∫∫_{A}(DMD(x,y) − DMD)³dxdy/(Nₚᵢₓ · σ_{DMD}³) |
| Skewness | | | |
| Dry Mass Radial Distribution | 46 | | $\frac{\int {\int }_{A} DMD ( r , θ ) r drd θ}{\int {\int }_{A} DMD ( r , θ ) drd θ}$ |
| Dry Mass | 47 | | \sqrt{(x_{DMD,cen} − x_{cen})² + (y_{DMD,cen} − y_{cen})²}· Lₚᵢₓ |
| Centroid | | | |
| Displacement | | | |
| Peak Phase | 48 | | max{MD(x,y)} |
| Phase | 49 | σ_{MD}² | ∫∫_{A}(MD(x,y) − MD)²dxdy/(Nₚᵢₓ − 1) |
| Variance | | | |
| Phase | 50 | | ∫∫_{A}(MD(x,y) − MD)³dxdy/(Nₚᵢₓ · σ_{MD}³) |
| Skewness | | | |
| Phase | 51 | | ∫∫_{A}(MD(x,y) − MD)⁴dxdy/(Nₚᵢₓ · σ_{MD}⁴) |
| Kurtosis | | | |
| Phase Range | 52 | | max{MD(x,y)} − min{MD(x,y)} |
| Phase | 53 | | min {MD(x,y)} |
| Minimum | | | |
| Phase Radial Distribution | 54 | | $\frac{\int {\int }_{A} r \cdot MD ( r , θ ) drd θ}{\int {\int }_{A} MD ( r , θ ) drd θ}$ |
| Phase | 55 | | \sqrt{(x_{DMD,cen} − x_{cen})² + (y_{DMD,cen} − y_{cen})²}· Lₚᵢₓ |
| Centroid | | | |
| Displacement | | | |
| Phase STD Mean | 56 | MD_{STD} | $\frac{\int {\int }_{A} {MD}_{STD} ( x , y ) dxdy}{{N}_{pix}}$ |
| Phase STD Var | 57 | σ_{MDstd}² | $\frac{\int {\int }_{A} {( {MD}_{STD} ( x , y ) - \underline{{MD}_{STD}} )}^{2} dxdy}{{N}_{pix} - 1}$ |
| Phase STD Skewness | 58 | | $\frac{\int {\int }_{A} {( {MD}_{STD} ( x , y ) - \underline{{MD}_{STD}} )}^{4} dxdy / {N}_{pix}}{{σ}_{MDstd}^{4}}$ |
| Phase STD Kurtosis | 59 | | $\frac{\int {\int }_{A} {( {MD}_{STD} ( x , y ) - \underline{{MD}_{STD}} )}^{4} dxdy / {N}_{pix}}{{σ}_{MDstd}^{4}}$ |
| Phase STD | 60 | | \sqrt{(x_{MDSTD,cen} − x_{cen})² + (y_{MDSTD,cen} − y_{cen})²}· Lₚᵢₓ |
| Centroid | | | |
| Displacement | | | |
| Phase SRD Radial Distribution | 61 | | $\frac{\int {\int }_{A} r \cdot {MD}_{STD} ( r , θ ) drd θ}{\int {\int }_{A} {MD}_{STD} ( r , θ ) drd θ}$ |
| Fit Texture Mean | 62 | MD_{fit} | $\frac{\int {\int }_{A} {MD}_{fit} ( x , y ) dxdy}{{N}_{pix}}$ |
| Fit Texture Variance | 63 | σ_{MDfit}² | $\frac{\int {\int }_{A} {( {MD}_{fit} ( x , y ) - \underline{{MD}_{fit}} )}^{2} dxdy}{{N}_{pix} - 1}$ |
| Fit Texture Skewness | 64 | | $\frac{\int {\int }_{A} {( {MD}_{fit} ( x , y ) - \underline{{MD}_{fit}} )}^{3} dxdy / {N}_{pix}}{{σ}_{MDfit}^{3}}$ |
| Fit Texture Kurtosis | 65 | | $\frac{\int {\int }_{A} {( {MD}_{fit} ( x , y ) - \underline{{MD}_{fit}} )}^{4} dxdy / {N}_{pix}}{{σ}_{MDfit}^{4}}$ |
| Fit Texture | 66 | | \sqrt{(x_{MDfit,cen} − x_{cen})² + (y_{MDfit,cen} − y_{cen})²}· Lₚᵢₓ |
| Centroid | | | |
| Displacement | | | |
| Fit Texture Radial Distribution | 67 | | $\frac{\int {\int }_{A} r \cdot {MD}_{fit} ( r , θ ) drd θ}{\int {\int }_{A} {MD}_{fit} ( r , θ ) drd θ}$ |
| Phase Entropy Mean | 68 | MDent | $\frac{\int {\int }_{A} {MD}_{ent} ( x , y ) dxdy}{{N}_{pix}}$ |
| Phase Entropy Var | 69 | σ_{MDent}² | $\frac{\int {\int }_{A} {( {MD}_{ent} ( x , y ) - \underline{{MD}_{ent}} )}^{2} dxdy}{{N}_{pix} - 1}$ |
| Phase Entropy Skewness | 70 | | $\frac{\int {\int }_{A} {( {MD}_{ent} ( x , y ) - \underline{{MD}_{ent}} )}^{3} dxdy / {N}_{pix}}{{σ}_{MDent}^{3}}$ |
| Phase Entropy Kurtosis | 71 | | $\frac{\int {\int }_{A} {( {MD}_{ent} ( x , y ) - \underline{{MD}_{ent}} )}^{4} dxdy / {N}_{pix}}{{σ}_{MDent}^{4}}$ |
| Phase | 72 | | \sqrt{(x_{MDent,cen} − x_{cen})² + (y_{MDent,cen} − y_{cen})²}· Lₚᵢₓ |
| Entropy | | | |
| Centroid | | | |
| Displacement | | | |
| Phase Entropy Radial Distribution | 73 | | $\frac{\int {\int }_{A} r \cdot {MD}_{ent} ( r , θ ) drd θ}{\int {\int }_{A} {MD}_{ent} ( r , θ ) drd θ}$ |
| Phase Fiber | 74 | | \sqrt{(x_{MDfiber,cen} − x_{cen})² + (y_{MDfiber,cen} − y_{cen})²}· Lₚᵢₓ |
| Centroid | | | |
| Displacement | | | |
| Phase Fiber Radial Distribution | 75 | | $\frac{\int {\int }_{A} r \cdot {MD}_{fiber} ( r , θ ) drd θ}{\int {\int }_{A} {MD}_{fiber} ( r , θ ) drd θ}$ |
| Phase Fiber Pixel > Upper Percentile | 76 | | $\frac{Number of pixels in {MD}_{fiber} ( x , y ) > 75 th percentile}{{N}_{pix}}$ |
| Phase Fiber Pixel > Media n | 77 | | $\frac{Number of pixels in {MD}_{fiber} ( x , y ) > median}{{N}_{pix}}$ |
| Phase Fiber Mean | 78 | MD_{fiber} | $\frac{\int {\int }_{A} {MD}_{fiber} ( x , y ) dxdy}{{N}_{pix}}$ |
| Phase Fiber Var | 79 | σ_{MDfiber}² | $\frac{\int {\int }_{A} {( {MD}_{fiber} ( x , y ) - \underline{{MD}_{fiber}} )}^{2} dxdy}{{N}_{pix} - 1}$ |
| Phase Fiber Skewness | 80 | | $\frac{\int {\int }_{A} {( {MD}_{fiber} ( x , y ) - \underline{{MD}_{fiber}} )}^{3} dxdy / {N}_{pix}}{{σ}_{MDfiber}^{3}}$ |
| Phase Fiber Kurtosis | 81 | | $\frac{\int {\int }_{A} {( {MD}_{fiber} ( x , y ) - \underline{{MD}_{fiber}} )}^{4} dxdy / {N}_{pix}}{{σ}_{MDfiber}^{4}}$ |
| Mean Phase Arrangement | 82 | | $\frac{\int {\int }_{A} MD ( r , θ ) r drd θ}{\int {\int }_{A} MD ( r , θ ) drd θ}$ |
| Phase Arrangement Variance | 83 | σ_{MDarr}² | $\frac{\int {\int }_{A} {( MD ( r , θ ) r )}^{2} drd θ}{\int {\int }_{A} MD ( r , θ ) drd θ}$ |
| Phase Arrangement Skewness | 84 | | $\frac{\int {\int }_{A} {( MD ( r , θ ) \cdot r )}^{3} drd θ}{{σ}_{MDarr}^{2} \cdot \int {\int }_{A} MD ( r , θ ) drd θ}$ |
| Phase Orientation Variance | 85 | σ_{MDang}² | $\frac{{\int }_{0}^{∞} {( ( ω ) \cdot ω )}^{2} d ω}{{\int }_{0}^{∞} ( ω ) d ω}$ |
| Phase Orientation Kurtosis | 86 | | $\frac{{\int }_{0}^{∞} {( ( ω ) \cdot ω )}^{4} d ω}{{σ}_{MDang}^{2} \cdot {\int }_{0}^{∞} ( ω ) d ω}$ |

Note: List of variables used can be found in Table 5.

TABLE 5
List of Variables and Abbreviations

| Variable | Description | Equation/Remarks |
|---|---|---|
| C | Contour of | |
| | binary | |
| | mask | |
| CM | Cell mask | CM(x,y) = {1, 0 if inside cell otherwise |
| | function | |
| DMD | Dry mas density map | $DMD ( x , y ) = \frac{λ \cdot MD ( x , y )}{2 π α \cdot h ( x , y )}$ |
| h | Cell height map | $h ( x , y ) = \sqrt{{( \frac{{L}_{minor} + {L}_{major}}{2} )}^{2} - ( {( x - {x}_{cen} )}^{2} + {( y - {y}_{cen} )}^{2} )}$ |
| Lₑₗₗᵢₚ | Distance | |
| | between | |
| | foci of | |
| | ellipse | |
| Lₘₐⱼₒᵣ | Major axis | |
| | length | |
| Lₘᵢₙₒᵣ | Minor axis | |
| | length | |
| Lₚᵢₓ | Physical | |
| | length of | |
| | one pixel | |
| MD | Mass | MD(x,y) |
| | density | |
| | map | |
| | (QP | |
| | contrast) | |
| MD(θ) | Mass | |
| | density | |
| | projected to | |
| | polar angle | |
| [symbol] (ω) | Mass | [symbol] (ω) = F(MD(θ)) |
| | density in | |
| | angular | |
| | frequency | |
| | domain | |
| MD_{STD,ker}(x,y) | Mean value of QPI within STD filter kernel | ${\int }_{x - \frac{{w}_{STD}}{2}}^{x + \frac{{w}_{STD}}{2}} {\int }_{y - \frac{{w}_{STD}}{2}}^{y + \frac{{w}_{STD}}{2}} MD ( u , v ) dvdu / {w}_{STD}^{2}$ |
| MD_{STD}(x,y) | QPI STD map | ${\int }_{x - {w}_{STD} / 2}^{x + {w}_{STD} / 2} {\int }_{y - {w}_{STD} / 2}^{y + {w}_{STD} / 2} \sqrt{\frac{{( MD ( u , v ) - \underline{{MD}_{STD , ker}} ( x , y ) )}^{2}}{{w}_{STD}^{2}}} dvdu$ |
| MD_{cubic}(x,y) | Cubic | |
| | polynomial | |
| | surface fit | |
| | of mass | |
| | density | |
| | map | |
| MD_{fit}(x,y) | Fit texture | MD(x,y) − MD_{cubic}(x,y) |
| | map of | |
| | mass | |
| | density | |
| | map | |
| MDₑₙₜ(x,y) | Entropy filtered mass density map | ${{\sum }^{255}}_{k = 0} {p}_{MD , k} \cdot {p}_{MD , k}$ |
| MD_{fiber}(x,y) | Fiber | FF(MD(x,y)), ref. ¹ |
| | texture | |
| | enhanced | |
| | mass | |
| | density | |
| | map | |
| Nₚᵢₓ | Pixel | ∫∫ CM(x,y) dA |
| | number in | |
| | cell mask | |
| OD | Optical | OD(x,y) |
| | density | |
| | map | |
| | (BF | |
| | contrast) | |
| OD | Amplitude | ∫∫_{A}OD(x,y)dxdy/Nₚᵢₓ |
| | mean | |
| ODₑₙₜ(x,y) | Entropy filtered optical density map | ${{\sum }^{255}}_{k = 0} {p}_{OD , k} \cdot {p}_{OD , k}$ |
| OD_{STD,ker}(x,y) | Mean value of BF within STD filter kernel | ${\int }_{x - \frac{{w}_{STD}}{2}}^{x + \frac{{w}_{STD}}{2}} {\int }_{y - \frac{{w}_{STD}}{2}}^{y + \frac{{w}_{STD}}{2}} OD ( u , v ) dvdu / {w}_{STD}^{2}$ |
| OD_{STD}(x,y) | BF STD map | ${\int }_{x - {w}_{STD} / 2}^{x + {w}_{STD} / 2} {\int }_{y - {w}_{STD} / 2}^{y + {w}_{STD} / 2} \sqrt{\frac{{( OD ( u , v ) - \underline{{OD}_{STD , ker}} ( x , y ) )}^{2}}{{w}_{STD}^{2}}} dvdu$ |
| OD_{fiber}(x,y) | Fiber | FF(OD(x,y)), ref. ¹ |
| | texture | |
| | enhanced | |
| | optical | |
| | density | |
| | map | |
| P | Perimeter | ${∮}_{c} \sqrt{( {( \frac{dx}{d θ} )}^{2} + {( \frac{dy}{d θ} )}^{2} )} d θ$ |
| P_{MD,k}(x,y) | Normalized histogram | $\frac{number of pixels in kernel ( {w}_{ent} ) with MD = k}{Total number of pixels in kernel} , where k = 0 to 255$ |
| | counts | |
| | within | |
| | kernel of | |
| | mass | |
| | density | |
| | map | |
| P_{OD,k}(x,y) | Normalized histogram | $\frac{number of pixels in kernel ( {w}_{ent} ) with OD = k}{Total number of pixels in kernel} , where k = 0 to 255$ |
| | counts | |
| | within | |
| | kernel of | |
| | optical | |
| | density | |
| | map | |
| r, θ | Polar | |
| | coordinates | |
| | centered at | |
| | cell | |
| | centroid | |
| wₑₙₜ | Kernel size | |
| | of entropy | |
| | filter | |
| w_{STD} | Kernel size | |
| | of STD | |
| | filter | |
| x,y | Cartesian | |
| | coordinates | |
| x_{cen} | Coordinate | x_{cen} = ∫∫_{A}x · CM(x,y)dxdy/Nₚᵢₓ |
| y_{cen} | s of cell | y_{cen} = ∫∫_{A}y · CM(x,y)dxdy/Nₚᵢₓ |
| | centroid | |
| x_{MD,cen} | Coordinate | x_{MD,cen} = ∫∫_{A}x · MD(x,y)dxdy/Nₚᵢₓ |
| y_{MD,cen} | s of mass | y_{MD,cen} = ∫∫_{A}y · MD(x,y)dxdy/Nₚᵢₓ |
| | density | |
| | weighted | |
| | cell | |
| | centroid | |
| x_{DMD,cen} | Coordinate | x_{DMD,cen} = ∫∫_{A}x · DMD(x,y)dxdy/Nₚᵢₓ |
| y_{DMD,cen} | s of dry | y_{DMD,cen} = ∫∫_{A}y · DMD(x,y)dxdy/Nₚᵢₓ |
| | mass | |
| | density | |
| | weighted | |
| | cell | |
| | centroid | |
| x_{MDent,cen} | Coordinate | x_{MDent,cen} = ∫∫_{A}x · MDₑₙₜ(x,y)dxdy/Nₚᵢₓ |
| y_{MDent,cen} | s of | y_{MDent,cen} = ∫∫_{A}y · MDₑₙₜ(x,y)dxdy/Nₚᵢₓ |
| | entropy | |
| | filtered MD | |
| | weighted | |
| | cell | |
| | centroid | |
| x_{MDfiber,cen} | Coordinate | x_{MDfiber,cen} = ∫∫_{A}x · MD_{fiber}(x,y)dxdy/Nₚᵢₓ |
| y_{MDfiber,cen} | s of fiber | y_{MDfiber,cen} = ∫∫_{A}y · MD_{fiber}(x,y)dxdy/Nₚᵢₓ |
| | enhanced | |
| | MD | |
| | weighted | |
| | cell | |
| | centroid | |
| x_{MDfit,cen} | Coordinate | x_{MDfit,cen} = ∫∫_{A}x · MD_{fit}(x,y)dxdy/Nₚᵢₓ |
| y_{MDfit,cen} | s of MD fit | y_{MDfit,cen} = ∫∫_{A}y · MD_{fit}(x,y)dxdy/Nₚᵢₓ |
| | texture | |
| | weighted | |
| | cell | |
| | centroid | |
| x_{MDSTD,cen} | Coordinate | x_{MDSTD,cen} = ∫∫_{A}x · MD_{STD}(x,y)dxdy/Nₚᵢₓ |
| y_{MDSTD,cen} | s of STD | y_{MDSTD,cen} = ∫∫_{A}y · MD_{STD}(x,y)dxdy/Nₚᵢₓ |
| | filtered MD | |
| | weighted | |
| | cell | |
| | centroid | |
| x_{ODent,cen} | Coordinate | x_{ODent,cen} = ∫∫_{A}x · ODₑₙₜ(x,y)dxdy/Nₚᵢₓ |
| y_{ODent,cen} | s of | y_{ODent,cen} = ∫∫_{A}y · ODₑₙₜ(x,y)dxdy/Nₚᵢₓ |
| | entropy | |
| | filtered OD | |
| | weighted | |
| | cell | |
| | centroid | |
| x_{ODfiber,cen} | Coordinate | x_{ODfiber,cen} = ∫∫_{A}x · OD_{fiber}(x,y)dxdy/Nₚᵢₓ |
| y_{ODfiber,cen} | s of fiber | y_{ODfiber,cen} = ∫∫_{A}y · OD_{fiber}(x,y)dxdy/Nₚᵢₓ |
| | enhanced | |
| | OD | |
| | weighted | |
| | cell | |
| | centroid | |
| x_{ODSTD,cen} | Coordinate | x_{ODSTD,cen} = ∫∫_{A}x · OD_{STD}(x,y)dxdy/Nₚᵢₓ |
| y_{ODSTD,cen} | s of STD | y_{ODSTD,cen} = ∫∫_{A}y · OD_{STD}(x,y)dxdy/Nₚᵢₓ |
| | filtered OD | |
| | weighted | |
| | cell | |
| | centroid | |
| α | Specific | 0.19 ml/g (ref. 2) |
| | refractive | |
| | increment | |
| θₘₐⱼₒᵣ | Angle | |
| | between | |
| | major axis | |
| | and x-axis | |
| F | Fourier | |
| | transform | |

TABLE 6
Equations and Variable for Characterizing Dispersion

| Description | Variables | Equation/Remarks |
|---|---|---|
| Fluorescent intensity | I(x,q,a) | Regarded as the wieghting of lateral position |
| Lateral position | x | Regardd as the dependent variable |
| Particle diameter | a | |
| Volumetric flow rate | q | |
| Number of sample points of | nₐ | |
| particle diameter | | |
| Number of sample points of | n_{q} | |
| volumetric flow rate | | |
| Total fluorescent intensity | Iₜₒₜₐₗ(q,a) | ${\sum }_{x} I ( x , q , a )$ |
| Mean lateral position | x(q,a) | ${\sum }_{x} ( x \cdot I ( x , q , a ) ) / {I}_{total} ( q , a )$ |
| Standard deviation of lateral position | σₓ(q, a) | $\sqrt{{\sum }_{x} ( I ( x , q , a ) \cdot {( x - \underline{x} ( q , a ) )}^{2} ) / {I}_{total} ( q , a )}$ |
| Mean of mean lateral position | x(q) | ${\sum }_{a} ( \underline{x} ( q , a ) ) / {n}_{a}$ |
| Standard deviation of mean lateral position | σₓ(q) | $\sqrt{{\sum }_{a} {( \underline{x} ( q , a ) - \underline{\underline{x}} ( q ) )}^{2} / {n}_{a}}$ |
| Spreading | SP | ${\sum }_{q} {\sum }_{a} {σ}_{x} ( q , a ) / ( {n}_{q} \cdot {n}_{a} )$ |
| Drifting | DR | ${\sum }_{q} {σ}_{\underline{x}} ( q ) / {n}_{q}$ |
| Dispersion | DISP | DR + SP |

TABLE 7
Ratio of residual zone (equivalently loss) of the
HAR rectangular pipe at various particle sizes
and flow rates (by direct numerical simulation)

| | Volumetric flow rate (mL/hr) | | |
|---|---|---|---|
| Particle size (μm) | 6 | 18 | 30 |
| 5 | 36.7% | 38.0% | 34.3% |
| 10 | 17.0% | 18.7% | 18.0% |
| 15 | 13.8% | 6.5% | 4.8% |
| 20 | 2.5% | 0.0% | 0.0% |
| 25 | 0.0% | 0.0% | 0.0% |

TABLE 8
Loss of the single-file DIF system (100%-yield) at various
particle sizes and flow rates (by experiment)

| | Volumetric flow rate (mL/hr) | | | | | |
|---|---|---|---|---|---|---|
| Particle size (μm) | 2.4 | 6 | 12 | 18 | 24 | 30 |
| 6 | 4.4% | 4.2% | 3.3% | 4.3% | 6.1% | 5.3% |
| 10 | 0.2% | 0.1% | 0.0% | 0.0% | 0.5% | 0.4% |
| 15 | 0.2% | 0.3% | 0.1% | 0.4% | 0.1% | 0.2% |
| 20 | 0.4% | 0.5% | 0.5% | 0.2% | 0.0% | 0.0% |
| 25 | 3% | 2% | 5% | 0% | 2% | 0% |

TABLE 9
Loss of the HAR rectangular pipe (100%-yield) at various
particle sizes and flow rates (by experiment)

| | Volumetric flow rate (mL/hr) | | | | | |
|---|---|---|---|---|---|---|
| Particle size (μm) | 2.4 | 6 | 12 | 18 | 24 | 30 |
| 6 | 39.9 | 33.9 | 29.0 | 32.2 | 34.4 | 41.7 |
| 10 | 15.8 | 6.3 | 17.5 | 22.2 | 25.3 | 15.6 |
| 15 | 0.9 | 1.7 | 1.3 | 1.2 | 10.2 | 16.6 |
| 20 | 0.8 | 0.1 | 0.4 | 1.0 | 0.0 | 0.0 |
| 25 | 2 | 4 | 2 | 2 | 1 | 0 |

TABLE 10
Equations and variable to characterize dispersion

| Description | Variables | Equation/Remarks |
|---|---|---|
| Fluorescent intensity | I(x, q, a) | Regarded as the wieghting of lateral position |
| Lateral position | x | Regardd as the dependent variable |
| Particle diameter | a | |
| Volumatric flow rate | q | |
| Number of sample points of | nₐ | |
| particle diameter | | |
| Number of sample points of | n_{q} | |
| volumetric flow rate | | |
| Total fluorecenct inetnsity | Iₜₒₜₐₗ(q,a) | ${\sum }_{x} I ( x , q , a )$ |
| Mean lateral position | x(q,a) | ${\sum }_{x} ( x \cdot I ( x , q , a ) ) / {I}_{total} ( q , a )$ |
| Standard deviation of lateral position | σₓ(q, a) | $\sqrt{{\sum }_{x} ( I ( x , q , a ) \cdot {( x - \underline{x} ( q , a ) )}^{2} ) / {I}_{total} ( q , a )}$ |
| Mean of mean lateral position | x(q) | ${\sum }_{a} ( \underline{x} ( q , a ) ) / {n}_{a}$ |
| Standard deviation of mean lateral position | σₓ(q) | $\sqrt{{\sum }_{a} {( \underline{x} ( q , a ) - \underline{\underline{x}} ( q ) )}^{2} / {n}_{a}}$ |
| Spreading | SP | ${\sum }_{q} {\sum }_{a} {σ}_{x} ( q , a ) / ( {n}_{q} \cdot {n}_{a} )$ |
| Drifting | DR | ${\sum }_{q} {σ}_{\underline{x}} ( q ) / {n}_{q}$ |
| Dispersion | DISP | DR + SP |

### DETAILED DISCLOSURE OF THE INVENTION

Embodiments of the subject invention are directed to a high-throughput single-file focusing system and methods for polydisperse particles in which coplanar IF of polydisperse particles enabled by a localized cross-sectional particle distribution is provided.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not prelude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e., the value can be +/−10% of the stated value. For example, “about 1 kg” means from 0.90 kg to 1.1 kg.

The dispersion-free inertial focusing (DIF) forms a tight single file of polydisperse particles by establishing a compensable size dispersion. In contrast to the conventional approaches, the spreading of this dispersion is localized within certain compartments of an inertial force field. The simplest single-file inertial focusing (naïve IF), which naturally focus the particles to the single file as long as particles stay within the corresponding compartment, can thus compensate this dispersion at the downstream. In other words, it is equivalent to setting a localized initial distribution of the particles that ignore the residual foci of naïve IF, if any, to efficiently focus the particles onto a plane downstream, regardless of particle size. As such, DIF comprises an upstream pre-focusing add-on for distributing particles only to particular compartments, and a downstream preliminary (“naïve”) IF for further confining particles into a single file. The method/system is configured with the aid of Computational Fluid Dynamics (CFD) simulations. Then, three different imaging modalities are adopted to vigorously verify that this simple but powerful approach can efficiently focus polydisperse particles (for example, >95% for 6-40 μm in diameter) into a single file in a wide range of volumetric throughput (for example, 2.4-30 mL/hr). The method/system is applied to continuous particle filtration and the in-depth single-cell analysis to demonstrate its significance in enabling diverse applications for polydisperse samples.

### 1.1. Working Principle of DIF: A Compensable Size-Dispersion

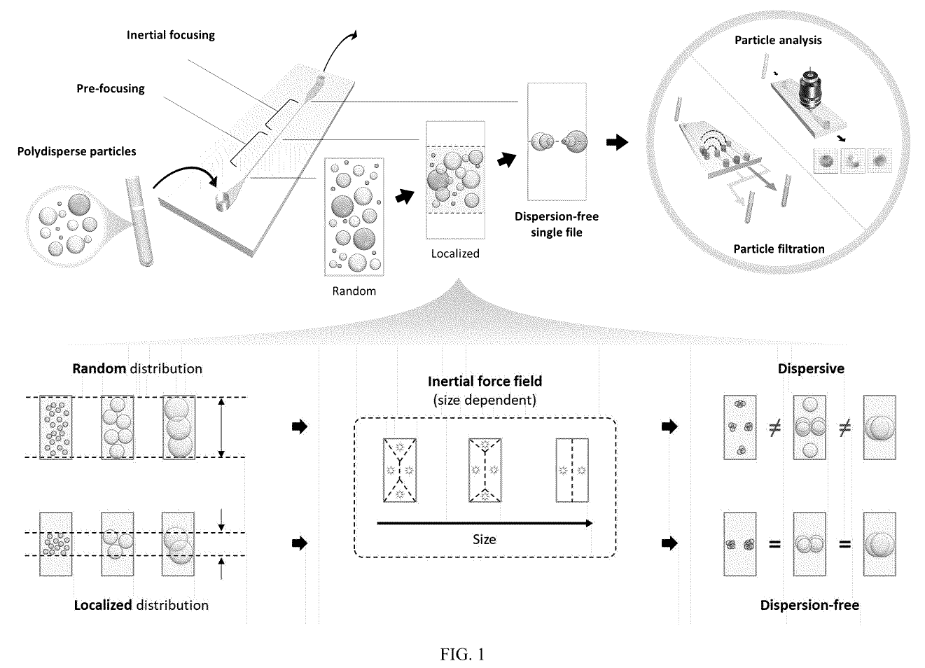

Referring to FIG. 1, dispersion-free inertial focusing (DIF) for co-planar focusing of polydisperse particles is described. The inherent dependency of inertial force to particle size leads to a size-dispersion of polydisperse particle during inertial focusing (IF). The traditional IF (naïve IF) thus struggles in forming single file for a wide range of particle sizes, restricting its applications to particle separation by size for decades. According to embodiments of the subject invention, the DIF leverages the compartmental nature of inertial force field and a localized input particle distribution to compensate this dispersion. The two-stage approach localizes all particles on the channel cross-section to a common compartment of inertial force field before a naïve IF to establish a size independent focusing condition, resulting in a co-planar focusing of polydisperse particles. Such unprecedented ability enables applications that minimally benefit from particle size, such as particle filtration/enrichment and particle analysis.

The central idea of DIF rests upon setting a single file of particles with compensable size-dispersion as shown in FIG. 1. An inertial force field naturally has a compartmental structure where each compartment contains a focus and a border that precludes particles from crossing. Such compartmentalization is not always consistent against different particle sizes. For instance, the compartmentalization of small particles is more resistant to the change of channel cross-section. Furthermore, in the case of a rectangular channel cross-section, naïve IF of polydisperse particles suffers from the presence of residual compartments (streams) of small particles, i.e., a form of size dispersion.[9] Hence, the single-file focusing of naïve IF can only be designed to favor a narrow particle size range. On the other hand, incorporating additional force(s) globally perturb the inertial force field and thus not effective in overcoming the size-dispersion effect locally. Therefore, virtually all the existing IF methods manipulate this inevitable size-dispersion effect as a mean to order and separate particles accordingly to their sizes.

DIF exploits a simple yet overlooked characteristic of IF to compensate for the dispersion: the initial particle distribution in the channel cross-section. Precisely because particles cannot pass through borders between compartments in the naïve IF, those particles initially located in the residual compartments can never migrate to the single file; the particles initially outside the residual compartments are always confined to a single file. Thus, DIF localizes all particles to the cross-sectional area outside all residual compartments to enable compensation by subsequent naïve IF for a tight single file (or single plane), regardless of particle polydispersity. The larger proportion of that area which is named common compartment is, the larger the tolerance of size-dispersion is. Thus, in a practical implementation, DIF employs a two-stage design based on a HAR rectangular channel, which pre-focuses polydisperse particles into a maximally overlapped compartment in the middle and subsequently forms a single file on the mid-plane.

In another embodiment, a Dispersion-Free Inertial focusing (DIF) system and methods are developed, minimizing particle size-dependent dispersion while maintaining the high throughput and precision of standard inertial focusing, even in a highly polydisperse scenario.

Through an extensive numerical analysis and experimental validations that cover a broad range of particle sizes and flow rates, a universal strategy is developed for efficient automated compression of the inherent dispersion based on a localized input particle distribution. As a result, a dispersion-free single-plane focusing (known as single-file focusing) is developed that can efficiently focus polydisperse particles (i.e., >95% for 6-30 μm in diameter, polydispersity=5) into a thin slice (i.e., <3 μm thin) consistently across a wide range of flow rate (2.4-30 mL/hr). The experimental benchmarking also demonstrates that the DIF system outperforms the state-of-the-art IF systems regarding minimal dispersion in positioning polydisperse particles onto a single plane. Finally, the applicability of the DIF system is demonstrated in two distinct applications beyond the reach of conventional methods: continuous microparticle filtration and high-throughput, in-depth image-based single-cell analysis. This new technique is also readily compatible with the common inertial microfluidic design and thus could unleash more diverse applications of IF that require dispersion-free processing of polydisperse particles.

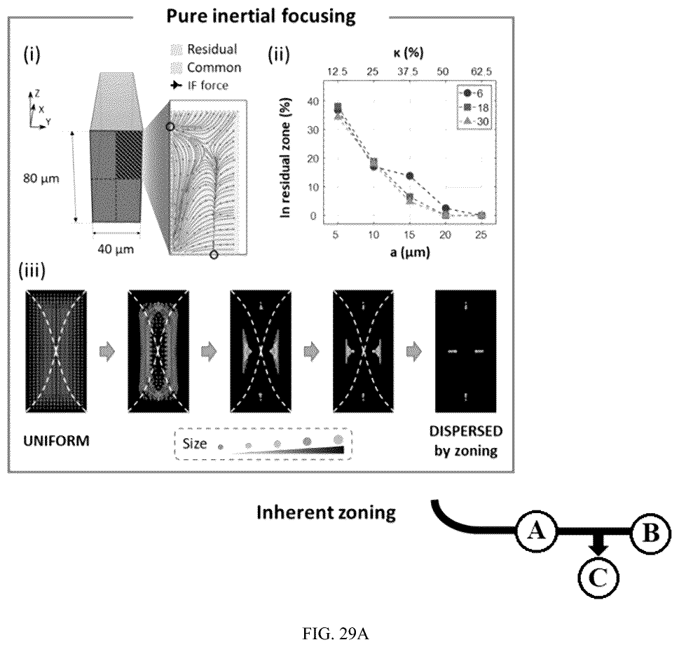

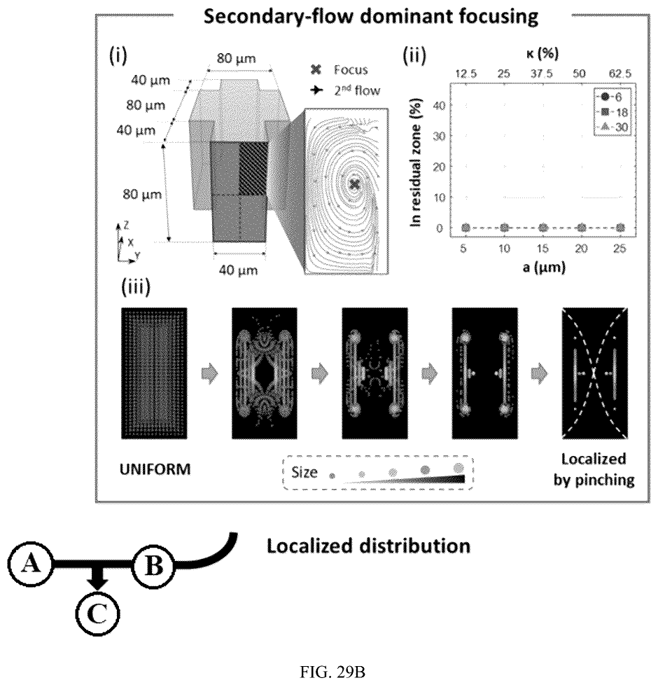

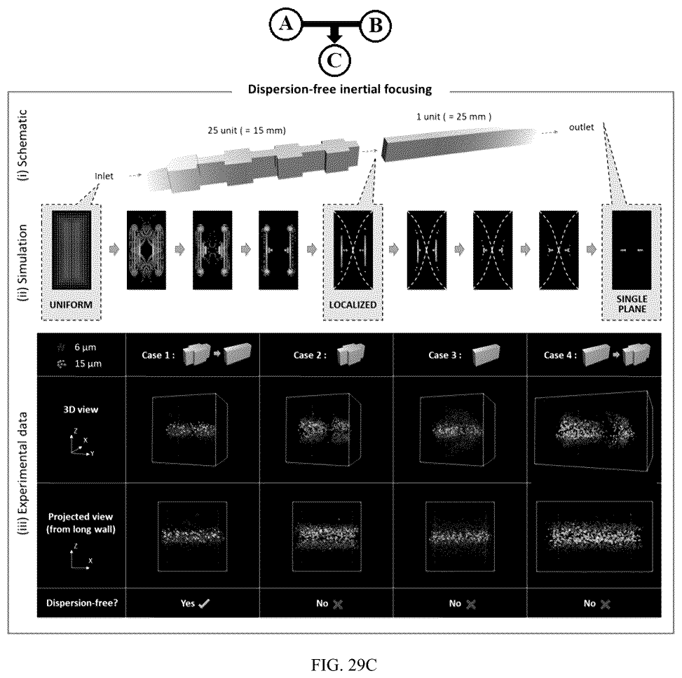

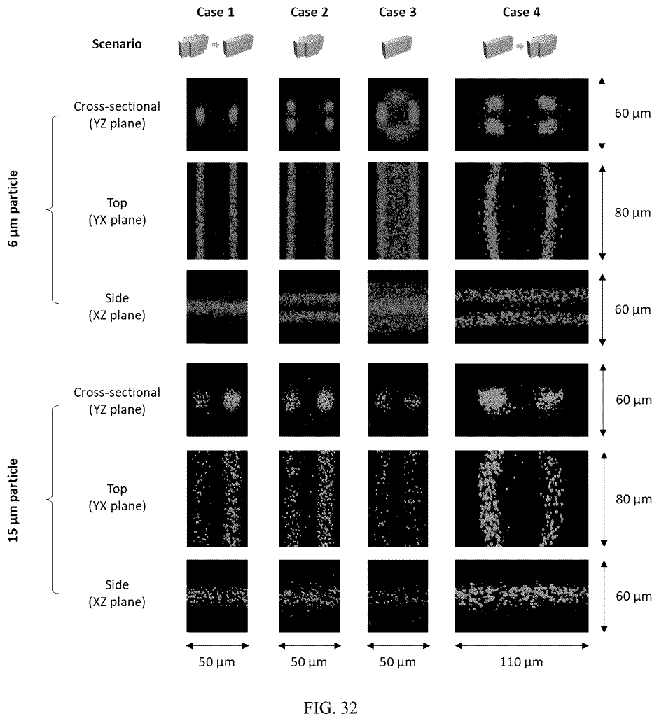

The central concept of DIF rests upon the strategic shaping and localization of the distribution of the polydisperse particles for achieving size-insensitive inertial focusing. The rationale is motivated by the inherent size-dependent property of the fundamental zoning (or compartmentalization) effect of inertial focusing. Consider the most commonly studied geometry, i.e., high-aspect-ratio (HAR) rectangular straight channel, the inertial force field is divided into multiple zones across the channel cross-section, each containing a focus and surrounded by a border that prevents particle from crossing. We revisited this mechanism by conducting a comprehensive numerical analysis (see FIG. 32), and we confirmed the existence of the size-sensitive residual focusing zones (located near the short walls), which create two satellite streams of particles (see FIG. 29A(i, iii)). More importantly, these residual zones expand significantly with decreasing particle sizes, for example, about 40% (see FIG. 29A(ii) and Table 7), i.e., small particles tend to disperse more than the large particles—leading to dispersion. In other words, no satellite streams will be formed if the polydisperse particle distribution can first be strategically localized outside the size-dependent residual zones. Thus, a HAR channel with emptied residual zones can focus particles into a thin slice regardless the polydispersity of particles.

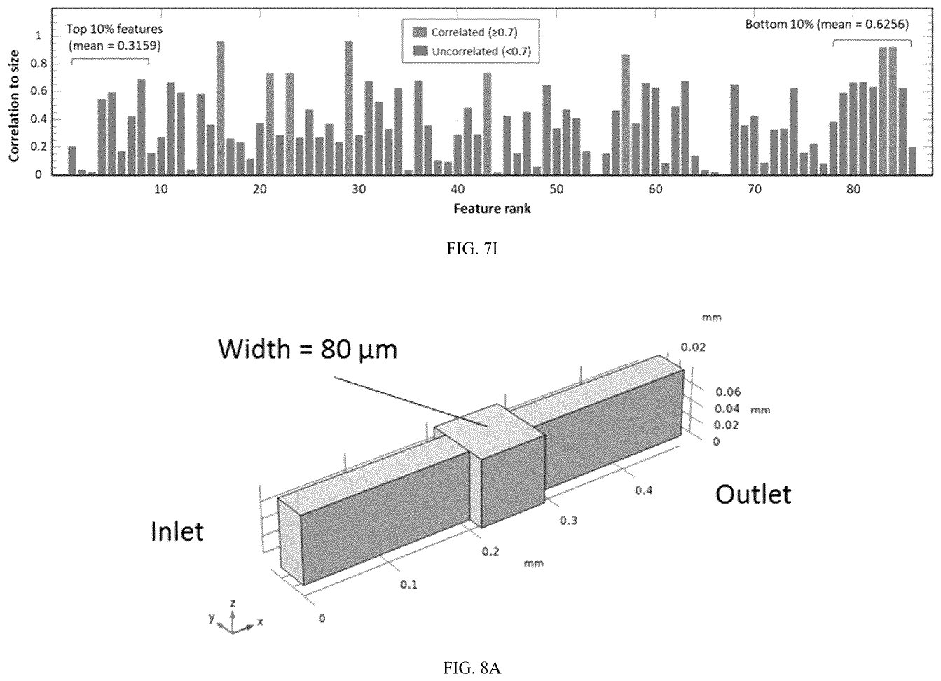

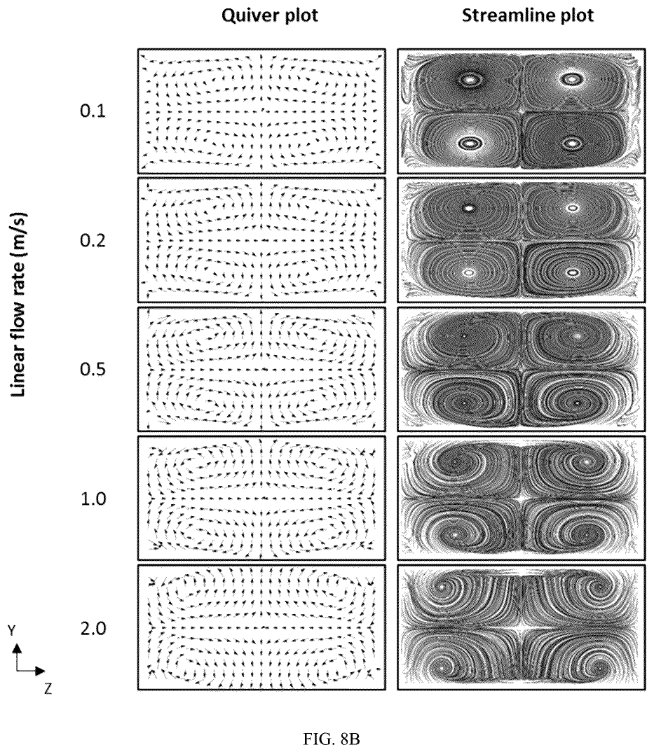

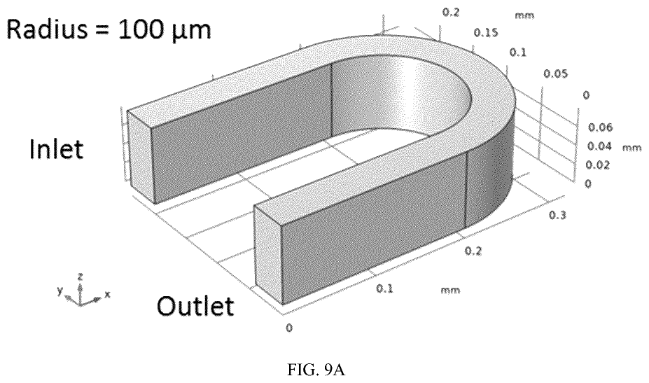

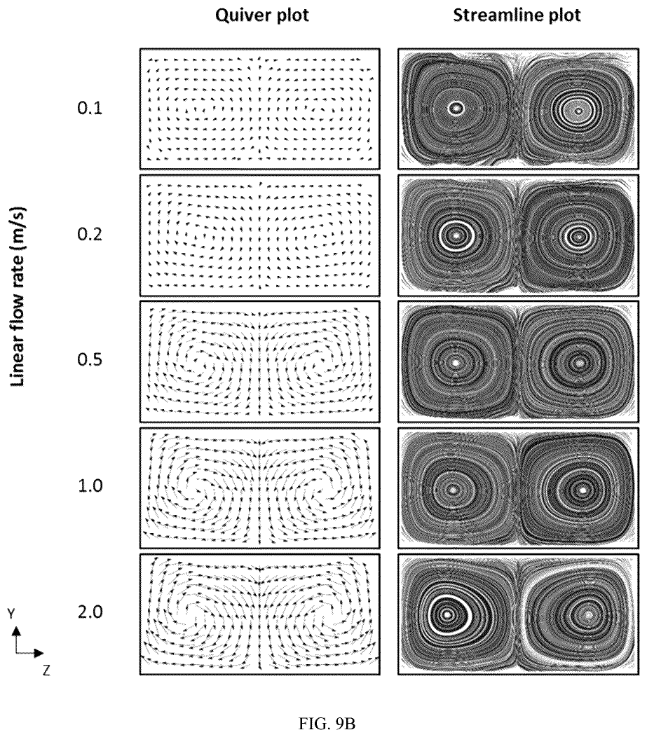

To achieve a targeted particle distribution for dispersion-free inertial focusing (DIF), a flow condition is required that satisfies all three requirements that have largely been overlooked in the existing inertial focusing methods: (1) it should generate a pinching effect for particle localization; (2) it should not generate any residual zoning effect; and (3) it should ensure the localization adapts with the downstream inertial force field (in this case at the long walls). Here, a HAR symmetric orifice structure (see FIGS. 29B and 8) is developed, which can create a secondary flow with four converging spiraling vortices, one at each quadrant, a favorable condition for particle pinching (see FIG. 29B(i)). It is noted that this differs from the secondary circulatory flow, Dean flow, generated by other spiral and serpentine designs that is not effective for creating the pinching effect (see FIGS. 9A-9B)^{[33]}. Furthermore, we refined this orifice structure design (by maximizing the repetition frequency) so that the secondary flow outruns the inertial force to make the zoning effect virtually absent. Consequently, the polydisperse particles can effectively be pinched by the secondary vortex flow along the long walls of the channel (see FIG. 29B(iii)). This particle distribution is thus shaped and localized outside the residual zone of the HAR rectangular channel (0% in the residual zone in FIG. 29B(ii)). The requirements for achieving all three conditions for DIF have been largely overlooked in the existing inertial focusing methods, including the well-known spiral^{[26,34]}, serpentine^{[35]}, and orifice designs^{[16]}.

Based on the above rationale, a single-file DIF system is developed by cascading the aforementioned HAR orifice to the inlet of the HAR rectangular straight channel with the same cross-section (a length of 15 mm and 25 mm, respectively) (see FIG. 29C(i)). The numerical computational fluid dynamic (CFD) particle tracing demonstrates that this integration allows the particle localization to evade from the residual zones (near the short wall) of the downstream inertial force field. The dispersion of such particle distribution is thus automatically compressed by the downstream inertial focusing—resulting in single-file DIF of polydisperse particles, free from dispersion (see FIG. 29C(ii)).

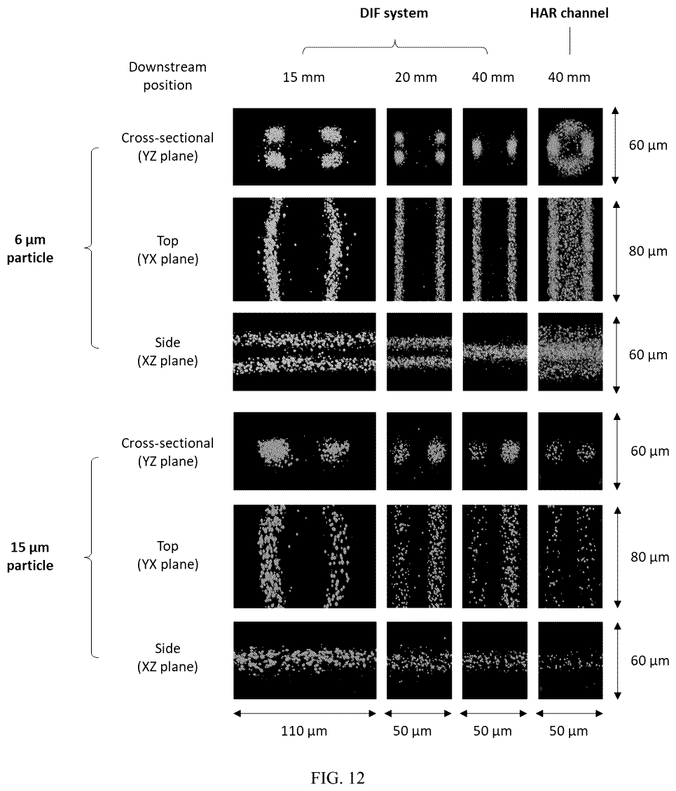

Furthermore, we experimentally verified this DIF design by imaging the 3D flowing trajectories of 6-μm and 15-μm fluorescent microspheres under a confocal microscope (FIGS. 29C(iii) and 33). Consistent with the CFD simulation, our experiment demonstrated that the DIF design can focus both small particles (i.e., 6 μm) and large particles (i.e., 15 μm) onto the same plane, (see FIG. 29C(iii), case 1). In contrast, all other designs exhibit dispersion in different ways. The orifice alone distributes polydisperse particles along the long wall (see FIG. 29C(iii), case 2) and the HAR rectangular straight channel alone introduces satellite streams (see FIG. 29C(iii), case 3). Importantly, reversing the order of orifice and straight channel cannot eliminate dispersion (see FIG. 29C(iii), case 4). These experimental demonstrations justify the importance of pre-localizing particle distribution strategically achieved by the three necessary flow conditions in order to achieve dispersion compression effectively in DIF. We note that the presented HAR symmetric orifice for particle localization is not the only viable geometry for DIF. An alternating asymmetric HAR orifice, which could create a similar localization, also enables single-file DIF (see FIGS. 11A-11B).

### Experimentally Evaluating Efficiency of Single-File DIF System

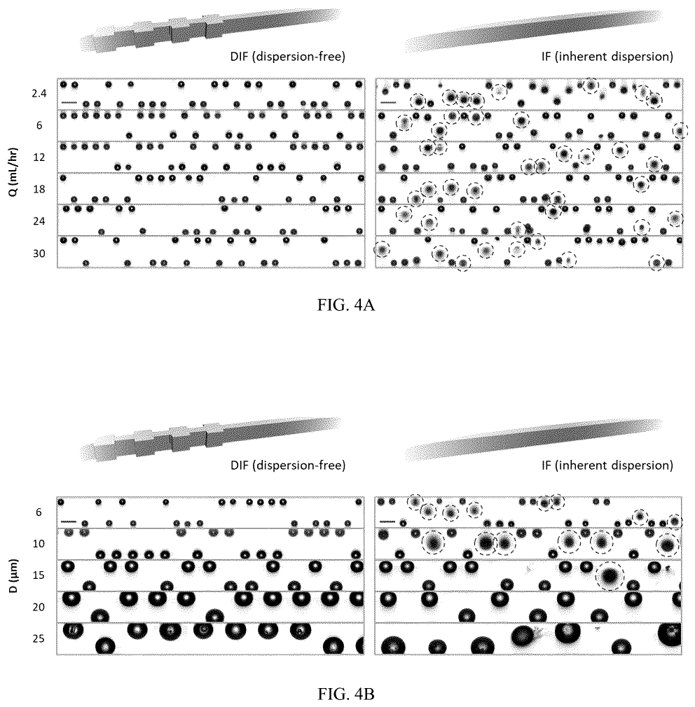

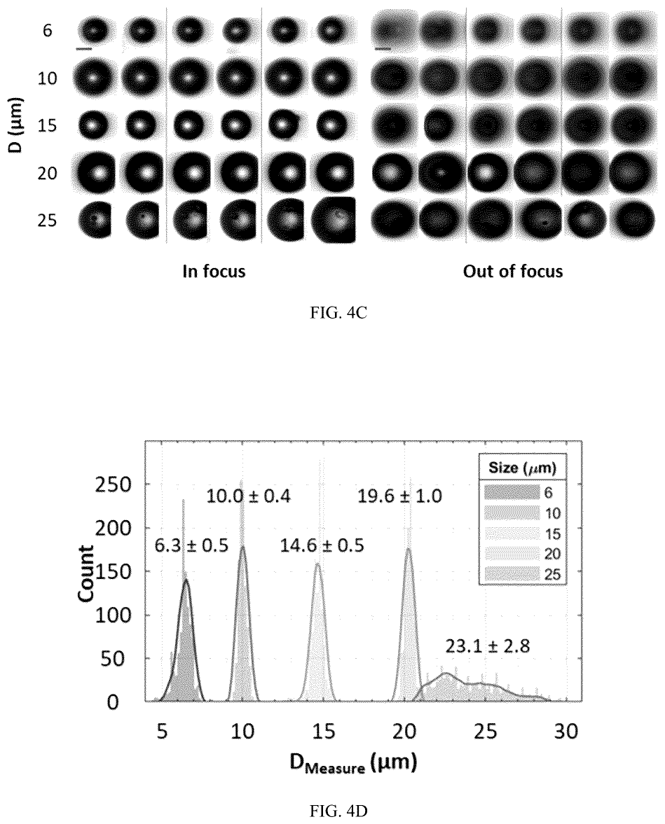

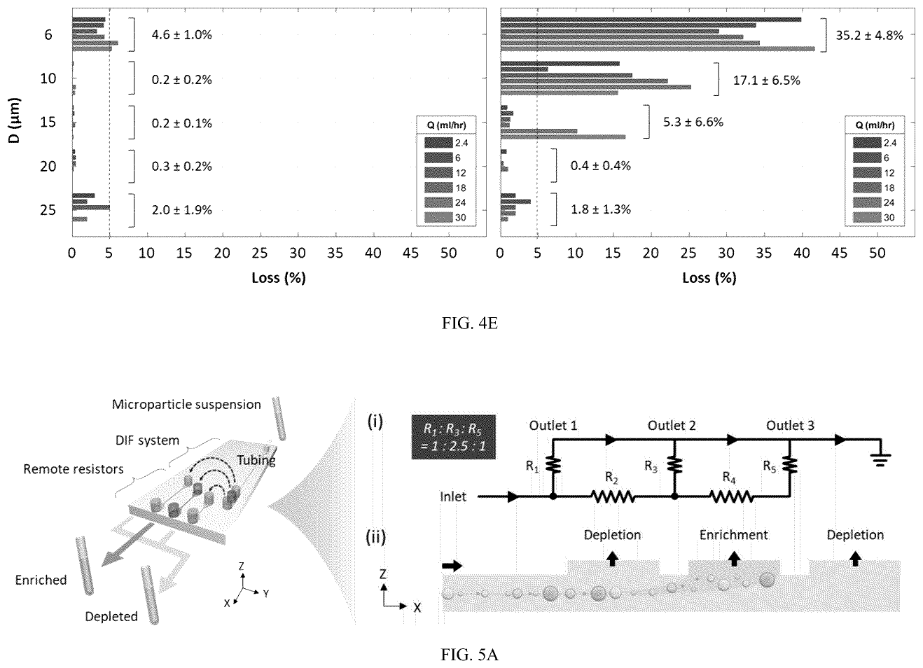

We next quantify and evaluate the efficiency of our single-file DIF method in handling polydisperse particles through particle flow characterization using our home-built ultrafast laser scanning microscope (FIGS. 4A-4E). We systematically tracked the flow behaviors of 5 sets of monodisperse fluorescent microspheres (i.e., 6, 10, 15, 20, and 25 μm) across a wide range of flow rates (i.e., 2.4, 6, 12, 18, 24 and 30 mL/hr) (FIGS. 4A-4E). Particles are imaged at a downstream position (40 mm) to ensure they are in a steady focusing state. Note that the images are taken from the short wall, and the optical image focus is set to the middle of the long wall. Thanks to the narrow depth of focus (DOF) brought by this high-resolution imaging system, the degree of sharpness of particle images can be used to indicate the particle position deviation away from the single plane. Hence, accurate particle recognition (in-focus versus out-of-focus) (FIGS. 4C-4D) and quantitative particle analysis can be performed (see FIG. 4E). We quantified the particle focusing efficiency in DIF by a parameter, loss, which is defined as the ratio of out-of-focus particles to the total number of particles (see FIG. 4E and Tables 8-9). In general, all particles in DIF are in sharp image focus, whereas a considerable amount of out-of-focus particle images were captured in the HAR straight channel (see FIGS. 4A-4B). The loss of the DIF system is quantified to be as low as 1.5±2% (mean±standard deviation (std)) across all particle sizes, while the loss of the HAR straight channel is as high as 12±13.9%, 7-8 times higher in both mean and standard deviation than DIF (see FIG. 4E). It shows a steep decreasing trend for the larger particle sizes, i.e., the loss is as high as 41.7% for 6 μm particles, whereas as low as almost 0% for 25 μm particles (see FIG. 4E). These observations agree very well with our earlier numerical simulation and experimental results—giving solid proof of the effective dispersion suppression and the superior single-file focusing performance of polydisperse particles.

Comparison with the State-of-the-Art Inertial Focusing Systems

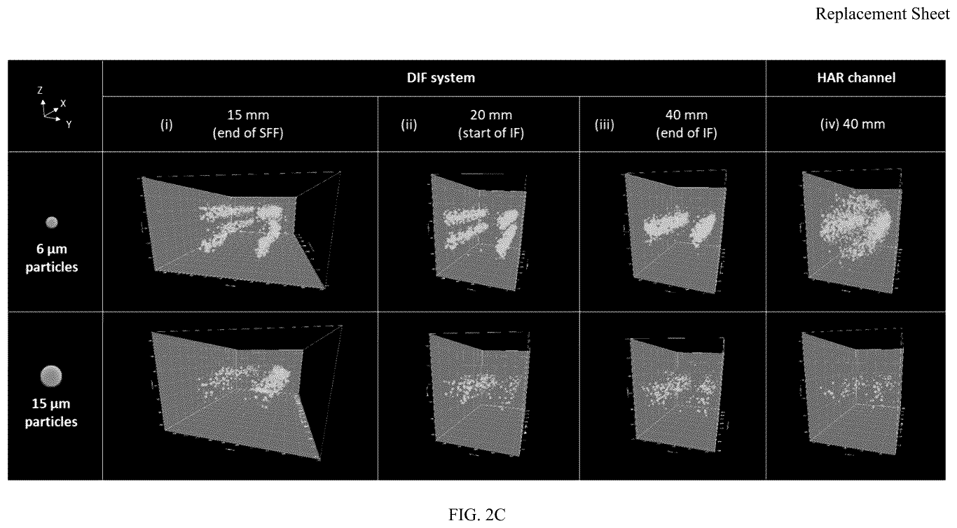

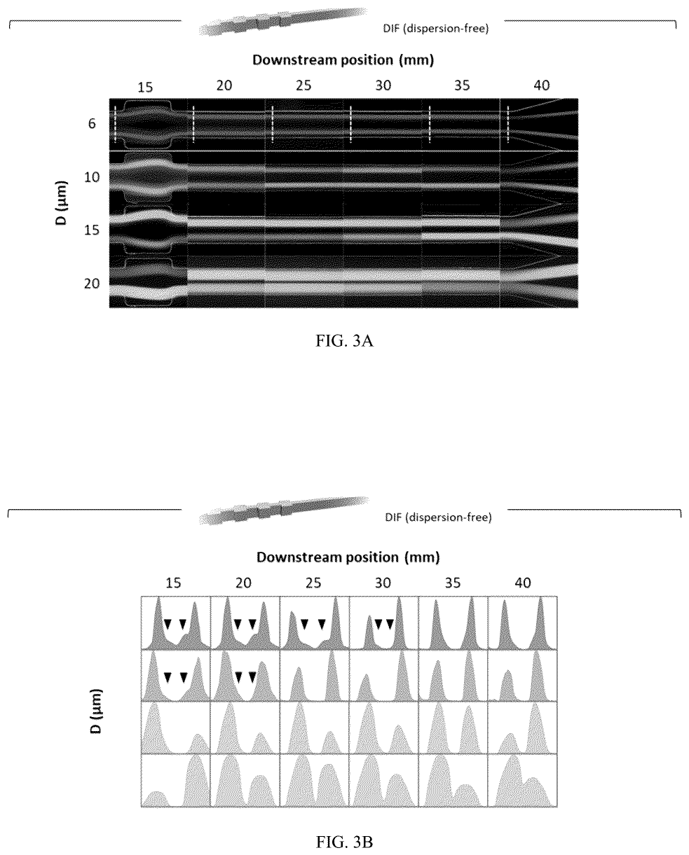

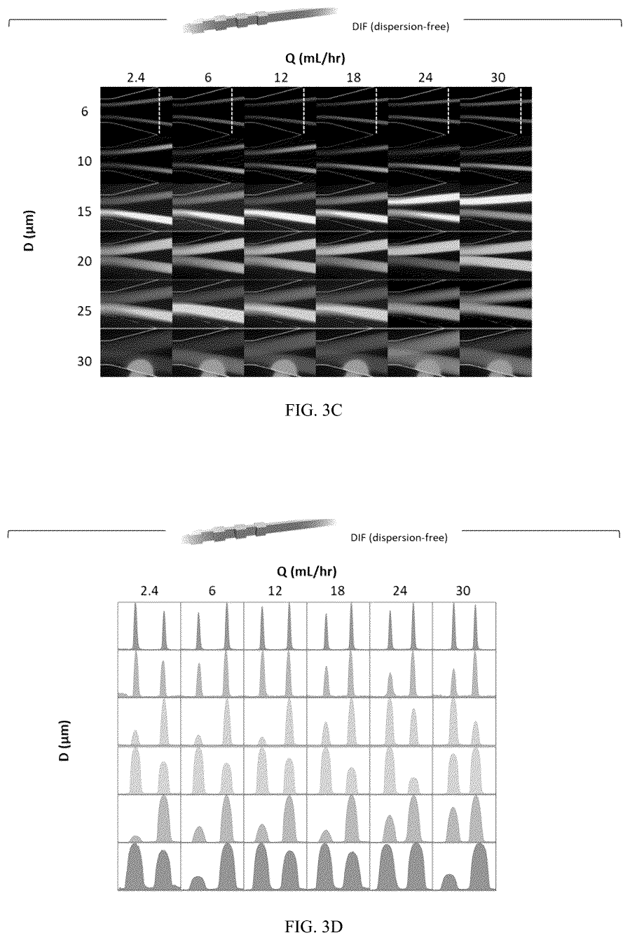

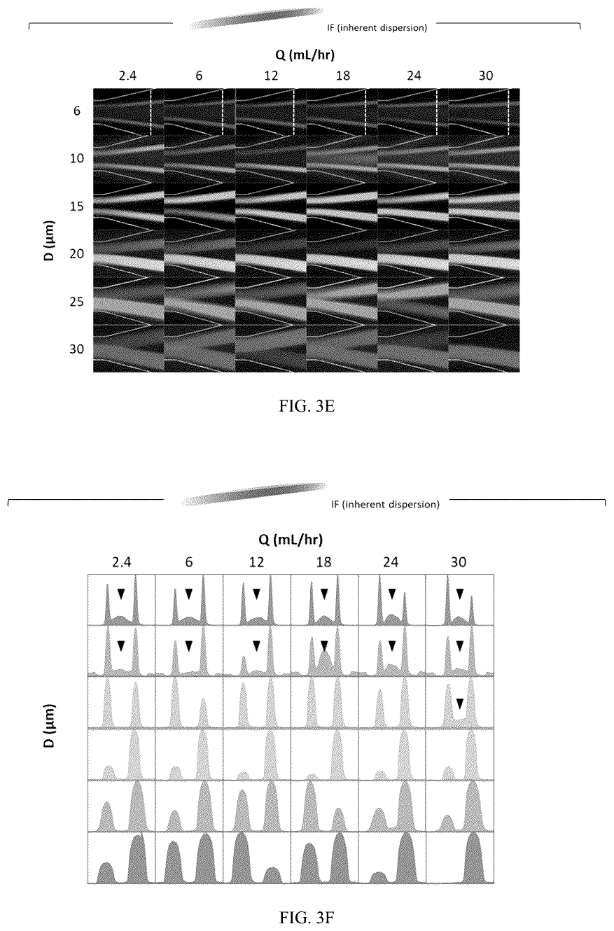

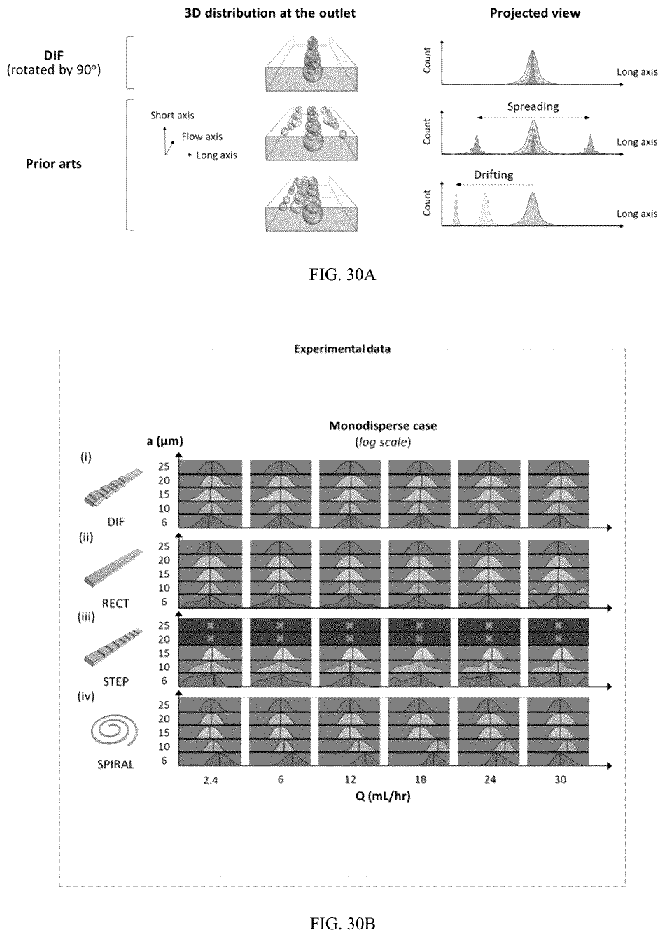

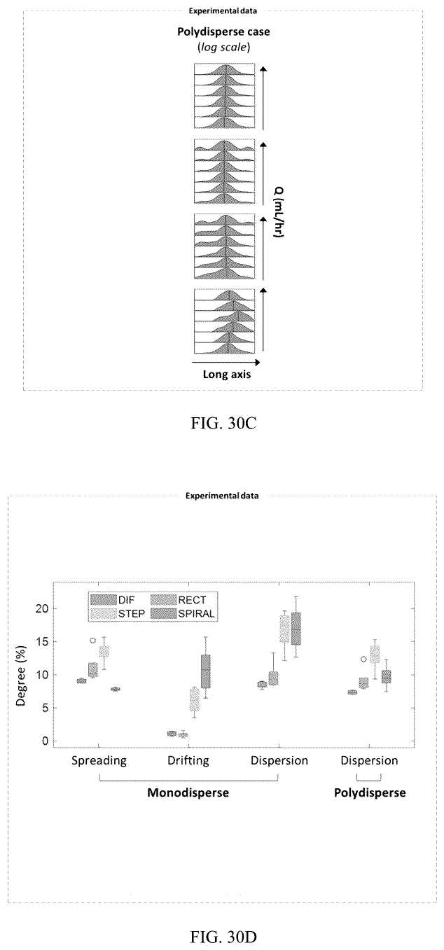

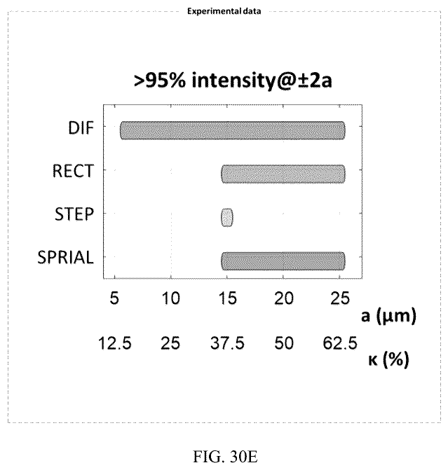

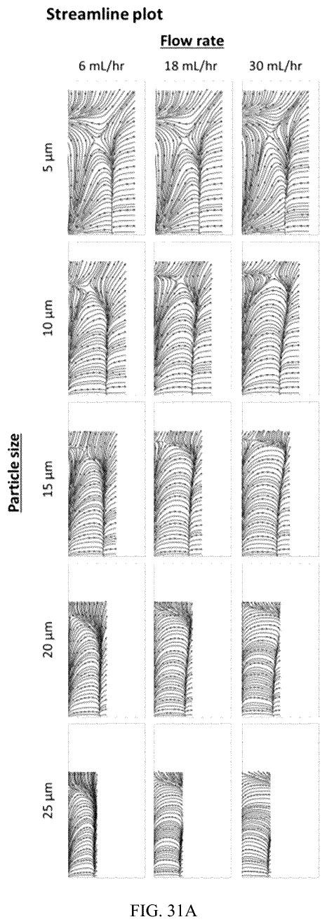

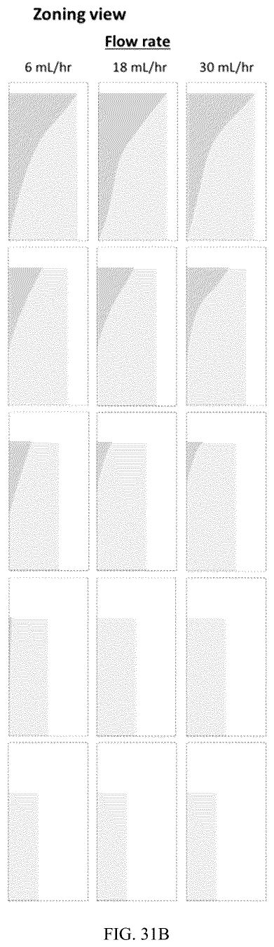

We further performed an experimental benchmarking of the DIF system against the representative inertial focusing systems, namely an asymmetric orifice (STEP), a spiral (SPIRAL), and a rectangular straight channel (RECT)) (see FIGS. 3A-3F and 30B). Our experiments, focused on analyzing the flow trajectories of fluorescent microspheres, revealed a distinctive advantage of DIF: its ability to achieve consistent single-file focusing across a diverse particle size range (6-30 μm). In contrast, the comparison systems exhibited highly variable focusing profiles that were notably sensitive to different particle sizes. Moreover, DIF demonstrated remarkable robustness across a broad spectrum of flow rates, a stark contrast to the performance of traditional inertial focusing methods. This was evidenced in experiments involving both monodisperse and polydisperse particles (FIGS. 30B-30C).

Based on this comparative study, we also observed that dispersion in other inertial focusing methods can mainly be categorized into two types and the combination of both: the presence of satellite streams (spreading type) or a lateral shift of the single file (drifting type). These two types of effects can be quantified by two dimensionless parameters based on the statistical moments of the focusing profiles (i.e., measured by the fluorescence intensity profile) (see FIG. 30D). Here we define dispersion as the cumulative effect of the two, i.e., the sum of spreading and drifting. In our comparative analysis, it is apparent that DIF stands out as the method exhibiting minimal dispersion across the board (see FIG. 30D). Effectively, it maintains the high precision across the broadest range of particle sizes—giving a tolerance of sample polydispersity that exceeds other methods by at least 2-fold (see FIG. 30E). Notably, systems relying on secondary flow mechanisms, such as STEP and SPIRAL, were found to be more prone to dispersion than even the RECT design. Specifically, the STEP configuration, while achieving precise single-stream focusing, was limited by its narrow operational particle size range. On the other hand, the high drifting and low spreading effects in SPRIAL explain its excellent performance in separating particles by size but highlight its limitations when it comes to focusing in polydisperse scenarios. These findings underscore that DIF is not only superior in achieving precise single-file focusing but also in maintaining this precision across a wide range of particle sizes and flow rates, making it an unparalleled solution that diversifies applications of inertial focusing from particle separation by size only.

### 1.2. Design of a Consistent and Compensable Dispersion: Converging Secondary Flow

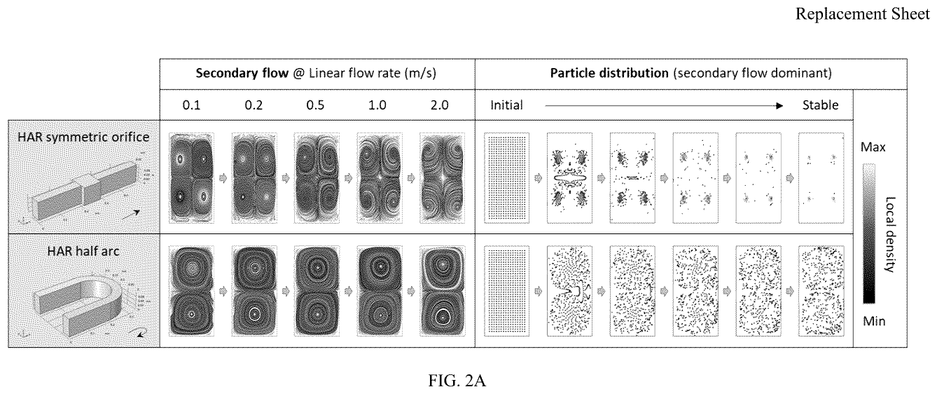

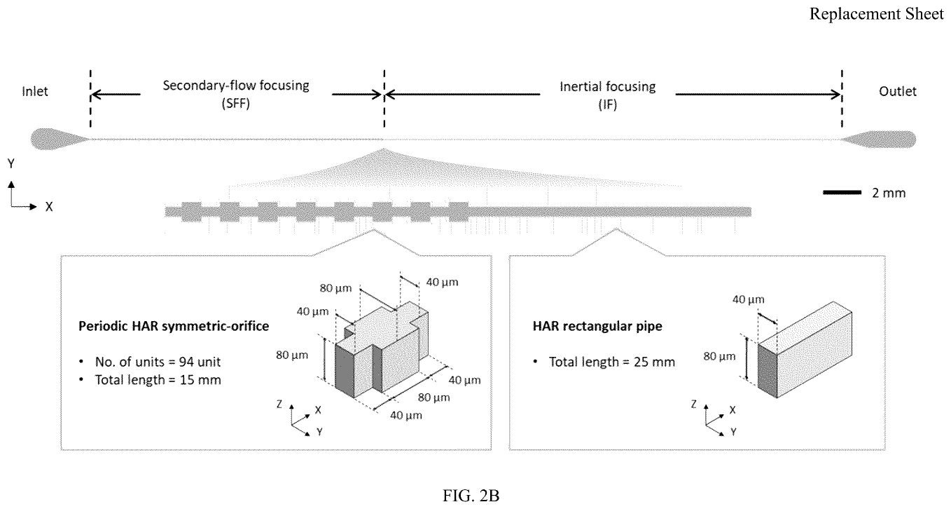

In localizing the dispersion, DIF does not rely on sheathing (the principle of hydrodynamic focusing) and instead employs a specific secondary flow: converging secondary flow. It critically differs from the secondary flow in other common methods by its inherent focusing power.[11] In other words, it can focus particles without inertial force. This effect can simply be achieved by a HAR symmetric orifice as shown in FIGS. 2A-2C. The design results in four spiraling vortexes that progressively pinch the polydisperse particles to the eyes of vortexes (equivalently, foci). This pinching ability, termed secondary flow focusing (SFF), ensures a consistent localization of size-dispersion in DIF. It can be understood that the dominant force transits from the inertial force to the secondary flow drag force when the fluid flow rate is increased; and the DIF based on the secondary flow that lacks the focusing ability could not maintain the localization after the transition. Its performance is thus inconsistent across a wide range of flow rates. In contrast, SFF can sustain the focusing power. With the foci of SFF setting to the common compartments of the HAR channel, the size-dispersion is guaranteed to be localized regardless of the dominant force. This high flexibility in flow rate gives two-fold benefits in applying IF. First, it overcomes the maximum speed limit in those focusing devices using the secondary flow to enable a high-throughput operation. Second, it allows seamless integration with other microfluidic designs on the same chip with a tight flow speed restriction or a preferable flow speed range for optimal performance.

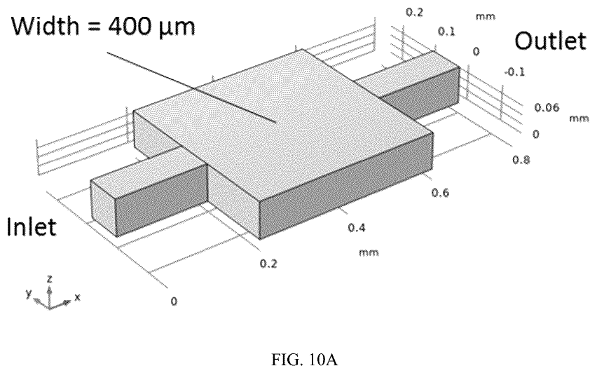

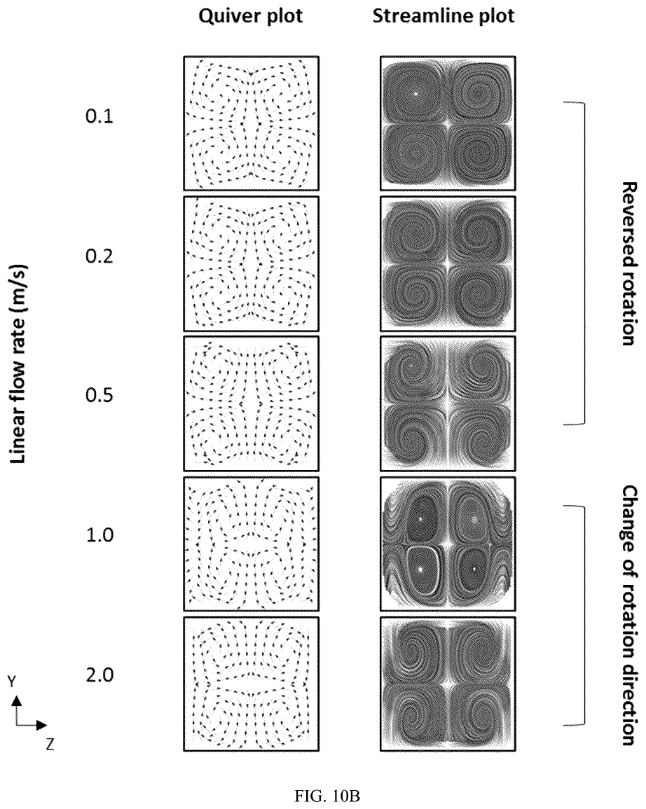

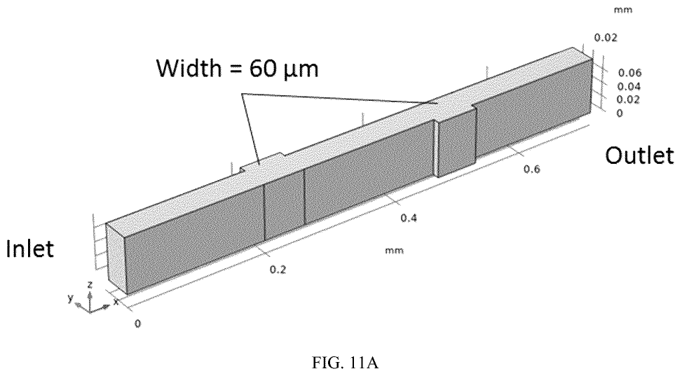

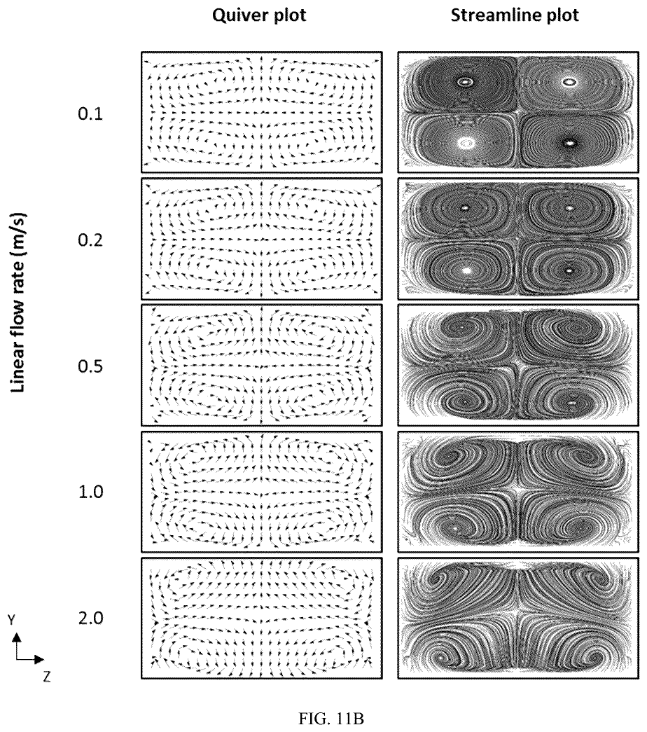

A CFD simulation is performed in COMSOL to visualize this flow and compare it with the popular Dean flow as shown in FIGS. 2C and 8A-9B. Consistent to previous findings, a half arc generates a pair of rotating vortexes—a signature pattern of Dean flow as shown in FIG. 2A, bottom row.^{[15]} When the secondary flow dominates, the flow only circulates but not focuses particles. Thus, it is unable to focus (pinch) the particles along the main flow direction. In contrast, the HAR symmetric orifice consistently creates four converging spiral vortices across linear flow rates spanning from 0.2 m/s to 2 m/s (equivalent to volumetric flow rates from 1.2 mL/hr to 23.0 mL/hr) as shown by the top row of FIG. 2A. These vortices, solely generated by converging secondary flow, drive particles to follow a spiral path and pinch them toward the center of the spiral. Note that this pinching effect has not been reported for the orifice structures, which were commonly used for size-based particle separation instead of focusing. Even though a similar secondary flow can be obtained in these orifice channel designs, which are typically in a low aspect ratio, all vortex flow directions are not consistent and stable at a different flow rate in FIGS. 10A-10B. In effect, the particles are not efficiently focused in the common compartments in these designs. Moreover, the HAR symmetric orifice is not the only viable geometry for creating SFF as a pre-focusing mechanism for DIF. Other alternative HAR orifice structures according to the embodiments of subject invention may create converging secondary flows similar to that of the HAR symmetric orifice shown in FIGS. 11A-11B. The DIF is featured by localizing particles in the channel cross-sectional areas of the common compartments. Next, SFF is applied to the design of the DIF system that can focus particles having diameters ranging, for example, from 6 μm to 40 μm, into a single file as shown in FIG. 2B. The system starts with a periodic structure comprising, for example, 94 units of HAR symmetric orifice connected in series. The total length, for example, 15 mm, ensures a sufficient length to complete secondary flow focusing for particle confinement. With the pinching effect of SFF, only as simple as a naïve IF given by a straight HAR channel having a length of, for example, 25 mm may compensate the size-dispersion in the downstream for single-file formation.

The DIF design is confirmed and the focusing mechanism is simulated and visualized by three-dimensional (3D) imaging trajectories of fast-flowing 6 μm and 15 μm fluorescent microspheres using a confocal microscope as shown FIGS. 2C and 12. In the DIF system, as demonstrated by the simulation, small particles having a diameter, for example, about 6 μm, are focused into four distinctive streams, one at each quadrant of the cross-sectional area after passing the SFF section as shown in FIG. 2C(i). They are then further confined by the naïve IF into a pair of streams on the mid-plane as shown in FIGS. 2C(ii)-2C(iii). Similarly, the large particles having a diameter, for example, about 15 μm, are focused into a pair of streams on the same plane as shown in FIGS. 2C(i)-2C(iii). As a result, the DIF system is capable of compensating the size-dispersion and focusing polydispersity particles into a single file. In contrast, a HAR channel alone shows distinctly different patterns for these two types of particles at the same downstream propagation distance as shown in FIG. 2C(iv). Specifically, large particles are focused into a confined single file while the small particles are focused into a scattered single file with additional residuals located above and below to form a significant dispersion which is arisen from the polydispersity. This comparison clearly shows the unique ability of the embodiments of the subject invention to create a compensable size-dispersion in DIF.

### 1.3. Performance of DIF

The DIF system is further characterized with an extended range of particle sizes and fluid flow rates. As IF is inherently sensitive to particle size and flow rate, common benchmarking of different IF schemes is only restricted to a specific, or a narrow range of them, within which particles can be focused. As a result, the impacts of sample polydispersity are prone to be overlooked or underestimated. To provide a holistic view of the DIF, flowing fluorescent microspheres of multiple sizes, such as 6 μm, 10 μm, 15 μm, 20 μm, 25 μm, and 30 μm, are imaged at various flow rates, for example, 2.4, 6, 12, 18, 24 and 30 mL/hr, and different downstream positions, for example, 15, 20, 25, 30, 35 and 40 mm, as shown in FIGS. 3A-3F and 4A-4E.

FIGS. 3A-3F show dispersion of single-file focusing by DIF (Left) and standard IF (Right), including trajectories of 6 different sets of fast-flowing fluorescence microspheres, each with different size, were individually captured by fluorescence microscopy. In particular, FIGS. 3A-3B show focusing mechanism of DIF having images captured at 6 downstream positions at the flow rate of 18 mL/hr to visualize the evolution of focusing pattern in DIF system, wherein the intensity profiles at the locations indicated by white dotted lines in FIG. 3A are plotted in FIG. 3B. Further, FIG. 3C-3F show consistency across particle sizes having images captured at different volumetric flow rates (Q) at the downstream distance of 40 mm in DIF system of FIG. 3C and HAR rectangular straight channel of FIG. 3E. Moreover, the intensity profiles at the locations indicated by white dotted lines in FIG. 3C and FIG. 3E are plotted in FIG. 3D and FIG. 3F, respectively, with a scale bar of 20 μm in FIGS. 3A, 3C, and 3E, and a scale bar of 5 μm in FIGS. 3B, 3D, and 3F.

### 1.4. Efficient, Continuous Particle Filtration by DIF

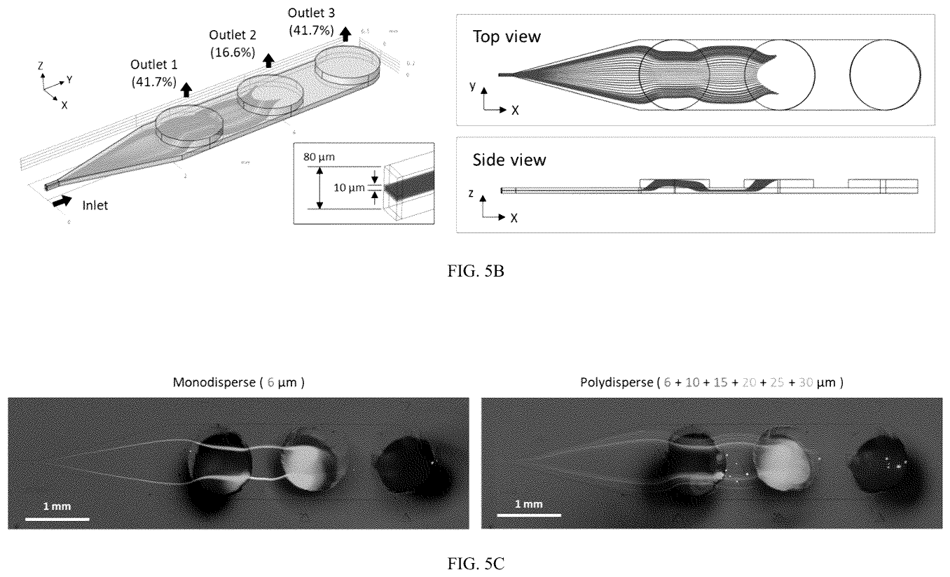

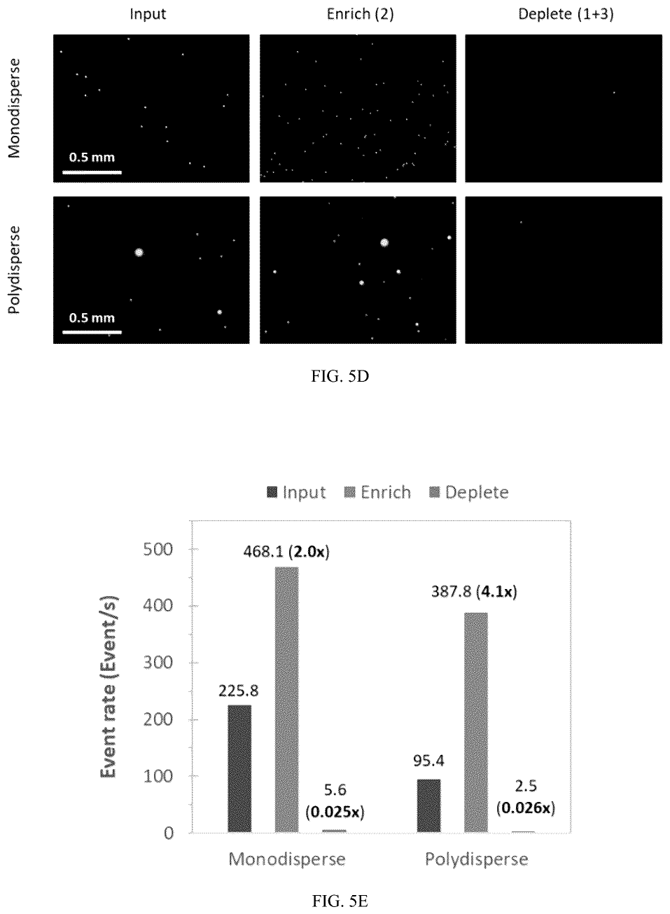

Referring to FIGS. 5A-5E, the DIF system is applied to high-throughput continuous particle filtering operations such as membraneless microfiltration. Microfiltration, in which particles having diameters greater than 5 μm are physically isolated, is effective in removing suspended particles, major pathogens, large bacteria proteins and yeast cells from liquids for purification and are important in pharmaceutical manufacturing^{[33]}, wastewater treatment^{[34]}, desalination^{[35]} and many other applications. An ideal microfilter provides high efficiency (E), high yield (Y), high throughput (T) and long life time as defined by Equations (1)-(3):

$$E = ( 1 - {C}_{out} / {C}_{in} ) \cdot 100 \% \qquad ( 1 )$$

$$Y = {V}_{out} / {V}_{in} \cdot 100 \% \qquad ( 2 )$$

$$T = {V}_{out} / t \qquad ( 3 )$$

where Cₒᵤₜ is the output particle concentration, Cᵢₙ is the input particle concentration, Vₒᵤₜ is the output volume, Vin is the input volume, and t is the total time of filtrating Vₒᵤₜ. Commercial standard membrane-based filter may provide high efficiency, high yield, and high throughput. However, owing to the unavoidable membrane clogging and fouling, these membrane-based filters suffer from limited life time and thus require frequent filter replacement.^{[36-38]} It is thus cost-ineffective in handling large fluid volume and long-term operations, for example microplastics removal from drinking water and environmental samples.^{[30,39]}. On the other hand, IF-based filters utilize stream bifurcation to continuously deplete particles and thereby bypass the use of membrane and its notorious clogging problem.^{[36]} However, the size-dispersion nature of IF makes it challenging to efficiently filter the polydisperse particles while retaining the purified fluid volume at output—leading to an inherent compromise between efficiency and yield of microfiltration. For example, state-of-the-art IF-based microfiltration designs based on Dean flow extensively sacrifice the yield, as high as 50%, to ensure to filter all particles, which are theoretically distributed over half of the channel cross-section.^{[39-43]} The yield can be improved by cascading multiple filters by either narrower filtering band (the range of particle size can be filtered) or fluid recirculation. However, the approach of engineering filtering band comes at the expense of complex design, large footprint and high hydraulic resistance, all of which forbid large-scale parallelization. Recirculation on the other hand sacrifices the filtration time, and eventually limits the filtration throughput.^{[39,43]}

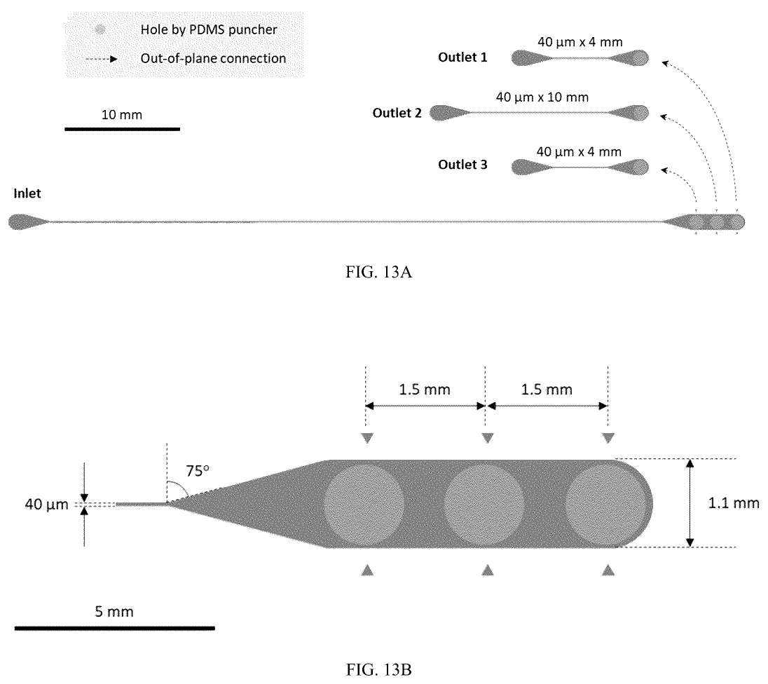

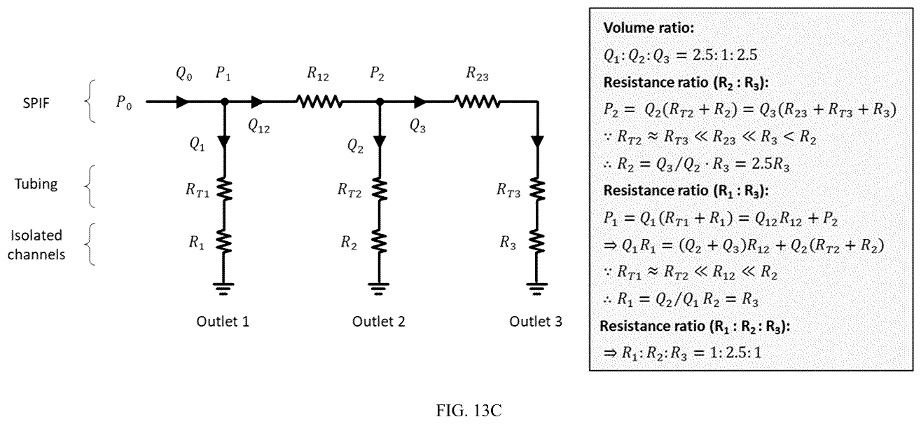

The DIF system provides single-pass, high efficiency, high yield, and parallelizable filtration as shown in FIGS. 5A-5E. The DIF system can be applied as a particle filter by bifucating its outlet. In order to branch a horizontal single-file, a three-outlets-in-series design is configured as shown in FIGS. 5A and 13A-13C. Outlets are connected to different isolated rectangular channels using plastic tubing to control the resistance ratio among them. With a suitable set of resistance, a thin horizontal layer can be precisely depleted at the second outlet as shown in FIGS. 5A(i) and 5A(ii). The filter is configured to isolate a middle layer having a thickness of 10 μm and a 80 μm×40 μm (H×W) rectangular cross-sectional area and the design is verified using the COMSOL simulations, demonstrating that the targeted streamlines (in red) are guided to the second outlet as shown in FIGS. 5B and 13A-13C.

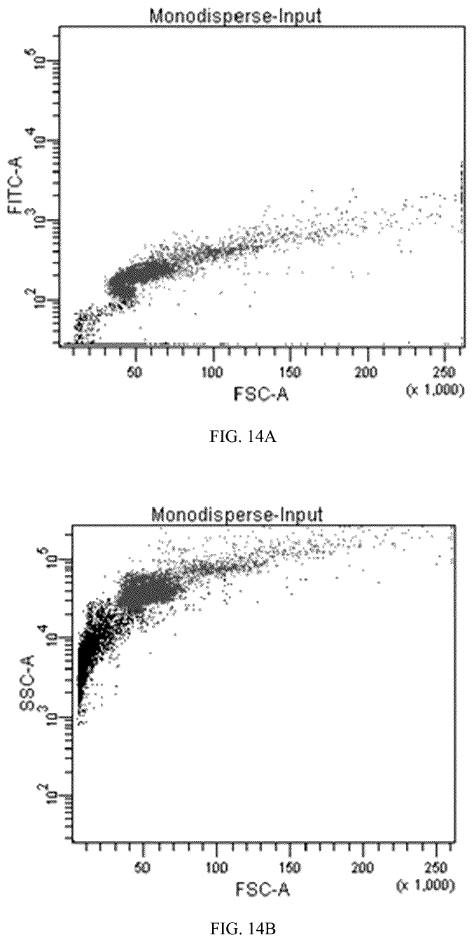

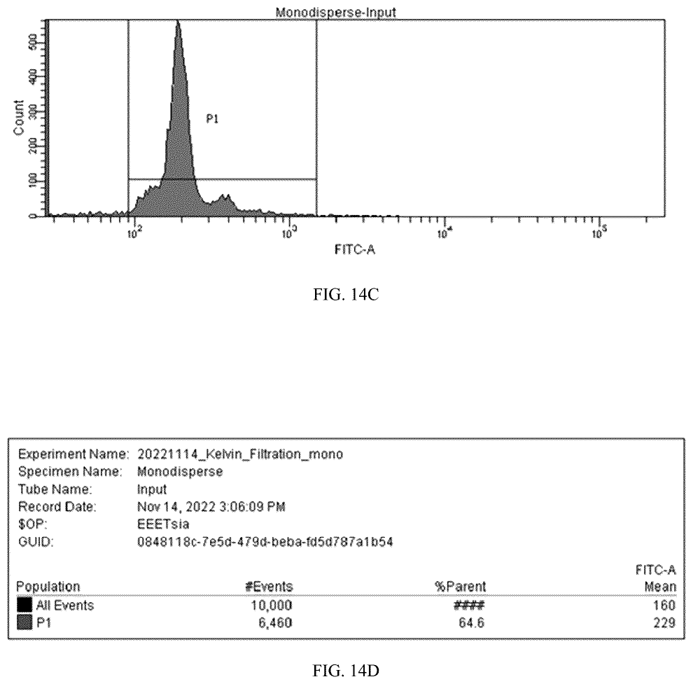

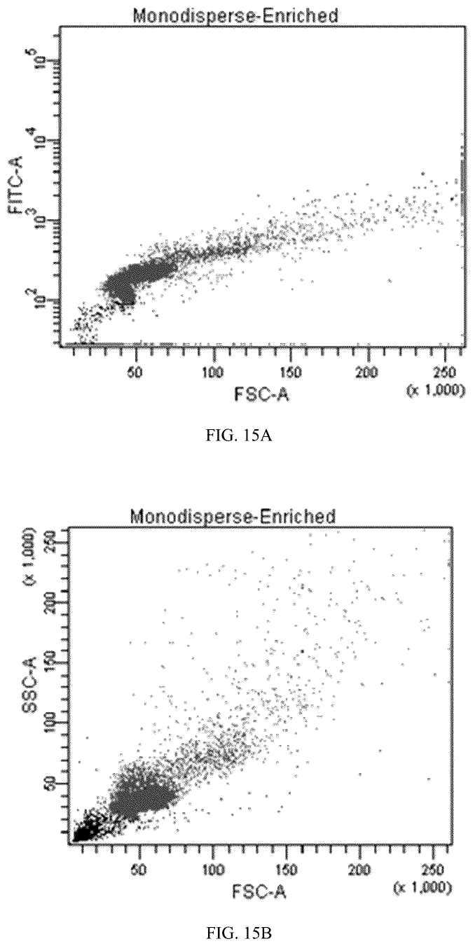

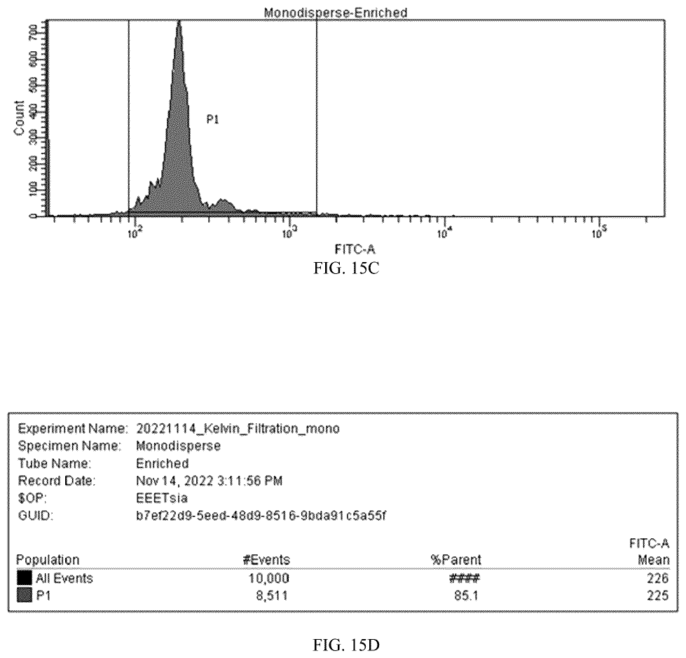

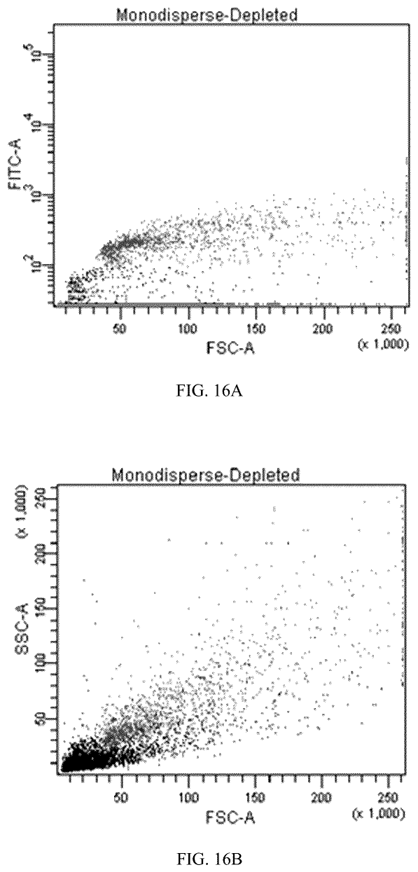

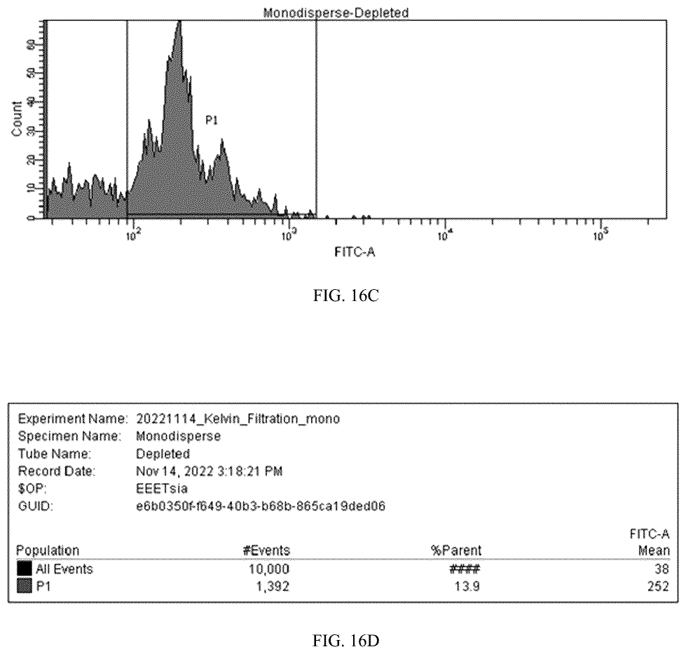

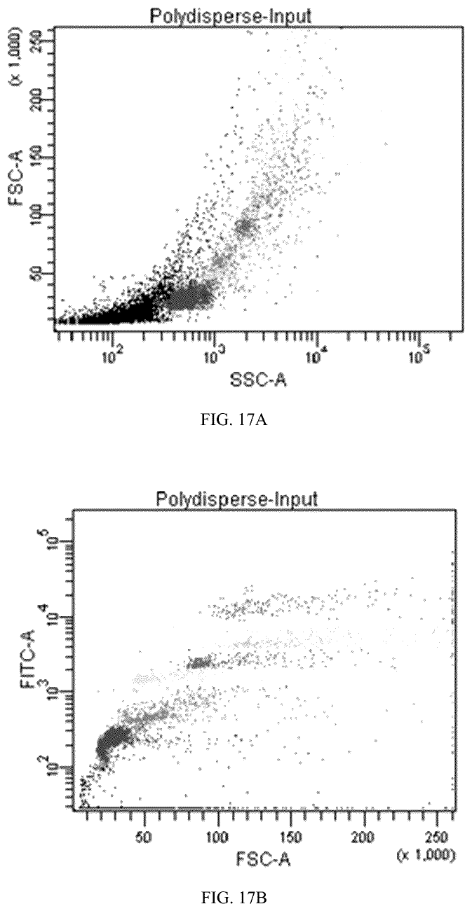

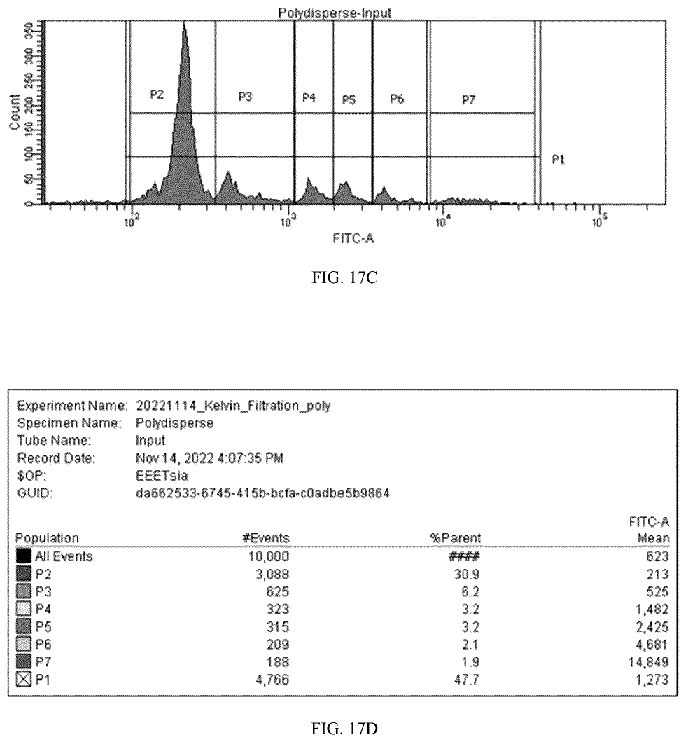

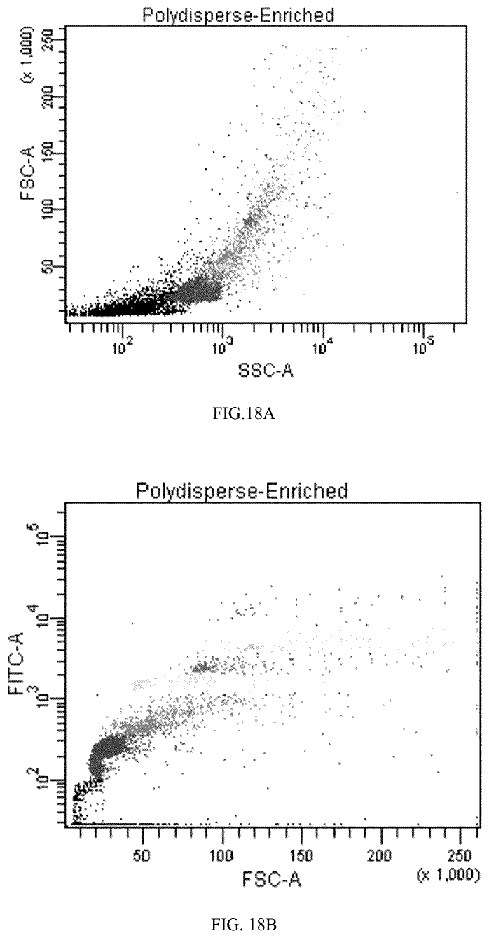

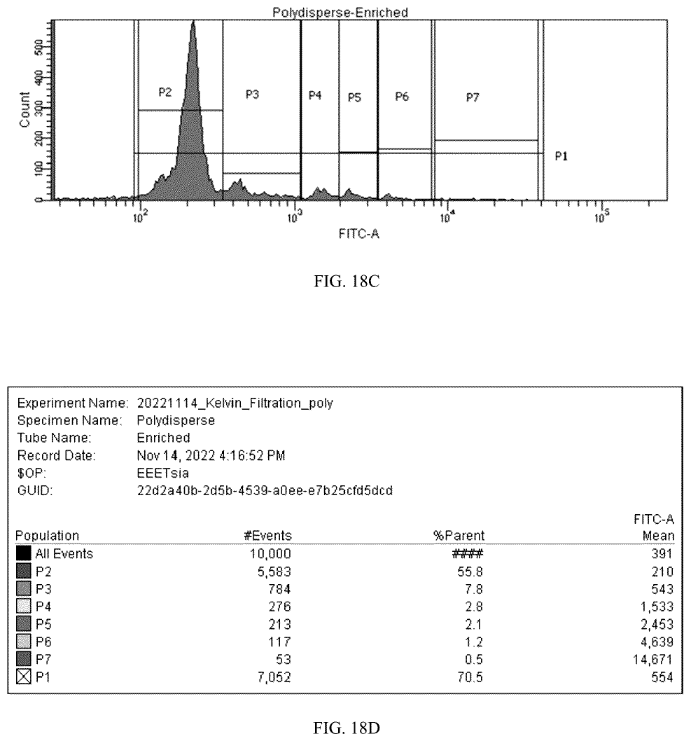

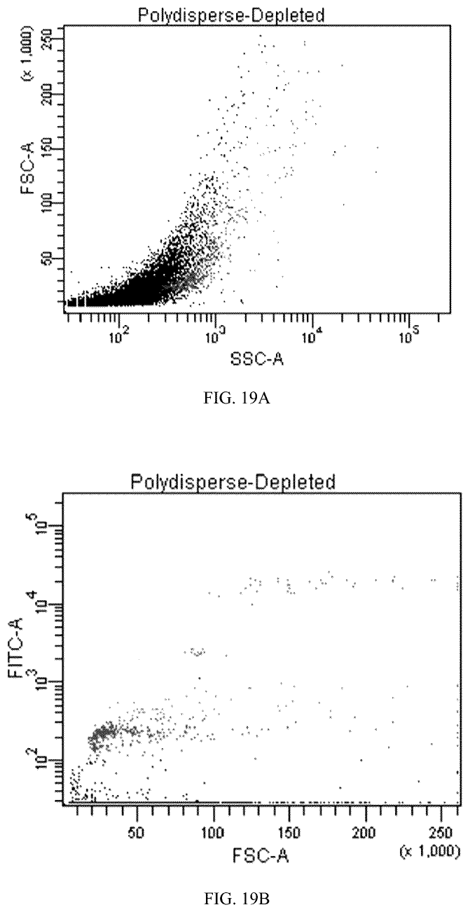

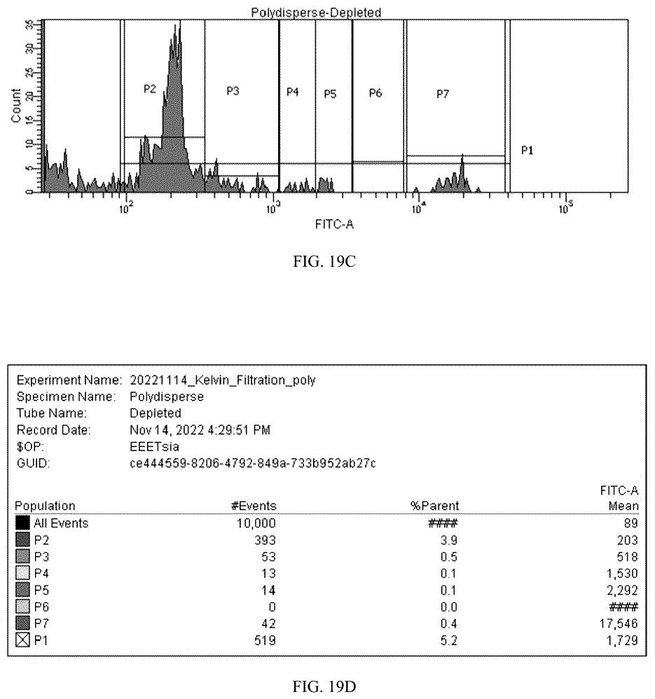

The DIF filter is then configured to deplete microspheres from a monodisperse sample (for example, having a diameter of 6 μm) and a polydisperse sample (for example, having a range of diameters including 6 μm, 10 μm, 15 μm, 20 μm, 25 μm, and 30 μm). The experimental results of both samples show a particle trajectory pattern consistent to the simulation results, where particles are unbiasedly guided toward and depleted at the second outlet as shown in FIGS. 5A-5E. The results do not only indicate a highly efficient focusing of polydisperse particles but also verify that all particles are synchronously focused on the same plane. The fluorescence images of samples collected from these outlets further verify that the particles are significantly depleted from the sample as shown in FIG. 5D. The filtration efficiency is quantified to be about 97.5% and about 97.4% for monodisperse and polydisperse cases, respectively, giving a 40 times concentration reduction in the depleted sample as shown in FIG. 5E. The unbiased filtration is also supported by the consistent fluorescence distributions between input and enriched samples as shown in FIGS. 14A-19D. Given that the yield is as high as 83.3%, the DIF system is capable of inertial focusing for efficient particle filtrations.

### 1.5. A High-Throughput and Unbiased Particle Analysis by DIF

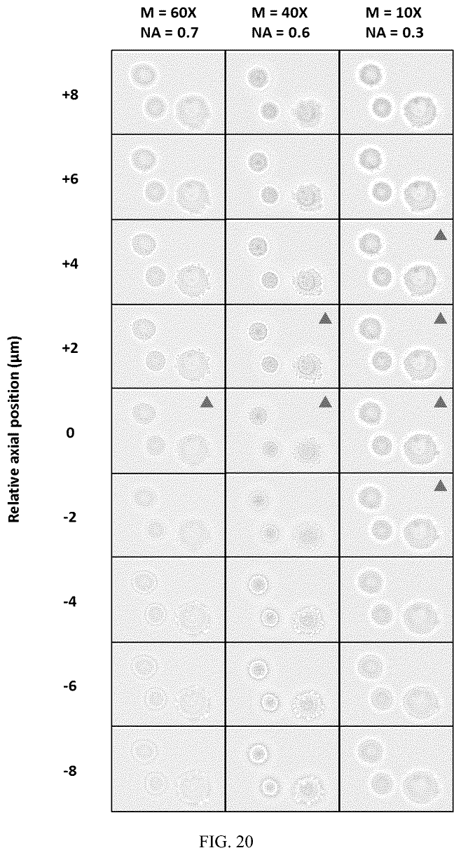

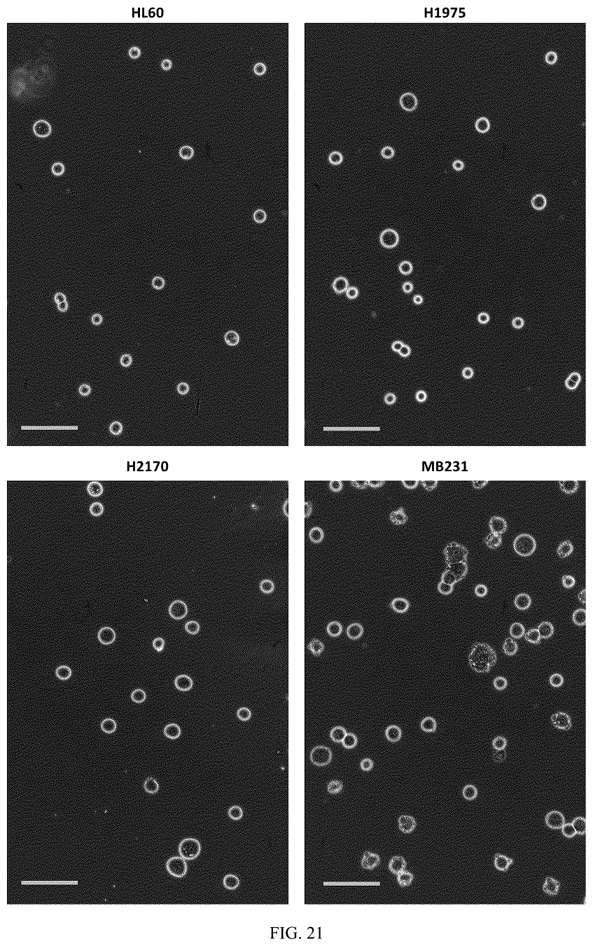

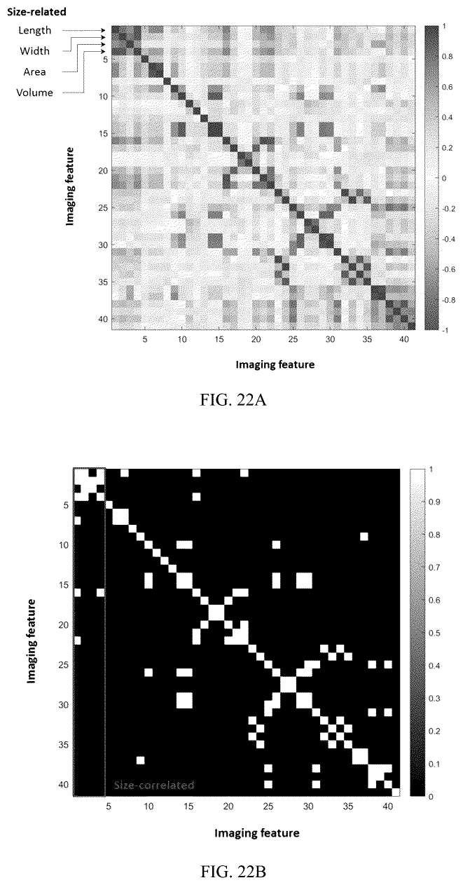

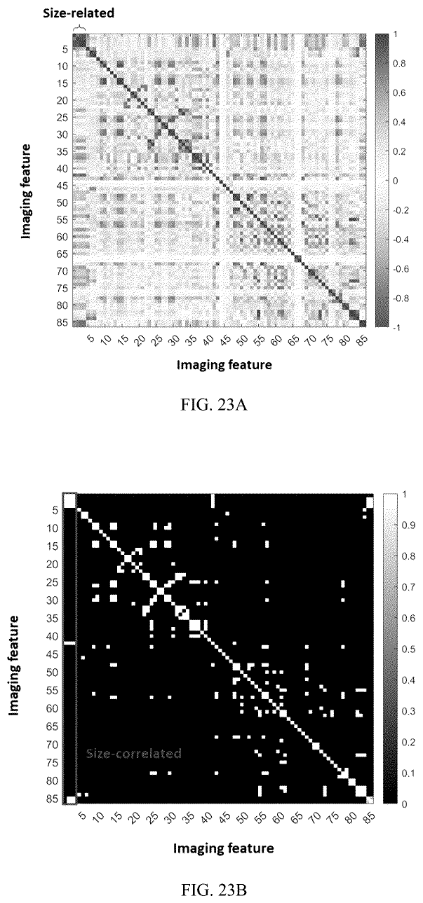

To show the diversity of applications enabled by the DIF system, the DIF system can be further employed to overcome an enduring problem of imaging flow cytometry that hinders its wide dissemination. The rationale of combining advanced imaging with flow cytometry is to gain access to richer morphological information of cells at a large scale and thus to permit a deeper spatial understanding of single-cell states and functions.^{[29,44]} Supercharged by game-changing deep learning, this strategy of image-based cell assay offers automated big-data-driven analytical methods to extract the biologically relevant information hidden in the images. Imaging flow cytometry has potentials for applications such as fundamental biological discovery (for example, single-cell analysis^{[45]}), translational medicine (for example, liquid biopsy^{[32,46,47]}), and pharmaceutics (for example, drug assays^{[32,48,49]}). Nevertheless, producing high-quality and high-resolution images of the fast-flowing cells in suspension remains a long-standing challenge, due to the prerequisite for robust deep-learning image analytics. This condition can only be fulfilled when the cells, which are highly polydisperse in nature, are aligned in a single plane (i.e., single file) well within the optical depth of focus (DOF). It is noted that the range of DOF has to be within a few micrometers in order to achieve sub-cellular resolution, for example, smaller than 3 μm by a typical 40× objective lens as shown in FIG. 20. Hence, this explains that the in-focus yield in many IF-based imaging flow cytometry platforms is typically low. More importantly, the size-dispersion nature of IF inevitably biases the high-quality cell image analytics (from deep-learning model training to morphological profiling), i.e., only the cells with a specific size will be included in the analysis. Highly precise single-file focusing of polydisperse cells is thus critical yet missing in imaging flow cytometry.

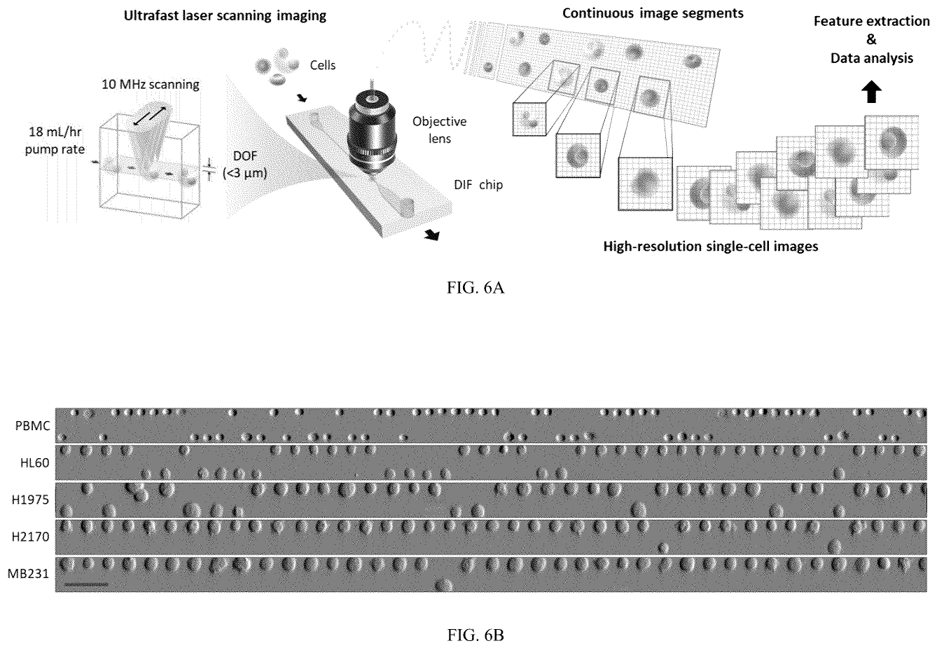

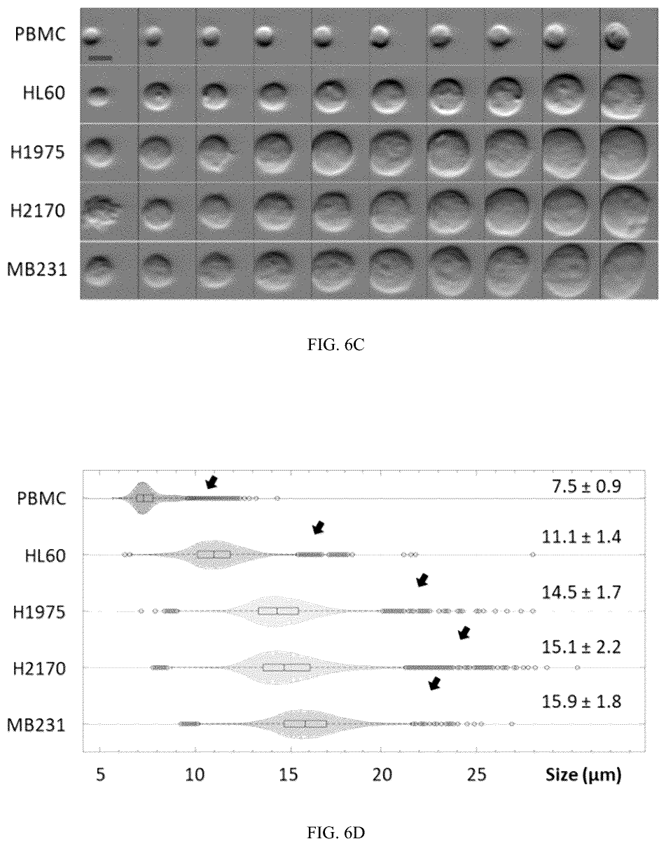

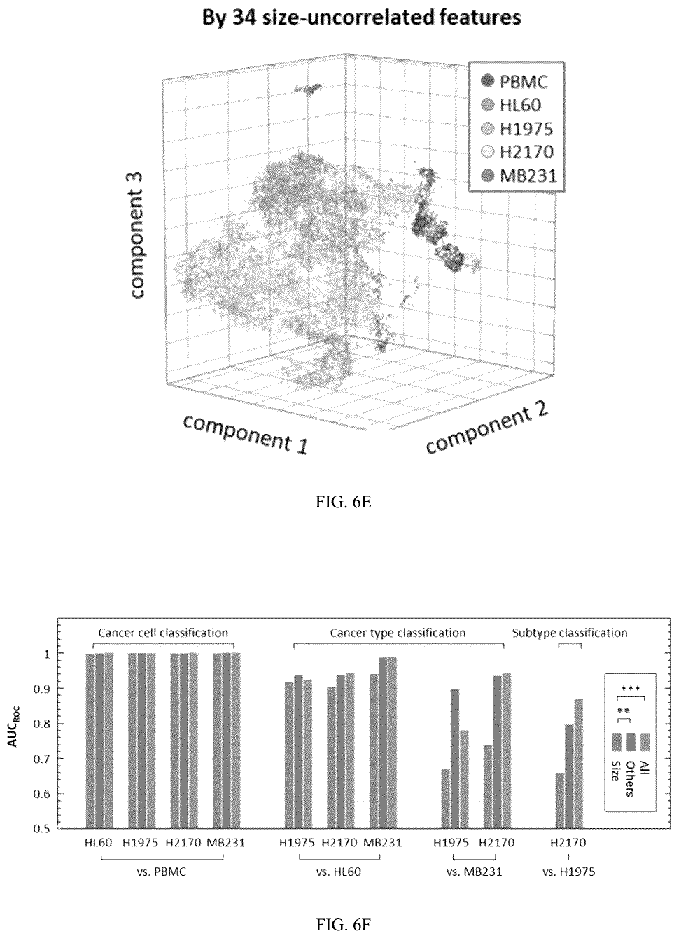

Herein, the DIF system is integrated with the ultrafast laser scanning system to configure a high-yield imaging flow cytometer at a high imaging throughput of 5,000 cell/sec. In exemplary embodiments, its performance was evaluated with five diverse types of human cells, including peripheral blood mononclear cells (PBMCs), a leukemia cell line (HL60), two types of lung cancer cell lines (H1975, H2170) and a breast carcinoma (MB231) as shown in FIGS. 6A-6F. The DIF system consistently aligned the flowing cells within a single plane as supported by the captured in-focus images of these heterogeneous biological cells as shown in FIGS. 6B-6C. The high tolerance to particle polydispersity of the DIF system overcomes the common analytical bias in imaging flow cytometry and thereby enables a quantification of significant variation of cell sizes, which broadly span from 5 μm to 30 μm as shown in FIGS. 6D and 22A-22B. More importantly, it reveals rare outliers (i.e. the very small or large cells) within each cell types that would have otherwise been missed by conventional imaging flow cytometer systems as shown in FIG. 6D.

It is worthy to highlight that the heterogenty of size exists not only among cell types but also within each cell type. The five probability distributions of the sizes have means ranging from 7.5 μm to 15.9 μm with the corresponding STDs ranging from 0.9 μm to 2.2 μm. While these means show statistically significant differences, it only guarantees that the classification based on size is effective on a population level. The comparable magnitudes between mean and STD indicate extensive cross-talks among the cell types, suggesting that it is uncertain to determine a single-cell identity solely based on its sizes. The co-existence of between-type and within-type heterogeneities fundamentally limits the effectiveness of size-based approaches.

The fact that DIF achieves size-insensitive in-focus imaging of cell suspension critically makes it advantageous for reliable high-resolution analysis of cell morphology. This attribute contrasts with the conventional microfluidic imaging flow cytometry approaches where the imaging quality is often limited. Thus, the most effective cytometric analysis is restricted to cell-size characterizations. While cell size is a crucial cell phenotype indicative of cell type and state, it is not always effective, especially when it comes to high heterogeneity between cell types and within a cell type. It can be evident from the partially overlapped size distributions among different cell types captured in the measurements as shown in FIG. 6D. A notable clinical example is circulating tumor cell (CTC) classification in blood, which is crucial for enabling downstream CTC enrichment and, thus, minimal residual disease (MRD) monitoring. Size-based cell detection and separation by IF have been widely adopted in CTC enrichment as the CTC is generally conceived larger than the blood cells. However, it is also known that size-based detection struggles to sensitively detect small CTCs and classify subtypes of cancer cells.^{[31,32]} In this regard, high-throughput morphological analysis of cells offers new dimensions for cell classification, as demonstrated by the DIF-based imaging flow cytometer in FIGS. 6E-6F.

The result suggests that not only between the PBMCs and the other cancer cell types but also between the cancer types can be clearly distinguished by morphological features extracted from the images that are not related to cell size as shown in FIG. 6E where the definition of features and its correlation to size are provided by Table 3 and FIGS. 22A-22B, respectively. The quantification of the classification accuracy by the area-under-curve (AUC) of the receiver-operating-characteristic (ROC) curve reveals that the classification power of size-uncorrelated morphological features outweighs that of the size-correlated in all cases as shown in FIGS. 6F, 23A, 23B, and Table 4. Furthermore, the improvement brought by the morphological features (compared to cell size only) becomes more pronounced when the cell types being classified are more similar. The improvement scales from <2% for identifying cancer cells from PBMCs, <10% for classifying different cancer types, to >10% for classifying cancer sub-types. It is noteworthy that adding the size-correlated features as shown in Table 3 does not significantly improve the classification accuracy. Hence, these results suggest the significance of DIF in enabling large-scale, in-depth analysis of cell morphology.

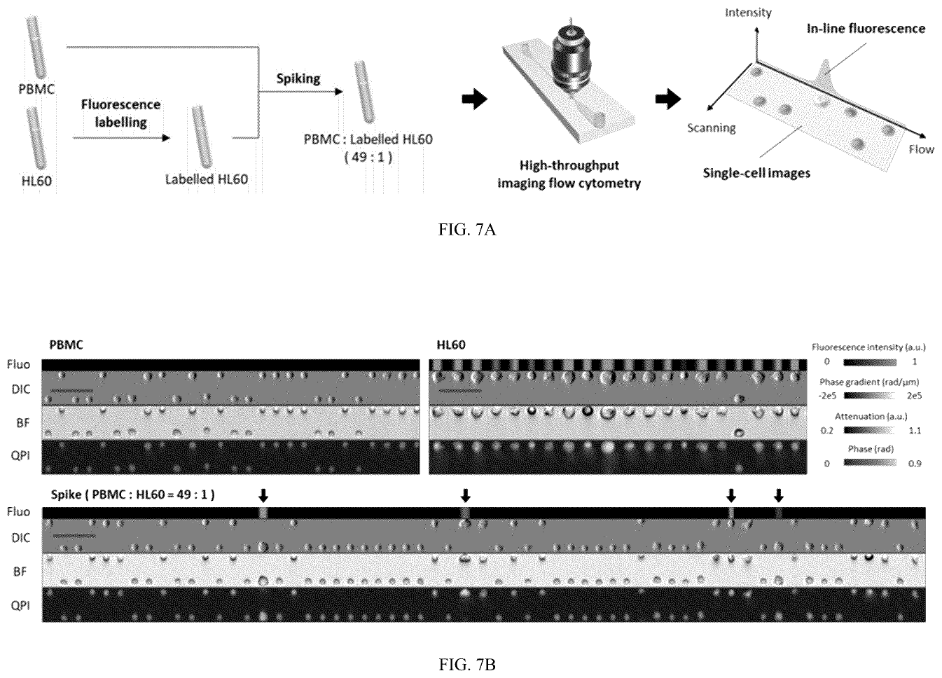

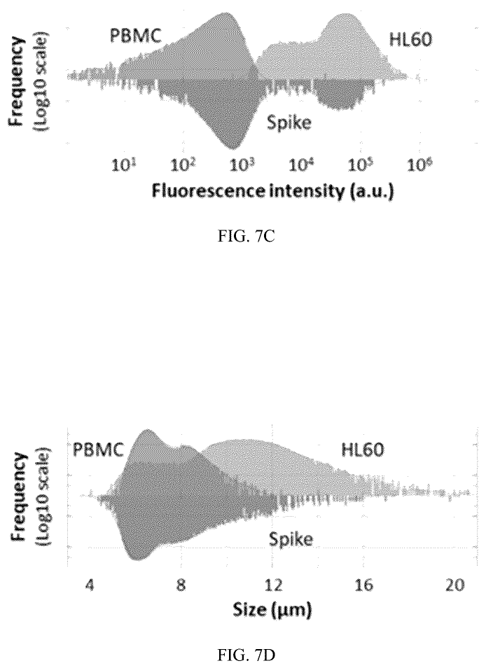

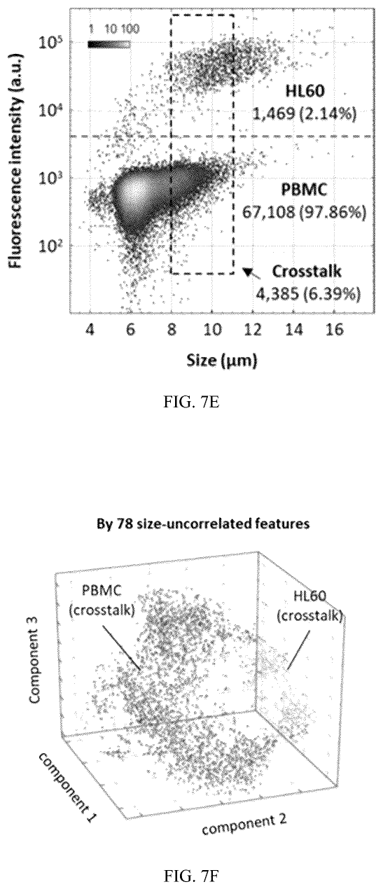

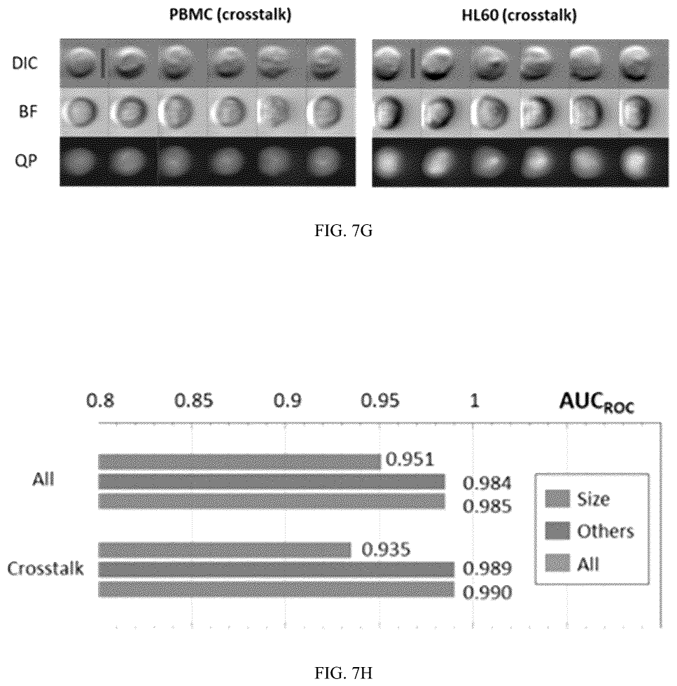

Finally, the performance of DIF-enabled imaging flow cytometry is further challenged with a mixture of human PBMC and fluorescently labelled HL60 cells, which is similar to a practical scenario of leukemic cell detection in the blood as shown in FIG. 7A. In this experiment, the high-throughput imaging flow cytometer was configured to deliver fluorescence detection plus multiple imaging contrasts all simultaneously, including bright-field (BF), differential phase gradient contrast (DPC), and quantitative phase images (QPI).^{[31,32]} The ability of the DIF to favor high-quality imaging of heterogeneous cell populations can be further evident from the consistent imaging performance between the cases of PBMCs and HL60 cells alone versus the spike-in case as shown in FIG. 7B. The fluorescence label is used as a marker for identifying HL60 in this mixture and validating the spike-in ratio as shown in the FIGS. 7B-7D. The measured spike-in ratio of PBMC: HL60 based on the fluorescence is 48.5:1 which closely agrees with the targeted ratio (49:1) as shown in FIGS. 7C and 7E. This high consistency is attributed to the unbiased single-file cell focusing by the DIF.

Without relying on the fluorescence signal, HL60 cells are hardly distinguishable from PBMCs in terms of their sizes as shown in FIGS. 7B and 7D. This can also be evident from the significant overlap between the size distributions of two cell populations. The subset of PBMC and HL60 that shares the same size range, labeled as “crosstalk” subset and enclosed by the dotted line box in FIG. 7E, is explored further if there are subtle differences in the cell morphology between two populations. The high-dimensional phenotypic analysis based on an extended set of 78 size-uncorrelated imaging features clearly distinguishes these two clusters of cells as shown in FIG. 7F. In the multi-contrast images, the HL60s are in general richer in morphological textures than PBMCs with similar sizes as shown in FIG. 7G. The significance of the morphological features, which can only be revealed in in-focus images, can further be supported by the comparable classification accuracies between the “crosstalk” subset of cells and the case using all the cells, where the AUCs of ROC curves are as great as 0.984 and 0.989 as shown in FIG. 7H, respectively. Furthermore, features ranking also shows that size-uncorrelated parameter is among the top-ranked features contributing to the classification as shown in FIG. 7I. This spike-in demonstration thus substantiates the unique capability of DIF in enabling high-throughput, high-quality morphological analysis of cells, going beyond the conventional IF methods, which are highly cell-size-biased.

### 1.6. Summary

Traditional approaches for IF are inherently size-sensitive and are thus broadly conceived as effective only for separating microparticles and cells based on their sizes. Counter-intuitively, a new form of IF that can focus polydisperse particles into a single file instead of separating them is presented here. According to an embodiment of subject invention, the DIF system, which can tightly focus particles and cells across a diverse size range (6-40 μm, i.e., >100 times difference in volume) into a single file as thin as <3 μm is achieved. This focusing performance (for example, >95% efficiency) is also consistent across a wide range of practical flow rates (for example, 2.4-30 mL/hr).

The concept of DIF would have a two-fold impact on technological and application fronts. First, the size-insensitiveness of DIF is a result of initial particle distribution engineering assisted by the converging (pinching) secondary flow. This approach is fundamentally different from the additional force field modification adopted by the conventional IF that inevitably leads to the size-dispersion effect in particle focusing. As a result, the DIF incentivizes microfluidic development to improve IF-based microfluidic devices to allow more diverse forms of particle focusing (or, generally, manipulation) regardless of the particle size. Second, the DIF diversifies the applications of IF, which have long been limited to size-dependent particle or cell separation/enrichment. In the embodiments of the subject invention, it is demonstrated that the DIF can further be employed in applications where particle/cell size is irrelevant, for example, holistic microfiltration and high-resolution imaging flow cytometry, which were once challenging for the traditional IF-based devices.

Notably, the DIF-based membrane-less microfilter efficiently and continuously depletes microparticles by 40 times at high throughput, regardless of size. This microfiltration technique thus impacts desalination, water purification and pharmaceutical and biomedical processes that have been relying on the membrane filtration. In addition, it is also demonstrated that the DIF enables high-resolution morphological analysis of cells at high yield, i.e. >95% of the cells in-focus, in contrast to about 50% in the case of the conventional IF-based imaging cytometry.^{[31]} The DIF significantly allows unbiased, accurate image-based cell classification, regardless of cell size, which is particularly pertinent in a wide range of imaging cytometry applications. Notable exemplary embodiments include in-depth morphological profiling and analysis of cells, which have been proven promising in mining specific patterns in the profile to reveal disease-associated phenotypes^{[51]} or mechanism of action of drugs^{[52]}; and image-activated cell sorter^{[53,54]} in which high-quality in-focus images are the key to triggering valid sorting decision for downstream molecular analysis. Therefore, by improving the tolerance to particle polydispersity in microfluidic manipulation and analysis, the DIF can further disseminate IF in a wider range of applications in the fields of biology, medicine, and industrial manufacturing.

The concept and method of DIF have a two-fold impact on technological and application fronts. First, its effective dispersion suppression comes from inserting an extra secondary-flow-dominant system instead of tailor-making a multi-field system. Fundamentally different from the prevailing approach, this method allows separate geometries for the inertial force and the secondary flow. It not only reduces the complexity but also gives higher flexibility to design dispersion-free systems. As a result, the embodiments of the subject invention incentivize microfluidic developers to reinvent IF-based microfluidic devices that unleash more diverse forms of particle focusing (or, generally, manipulation) regardless of particle size. Second, DIF diversifies the applications of IF, which have long been limited to size-dependent particle or cell separation/enrichment. It is demonstrated that DIF can further be employed in applications where particle/cell size is irrelevant, e.g., holistic microfiltration and high-resolution imaging flow cytometry, which were once challenging with the traditional IF-based devices.

### 1.7. Design of DIF

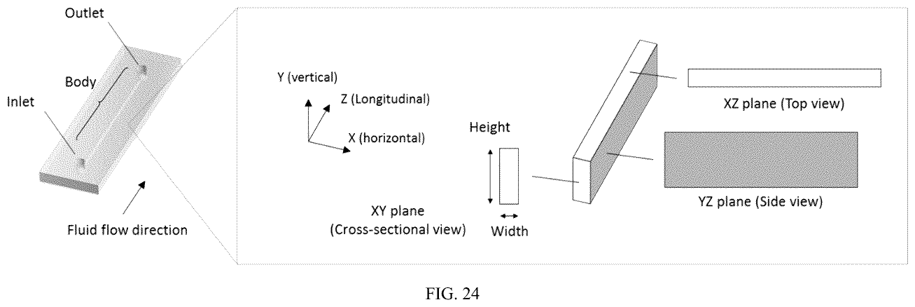

Referring to FIG. 24, an embodiment of the inertial focusing system with detailed geometrical description is provided.

Herein, the term “particle focusing” refers to confining particles' positions in the cross-section of a microfluidic channel. In the inertial focusing, this confinement originates from the cross-streamline migration of particles introduced by two geometry-depending forces, namely, shear-gradient-induced lift force and wall-induced lift force. This pair of counteracting forces results in an inertial force field in the channel cross-section that moves particles to the nearest focal point where the net force is zero when Reynolds number (Re) is sufficiently large.

$$Re = \frac{ρ \cdot {D}_{h} \cdot {U}_{m}}{μ}$$

$$ρ = carrier fluid density$$

$${D}_{h} = hydrlic diameter of channel = ( 2 \cdot w \cdot h ) / ( w + h ) .$$

$$w = channel width ,$$

$$h = channel height ,$$

$${U}_{m} = maximum flow velocity$$

$$μ = dynamic viscosity of the fluid$$

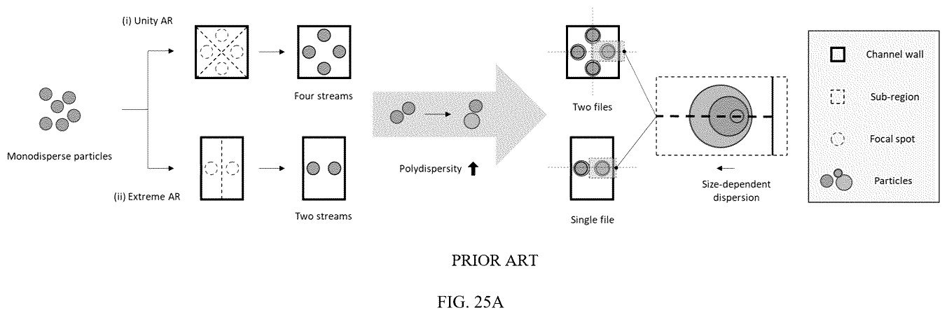

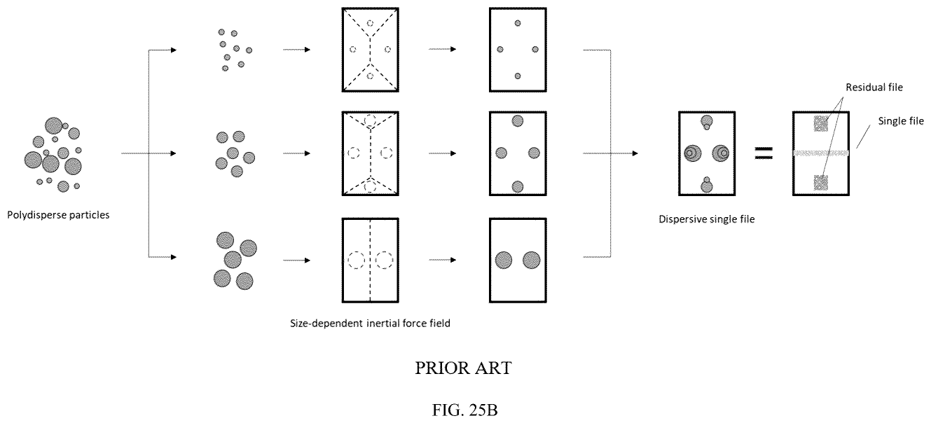

In the absence of external force field and non-Newtonian fluid, a focal point forms at a short distance away from the center of wall, on its perpendicular bisector. As a result, four focal points, which are seen as four streams along the flow direction, form in typical microchannels with a square cross-section as shown in FIG. 25A(i). It is essential to note that the positions of these focal points are size dependent such that the larger the particle, the closer the position to the center of the cross-section. Taking particle size into consideration, particles are distributed to two perpendicular bisectors, instead of four points, and form two perpendicular files along the flow as shown in FIG. 25A(i). The simplest approach of single-file focusing is by maximizing the difference of shear-force-gradients between two bisectors to destabilize focal points on the one with a weaker gradient. The widely adopted approach to implement this idea is using an extreme aspect-ratio (AR) of the channel cross-section, i.e., height>>width (high aspect ratio, HAR) or width>>height (low aspect ratio, LAR). In this case, the short focal line remains while the long focal line disappears as shown in FIG. 25A(ii). Nevertheless, the stability of the focal points also depends on the particle sizes. Changing the ARs is insufficient in handling highly polydisperse particles and results in a low single-file focusing efficiency as shown in FIG. 25B.

It is intuitive to remove the residuals along the long focal line for a higher size-averaged focusing efficiency of the single file. The conventional approaches implement this idea by applying a secondary flow (that is, a flow pattern on the channel cross-section), remarkably the Dean flow. It is a passive, size-insensitive, bilaterally symmetric, circulating force field that can be introduced by a curved structure of microchannel. Serpentine, spiral patterns have thus been the mainstay for a Dean-flow-assisted inertial focusing. Given a balance between two force fields conditioned by the force ratio between Dean and inertial forces (R_{f}), these designs effectively remove residuals outside the single file.

$${R}_{f} = \frac{{F}_{L}}{{F}_{D}} = \frac{2 \cdot R \cdot {a}^{2}}{{D}_{h}}$$

$${F}_{L} = Inertial lift force$$

$${F}_{D} = Dean force$$

$$R = Radius of curvature$$

$$a = particle size$$

$${D}_{h} = hydralic diameter$$

Despite the success, the Dean flow introduces a significant size-dependent dispersion of focal point to the inertial force field. It smears the single file along the long walls and distributes particles according to its size. This phenomenon frustrates the purpose of single-file focusing of polydisperse particles that practically limits the use of microchannel in focusing real-life samples. For instance, the focusing covers a few micrometers while biological cells can range from a few to a few tens of micrometers. While one may attempt to recover the single file by compensating this dispersion with a downstream inertial focusing, this approach may not work as the dispersion may not be localized within the original compartment of the inertial force field. This effect was once demonstrated and utilized by Oakey J. et al. for a single stream focusing of a specific size of particle, such as 10 μm. It is particularly effective for small particles and in turn goes back to the low single-file focusing efficiency. Besides, the spreading of dispersion also depends on the fluid flow rate. It suggests that the higher the flow rate is, the narrower the particle size coverage and thus the lower efficiency of the recovered single file are. This challenge has been a long-standing hurdle for implementing single-file inertial focusing on real-life samples.

It is noted that this challenge originates from the uncompensated size-dependence of inertial force field, which can be elaborated in terms of the convergence and symmetry of Dean flow. First, Dean flow cannot solely remove residuals without affecting the single file unlike the inertial force due to its circulating nature. Second, its bilateral symmetry does not match with the bisymmetry of inertial force field. Together, particles cannot be localized in one of all sub-regions of inertial force field by a continuous Dean flow—size-dependency of inertial focusing eventually remains.

Herein, a single-file inertial focusing of polydisperse particles based on the concept of dispersion-free inertial focusing (DIF) is employed to overcome this challenge. The key game changer in DIF is the “secondary-flow focusing (SFF)” enabled by a converging secondary flow, in which its vortex eyes are fast-converging and can be analogous to the foci of inertial force field. This feature allows one to retain the focusing power even when the secondary dominants and thereby to ensure localizing the dispersion across a wide range of flow rates and particles sizes. Furthermore, with all vortex eyes engineered to fall into the compartment of inertial force field that corresponds to the single file, this localized dispersion can always be compensated by the inertial focusing for a tight single file of polydisperse particles.

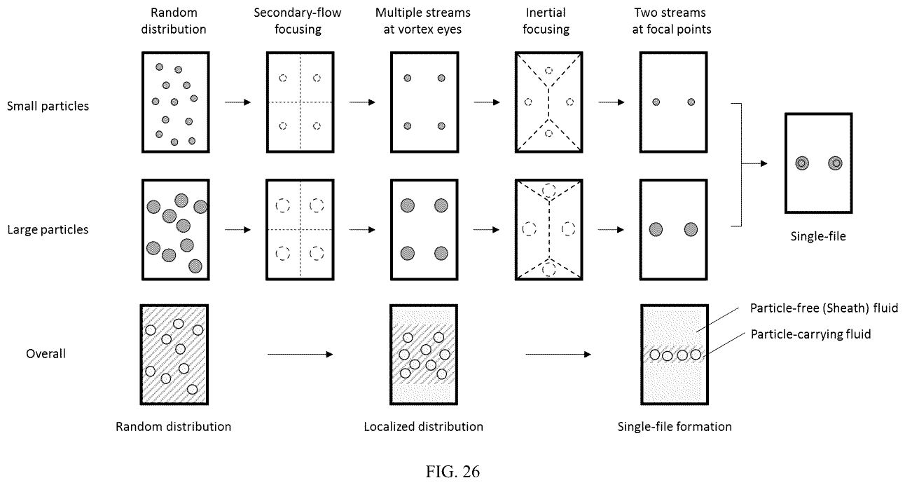

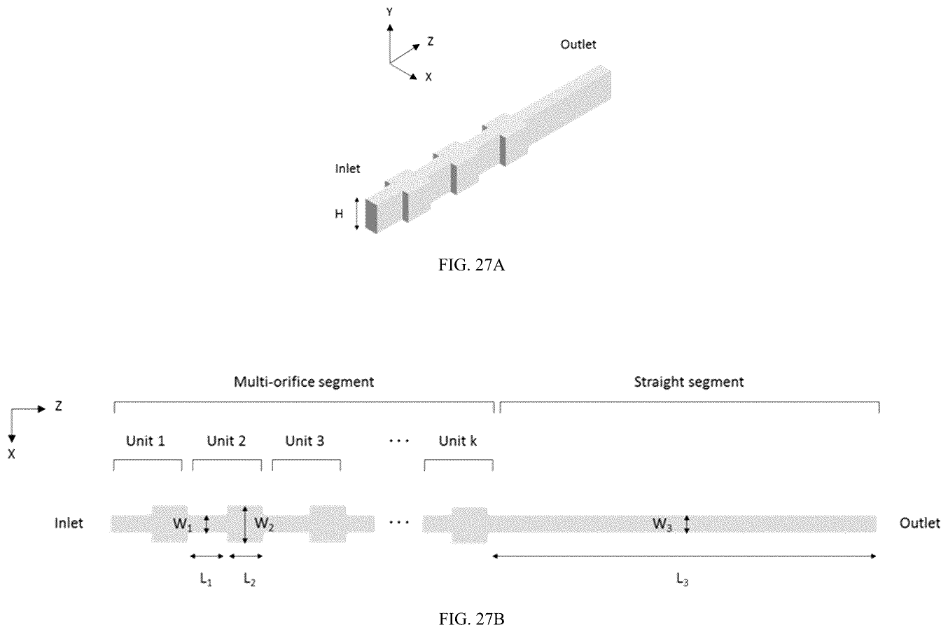

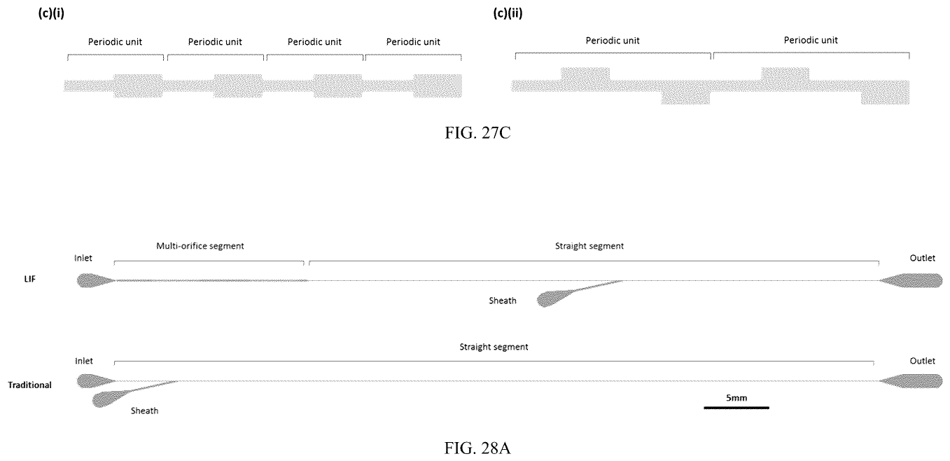

In terms of implementing secondary-flow focusing for DIF, referring to FIG. 26, one embodiment employs a two-staged, multi-orifice-straight microchannel where the multi-orifice segment comprises multiple periodic units of symmetric orifice structure described in FIG. 27B. This microchannel has a HAR rectangular cross-section to define the single file on the horizontal (xz) plane where:

$${AR}_{n} = \frac{H}{{W}_{n}} \geq 0.75 , n = 1 and 3$$

$${AR}_{n} = aspect ratio of segment n$$

$$H = channel right$$

$${W}_{n} = channel width of segment n$$

The height and the minimum width of this channel also define the range of particle size that can be focused into single file where:

$$0.07 \cdot H \leq a \leq min ( {W}_{n} )$$

$$a = particle size$$

$$H = channel height$$

$${W}_{n} = channel width of segment n$$

To generate the converging secondary flow, the expanded segment of the periodic orifice unit must have a larger width and a lower AR where:

$$\{ \begin{matrix}{W}_{2} > {W}_{1} \geq {W}_{3} \\ {AR}_{2} < {AR}_{1} \leq {AR}_{3}\end{matrix}$$

$${AR}_{n} = aspect ratio of segment n$$

$$H = channel height$$

$${W}_{n} = channel width of segment n$$

To ensure an overall HAR inertial focusing effect, the length of the orifice segments must satisfy:

$${L}_{1} \geq {L}_{2}$$

$${L}_{n} = Length of segment n$$

The length of segments must also be sufficiently long for the inertial focusing to complete:

$${L}_{n} \geq \frac{3 π \cdot μ \cdot {D}_{n}^{2}}{4 \cdot ρ \cdot {U}_{m} \cdot {a}^{3}} ( \frac{{W}_{n}}{{C}_{L}^{-}} + \frac{H}{{C}_{L}^{+}} ) , {C}_{L}^{+} ≪ {C}_{L}^{-} , n = 1 , 2 , 3$$

$$ρ = carrier fluid density$$

$$μ = dynamic viscosity of the fluid$$

$${D}_{n} = hydrlic diameter of segment n$$

$${U}_{m} = maximum flow velocity$$

$$a = minimum particle siz e$$

$$H = channel height$$

$$W = channel width of segment n$$

$${C}_{L}^{-} = negative lift coefficient$$

$${C}_{L}^{+} = positive lift coefficient$$

The abovementioned criteria apply to the embodiments that employs alternating asymmetric orifice structure as the periodic unit.

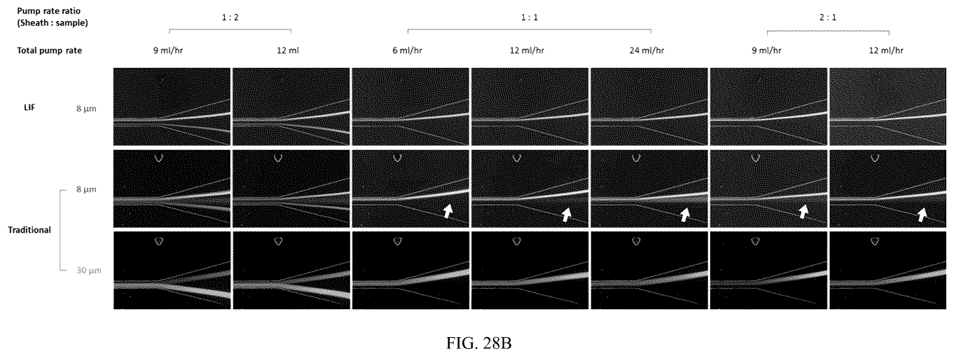

Besides the single-file inertial focusing, the DIF can be configured to perform single-stream focusing by an additional sheath flow as shown FIGS. 28A-28B. Extending the embodiments of particle confinement, one can further confine particles to one of all sub-regions of inertial force field for the single-stream focusing. Co-flow with sheath fluid in a HAR rectangular channel to confine all particles into one of the two horizontal sub-regions is thus a simple solution in delivering single-stream focusing. However, one-dimensional sheathing is not effective in handling polydispersity of particles as small particles experience a two-dimensionally partitioned inertial force field as abovementioned. FIG. 28B illustrates this incapability. For large particles, a clean single stream forms with a 1:1 sheath-to-sample ratio as predicted by the theory; for small particles, residuals still exist at a large sheath-to-sample ratio as shown in FIG. 28B. In contrast, since residuals are removed in DIF, the problem is simplified to one-dimension that an additional sheathing can efficiently form single stream for small and thus polydisperse particles as shown in FIG. 28B.

### Materials and Methods

### Microfluidic Chip Fabrication

The microfluidic channels are fabricated using a standard soft lithograpy including photolithography and molding.

Photolithography: A 4-inch silicon wafer (UniversityWafer, Inc., US) is first coated with a 80 μm-thick layer of photoresist (SU-8 2025, MicroChem, US) using a spin coater (spinNXG-P1, Apex Instruments Co., India), followed by soft-baking (at 65° C. for 3 minutes and then at 95° C. for 9 minutes). After cooling under the ambient temperature, a maskless photolithography machine (SF-100 XCEL, Intelligent Micro Patterning, LLC, US) transfers the channel pattern obtained by computer-aided design to the coated-wafer with exposure time of 8 seconds. Then, a post-baking (for 2 minutes at 65° C. and then 7 minutes at 95° C.) is performed. The patterned wafer is developed with the SU-8 developer (MicroChem, US) for 10 minutes, followed by rinsing with IPA and drying. Finally, the wafer is hardbaked at 180° C. for 15 minutes to be ready for the molding.

Molding of polydimethylsiloxane (PDMS)-glass chip: The PDMS precursor (SYLGARD® 184 Silicone Elastomer kit, Dow Corning, US) is mixed with the curing agent with a ratio of 10:1 before pouring onto the silicon wafer. A custom-designed glass block is placed on the silicon wafer to control the channel height of regions besides the inlet and outlet to be about 1 mm. After degassing in a vacuum chamber, the wafer is then incubated in an oven at 65° C. for 4 hours for PDMS curing. After demolding, the PDMS block is punched using a PDMS puncher with a diameter of 1 mm (Miltex 33-31 AA, Integra LifeSciences, US) to open inlets and outlets for plastic tubings (BB31695-PE/2, Scientific Commodities, Inc., US) insertion. Microchannels are then formed by bonding the PDMS block to a glass slide using an oxygen plasma (PDC-002, Harrick Plasma, US), followed by baking at 65° C. for 30 minutes in an oven.

Molding of PDMS-PDMS chip: The PDMS precursor (SYLGARD® 184 Silicone Elastomer kit, Dow Corning, US) was mixed with the curing agent with a 10:1 ratio. Half of the mixture was poured onto the silicon wafer with the channel pattern and another half onto a plain wafer. After degassing in a vacuum chamber, both wafers were then incubated in an oven at 80° C. for 2 hours for PDMS curing. After demolding, the PDMS block with the pattern was punched using a PDMS puncher with a 1 mm diameter (Miltex 33-31 AA, Integra LifeSciences, US) to open inlets and outlets for plastic tubings (BB31695-PE/2, Scientific Commodities, Inc., US) insertion. Microchannels were then formed by bonding two PDMS blocks using oxygen plasma (PDC-002, Harrick Plasma, US), followed by baking at 80° C. for 30 minutes in an oven. For channels that can only be fabricated in HAR (i.e., DIF and STEP in FIGS. 3A-3F), 3 mm-wide microchips were cropped out of the PDMS block. The long sides of the channel were coated with uncured 10:1 PDMS mixture and then sandwiched between two glass slides for 2 hours of incubation at 80° C. to clear the side wall for imaging.

### Imaging

2D Particle Flow Trajectory Imaging: An inverted microscope (Ti2E, Nikon Instruments Inc., JP) with an epi-fluorescence imaging (a multi-bandpass filter set including FITC (480/515) and TRITC (540/575) detection) is used to capture the trajectories of flowing fluorescent microspheres. All images are captured using a 40× objective lens (NA=0.7), except for the case of whole-field imaging in particle filtration which is captured using 4× objective lens (NA=0.2). For each trajectory image, a bright-field image is captured together with the fluorescence image to indicate the positions of channel walls on the fluorescence images. The exposure time of the fluorescence image is set to be 1 second to ensure that sufficient amount of particles are captured.

3D Particle Flow Trajectory Imaging: A confocal microscope (A1R MP+ Multiphoton microscope, Nikon Instruments Inc., JP) is used to capture the trajectories of green fluorescent microsphere of particle sized of 6 μm and 15 μm flowing at a linear speed of 0.87 m/s (equivalent to a volumatric flow rate of 10 mL/hr). A 20× dry objectives lens (NA=0.75) is used to provide a lateral (x/y axis) resolution of about 0.4 μm and an axial (z axis) resolution of about 1 μm across the entire imaging field of view (120 μm (x)×120 μm (y)×80 μm (z)). The exposure time and the frame averaging are set to be 10 us and 4 for each scanning point, respectively.

Ultrafast Laser Scanning Imaging: A home-built ultrafast laser scanning system, multi-ATOM, is employed for continuously capturing high-resolution single-cell images with multiple label-free contrasts and an in-sync fluorescence signal. The system adopts all-optical laser scanning to achieve a scanning rate of 10 MHz. In particular, a custom all-fiber broadband pulsed IR laser (bandwidth=about 10 nm; repetition rate=10 MHz; center wavelength=1064 nm) is first temporally dispersed by a dispersive optical fiber (group-velocity dispersion=1.78 ns/nm) and then spatially dispersed by a diffraction grating (1200 grove/mm) after launching to the free space to create an ultrafast swept source. A 40× objective lens (NA=0.65) demagnifies the laser beam to scan a one-dimensional (1D) field of view of 60 μm perpendicular to the fluid flow direction at an optical resolution of 1 μm and a depth of view of 3 μm. A multiATOM module encodes four phase-gradient contrasts, which can be digitally converted to differential-phase, bright-field, and quantitative-phase contrasts, to the light beam prior to the photodetection by a high-speed single-pixel photodetector (electrical bandwidth=12 GHz). In the system backend, a real-time field programmable gate array based signal processing system (electrical bandwidth=2 GHz, sampling rate=4 GSa/s), on which custom logic such as FPGA is configured to automatically detect and segment cells from the digitized data stream, is operated at a processing throughput equivalent to >10,000 cell/s. All segmented cell images (four different gradient-contrast contrasts per cell) are sent through four 10G Ethernet links and are stored by four data storage nodes with a total memory capacity of over 800 GB. For each cell, the two dimensional (2D) complex-field information (for example, bright-field and quantitative phase) is retrieved from the four different phase-gradient contrasts based on a method using complex Fourier integration. In the fluorescence detection module, a continuous wave laser (wavelength=488 nm) is employed to generate line-shaped fluorescence excitation spatially and temporally synchronized with the imaging signals. The epi-fluorescence signals are detected by a photomultiplier tubes (PMT). The FPGA may be configured to synchronously obtain the signals from multi-ATOM and fluorescence detection from each single cell at a high speed.

### Computational Fluid Dynamics ((FD)) Simulation

All simulations are carried out by COMSOL Multiphysics 5.6 in a single phase and stationary condition. The parameter of material is set to be water (density=1 g/cm³).

Secondary Flow Modelling: A periodic unit of each simulated geometry is simulated while considering the 2^{nd} order terms. The inlet is conditioned at a fully-developed flow profile at certain flow rates in the unit of m/s. The outlet is conditioned to have a pressure of 0 Pa. The cross-sectional positions of streamlines at the start and the end are extracted for computing the displacement of streamlines in the cross-sectional areas, where the simulated secondary flow is generated by the simulated structure.

Direct numerical simulation (DNS) of inertial force field: DNS is based on the Flow at Specific Particle Position (FSPP) method. In brief, a microparticle flowing inside a microchannel was modeled as a hollow sphere placed at the center of a long pipe with a rectangular cross-section (for example, 40 μm(w)×80 μm(h)). The particle is restricted from moving laterally while allowed to move longitudinally and rotate freely to obtain the lift force. The channel walls were set as moving walls to render a moving frame to simplify the simulation. A fluid flow was introduced by setting the two ends of the pipe as the inlet and the outlet, which was conditioned with a fully developed flow profile at the list of flow rates in the unit of mL/hr and a pressure of 0 Pa, respectively. Ordinary differential equations were set up to introduce the conservation of linear and angular moments. Under this condition, the lift force at a specific location on the channel cross-section can be acquired when the linear speed and the angular momentum reach equilibrium. The simulation was repeated with different lateral positions of the particle and inertial forces were sampled through the entire channel cross-section—resulting in an inertial force field. The same procedure was repeated with different particle sizes and flow rates to examine the dispersion.

Filtration Modelling: The outlet of the DIF filter is simulated. The inlet condition is set to full-developed profile flowing at a rate of 1 m/s. To simulate the depletion effect under limited computing resources, instead of extending the outlets with different remote channels, these outlets are conditioned to the corresponding pressures, which is 70, 40 and 0 Pa, respectively. The streamline of the middle 10 μm-thick layer is plotted to visualize the single-file depletion effect.

### Particle Sample Preparation

Fluorescent Polystyrene Microsphere: fluorescent polystyrene microsphere (Phosphorex. Inc, US) used has 1% solid content without any prior surface treatment and is suspended in 1 mL de-ionized water containing a small amount of surfactant and 2 mM of sodium azide. Six different sizes, 6 μm (2106C), 10 μm (2106G, 2227), 15 μm (2106L), 20 μm (2229), 25 μm (2230), 30 μm (2231) are selected where 2106C, 2106G and 2106L are in green color, while 2227, 2229, 2230 and 2231 are in orange color. Samples are wetted, diluted and filtered prior to the experiments to minimize aggregation and channel clogging. In particular, for each sample, 100 μL solution is diluted by 10 mL 10% bovine serum albumin (BSA) solution for 15 minutes, centrifuged under 100 g for 5 minutes, and then resuspended in 5 mL deionized water to produce a 0.02% solid content. Samples are filtered by a cell strainer with a pore size of 30 μm (SKU 43-50030-50, pluriSelect Life Science, DE) right before being pumped into the microchannels. The mixture used in particle filtration is prepared by mixing the particle suspensions (0.02% solid content) of particle sized of 6 μm, 10 μm, 15 μm, 20 μm, 25 μm and 30 μm.

Human Peripheral Blood Mononuclear Cells (PBMC's): PBMCs are negatively isolated by PBMC isolation kit (130-115-169, Miltenyi Biotec Inc., CA) from human buffy coat provided by the Hong Kong Red Cross. Written consents for clinical care and research purposes are obtained from the donors. The research protocol is approved by the Institutional Review Board of the University of Hong Kong (IRB Reference No.: UW 17-219) and complied with the Declaration of Helsinki and acts in accordance to ICH GCP guidelines, local regulations and Hospital Authority and the University policies. Buffy coats and all reagents used are prewarmed to room temperature. 3 mL of buffy coat is 1:1 diluted by PBS in a 15 mL centrifuge tube. 5 mL of Ficoll is carefully layered on top to avoid mixing with the solution below. The solution is centrifuged under 400 g for 20 minutes, producing 5 distinct layers in the centrifuge tube. The second layer from the top which corresponds to PBMCs is then carefully extracted using a 1 mL pipette tip. Next, the extracted PBMCs are rinsed with 1×PBS once by centrifuging under 200 g for 5 minutes and resuspended in fresh 1×PBS.

Human Cancer Cell Lines: Culture medium for MDA-MB-231 (HTB-26™, ATCC, US), and MCF-7 (HTB-22D™, ATCC, US) is cultured in DMEM medium (Gibco™) supplemented with 10% PBS and 1% 100× antibiotic-antimycotic (Anti-Anti, Thermo Fisher Scientific, US). Cells are cultured in a 5% CO₂ incubator under 37° C. and the medium is renewed twice a week. Cells are pipetted out adjusted to be around 105 cells per mL of 1×PBS. Prevention of mycoplasma contamination is performed by adding Antibiotic-Antimycotic (Thermo Fisher Scientific, US) during the cell culture. Cellular morphology is routinely checked during the cell culture under light microscope prior to the imaging experiments.

The adenocarcinoma cell lines H1975 (L858R and T790M)) and the squamous cell carcinoma cell lines (H2170) are obtained from American Type Culture Collection (ATCC) and authenticated using the Human STR profiling cell authentication service. They are expanded and cultured in the tissue culture flasks having a surface area of 75 cm². The full culture medium is ATCC modified RPMI-1640 (Gibco) supplemented with 10% fetal bovine serum (FBS) (Gibco) and 1% antibiotic-antimycotic (Gibco). The cells are placed in a CO₂ incubator with 5% CO₂ at 37° C. Passage or change of medium is done 2-3 times a week depending on the cell confluency.

Live-cell Fluorescence Labeling: HL60s are stained with CellTracker™ Green CMFDA dye (Thermo Fisher Scientific, US) for the green fluorescence. The lyophilized product is first warmed at room temperature and dissolved in Dimethyl sulfoxide (DMSO) to a final concentration of 1 mM. Briefly, 20 μl of DMSO is added to each vial as stock solution. After washing sample with PBS three times by removing the supernatant after centrifugation at 1000 rpm, cell samples are stained with the staining solution, which comprises CellTracker™ stock solution and serum-free RPMI 1640 medium at a concentration of 1:1000. Samples in the staining solution are incubated at 37° C. for 30 minutes and resuspended with PBS after removing the staining solution with centrifugation as aforementioned.

Flow Cytometry: Six samples (the input, enriched and filtrated samples of monodisperse and polydisperse cases) are analyzed using BD FACSAriaIII (BD Bioscience, IN). For fluorescence detection, 488 nm laser and FIT-C channel are chosen for excitation and detection, respectively. The recorded event is set to 10,000 for each sample. A gating is performed on the FIT-C signals to identify fluorescent microspheres and the average event rates are recorded for comparison.

Data analysis (quantifying dispersion): The dispersion is defined as the sum of spreading and drifting. These two parameters were quantified as two dimensionless numbers based on the statistical moments of the intensity profiles shown in FIGS. 30A-30E. For each system, the spreading is calculated by averaging the standard deviations computed from each monodispersed profile; while the drifting is calculated by calculating the mean of each intensity profile, its standard deviation of mean along particle size, and the flow-rate-averaged standard deviations (see Table 10 for the equations for characterizing the dispersion).

### EXEMPLARY EMBODIMENTS

Embodiment 1. A microfluidic device for focusing polydisperse particles suspended in a particle-carrying fluid, comprising:
a fluidic channel configured to localize distributions of the polydisperse particles in a cross-sectional area of the fluidic channel.

Embodiment 2. The microfluidic device of embodiment 1, wherein the fluidic channel is formed to have either a plurality of high aspect ratio (HAR) symmetric orifice structures connected in series by HAR rectangular structures, or a plurality of high aspect ratio (HAR) alternating asymmetric orifice structures connected in series by HAR rectangular structures.

Embodiment 3. The microfluidic device of embodiment 2, wherein dimensions of the fluidic channel are configured such that a converging secondary flow having four spiral vortices is generated.

Embodiment 4. The microfluidic device of embodiment 3, wherein each of the spiral vortices drives the polydisperse particles to flow inward following a spiral path to be concentrated into a center of the spiral vortex such that the polydisperse particles are focused by the converging secondary flow without any inertial force.

Embodiment 5. The microfluidic device of embodiment 1, wherein the fluidic channel has a length between 1 mm and 100 mm.

Embodiment 6. The microfluidic device of embodiment 1, wherein the polydisperse particles have diameters ranging from 6 μm to 40 μm.

Embodiment 7. The microfluidic device of embodiment 1, wherein the polydisperse particles are carried by a fluid flowing at a volumetric throughput ranging between 2.4 mL/hr and 30 mL/hr.

Embodiment 8. A high-throughput single-file focusing system for polydisperse particles suspended in a particle-carrying fluid, comprising:
the microfluidic device according to embodiment_1, for pre-focusing the polydisperse particles; and
an extended HAR rectangular structure coupled to the microfluidic device, receiving the pre-focused polydisperse particles and further confining the polydisperse particles to form a single file on a mid-plane of the extended HAR rectangular structure.

Embodiment 9. The high-throughput single-file focusing system of embodiment 8, wherein the dimensions of the microfluidic device and dimensions of the extended HAR rectangular structure are configured to have corresponding predetermined ratios.

Embodiment 10. The high-throughput single-file focusing system of embodiment 8, wherein a focusing efficiency greater than 95% is obtained.

Embodiment 11. A system for continuous particle filtration/enrichment, comprising:
a high-throughput single-file focusing device for polydisperse particles suspended in a particle-carrying fluid comprising:
a microfluidic structure for pre-focusing the polydisperse particles comprising a fluidic channel configured to localize distributions of the polydisperse particles in a cross-sectional area of the fluidic channel; and
an extended HAR rectangular structure coupled to the microfluidic structure for pre-focusing, receiving the pre-focused polydisperse particles and further confining the polydisperse particles to form a single file on a mid-plane of the extended HAR rectangular structure;
wherein the high-throughput single-file focusing device comprises a plurality of outlets coupled in-series to control resistance ratios between the outlets.

Embodiment 12. The system for continuous particle filtration/enrichment of embodiment 11, wherein the high-throughput single-file focusing device is configured to deplete a mixture of microspheres of a monodisperse sample and a polydisperse sample.

Embodiment 13. The system for continuous particle filtration/enrichment of embodiment 12, wherein the monodisperse sample includes particles having a diameter of about 6 μm.

Embodiment 14. The system for continuous particle filtration/enrichment of embodiment 12, wherein the polydisperse sample has particles having diameters ranging between 6 μm and 30 μm.

Embodiment 15. The system for continuous particle filtration/enrichment of embodiment 12, wherein a filtration efficiency of about 97.5% and a filtration efficiency of about 97.4% are obtained for the monodisperse sample and the polydisperse sample, respectively.

Embodiment 16. A system for in-depth particle analysis, comprising:
a high-throughput single-file focusing device for polydisperse particles suspended in a particle-carrying fluid; and
an imaging flow cytometry coupled with the high-throughput single-file focusing device;
wherein the high-throughput single-file focusing device comprises:
a microfluidic structure for pre-focusing the polydisperse particles comprising a fluidic channel configured to localize distributions of the polydisperse particles in a cross-sectional area of the fluidic channel; and
an extended HAR rectangular structure coupled to the microfluidic structure for pre-focusing, receiving the pre-focused polydisperse particles and further confining the polydisperse particles to form a single file on a mid-plane of the extended HAR rectangular structure.

Embodiment 17. The system for in-depth particle analysis of embodiment 16, wherein the particles include five types of human cells, including peripheral blood mononclear cells (PBMCs), a leukemia cell line (HL60), two types of lung cancer cell line (H1975, H2170) and a breast carcinoma (MB231).

Embodiment 18. The system for in-depth particle analysis of embodiment 17, wherein sizes of the cells of the samples range from 5 μm to 30 μm.

Embodiment 19. The system for in-depth particle analysis of embodiment 17, wherein the cells have heterogenty of size both among cell types and within each cell type.

Embodiment 20. The system for in-depth particle analysis of embodiment 19, wherein five probability distributions of the cell sizes have means ranging from 7.5 μm to 15.9 μm with corresponding standard deviations (STDs) ranging from 0.9 μm to 2.2 μm.

Embodiment 21. A microfluidic device for achieving a targeted particle distribution for dispersion-free inertial focusing (DIF) of polydisperse particles, comprising:
a HAR orifice structure configured to create a secondary vortex flow with a plurality of converging spiraling vortices, each of the converging spiraling vortices being at a perspective one of each quadrant of the orifice structure.

Embodiment 22. The microfluidic device of embodiment 21, wherein the HAR symmetric orifice structure is configured to create a pinching effect.

Embodiment 23. The microfluidic device of embodiment 21, wherein the HAR symmetric orifice structure is optimized by maximizing a repetition frequency such that the secondary flow outruns an inertial force to make zoning effects absent or minimized.

Embodiment 24. The microfluidic device of embodiment 21, wherein the polydisperse particles are pinched by the secondary vortex flow along long walls of a channel of the HAR symmetric orifice structure.

Embodiment 25. The microfluidic device of embodiment 21, wherein the particle distribution is shaped and localized outside a residual zone of the channel of the HAR rectangular channel.

Embodiment 26. The microfluidic device of embodiment 21, wherein the dispersion of the particle distribution is automatically compressed by the downstream inertial focusing to form a single-file DIF of polydisperse particles, free from dispersion.

Embodiment 27. The microfluidic device of embodiment 21, wherein the particles have an average diameter in a range between 6 μm and 30 μm.

Embodiment 28. The microfluidic device of embodiment 21, wherein a flow carrying the particles has an average flow rate in a range between 2.4 mL/hr and 30 mL/hr.

Embodiment 29. The microfluidic device of embodiment 21, wherein the HAR orifice structure is a symmetric structure.

Embodiment 30. The microfluidic device of embodiment 21, wherein the HAR orifice structure is an asymmetric structure.

Embodiment 31. The microfluidic device of embodiment 21, wherein a particle focusing efficiency in DIF is quantified by a parameter, loss, which is defined as a ratio of out-of-focus particles to the total number of particles.

Embodiment 32. The microfluidic device of embodiment 31, wherein the loss of the DIF system is quantified to be about 1.5±2% (mean±standard deviation (std)) across all particle sizes,

Embodiment 33. The microfluidic device of embodiment 31, wherein the loss of the HAR straight channel is about high as 12±13.9%.

Embodiment 34. The microfluidic device of embodiment 31, wherein the loss is decreased when particle sizes are larger.

Embodiment 35. A single-file dispersion-free inertial focusing (DIF) system of polydisperse particles, comprising a plurality of the microfluidic devices of embodiment 21 cascaded to an inlet of a HAR rectangular straight channel with an identical cross-section.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] J. M. Martel, M. Toner, Annu. Rev. Biomed. Eng. 2014, 16, 371.
[2] J. Zhang, S. Yan, D. Yuan, G. Alici, N.-T. Nguyen, M. E. Warkiani, W. Li, Lab Chip 2016, 16, 10.
[3] N. V. Menon, S. Bin Lim, C. T. Lim, Curr. Opin. Pharmacol. 2019, 48, 155.
[4] S. Zhu, F. Jiang, Y. Han, N. Xiang, Z. Ni, Analyst 2020, 145, 7103.
[5] M. E. Warkiani, A. K. P. Tay, B. L. Khoo, X. Xiaofeng, J. Han, C. T. Lim, Lab Chip 2015, 15, 1101.
[6] J. Shrestha, S. R. Bazaz, L. Ding, S. Vasilescu, S. Idrees, B. Söderstörm, P. M. Hansbro, M. Ghadiri, M. E. Warkiani, Lab Chip 2022.
[7] J. Zhou, I. Papautsky, Lab Chip 2013, 13, 1121.
[8] H. Amini, W. Lee, D. Di Carlo, Lab Chip 2014, 14, 2739.
[9] C. Liu, G. Hu, X. Jiang, J. Sun, Lab Chip 2015, 15, 1168.
[10] J. Bingyan, P. Tao, Y. Shuai, Z. Mingyong, Prog. Chem. 2021, 33, 1780.
[11] Q. Zhao, D. Yuan, J. Zhang, W. Li, Micromachines 2020, 11, 461.
[12] J. Zhou, I. Papautsky, Microsystems Nanoeng. 2020, 6, 1.
[13] J. Zhang, S. Yan, R. Sluyter, W. Li, G. Alici, N.-T. Nguyen, Sci. Rep. 2014, 4, 1.
[14] Y. Ying, Y. Lin, Sci. Rep. 2019, 9, 1.
[15] D. Di Carlo, D. Irimia, R. G. Tompkins, M. Toner, Proc. Natl. Acad. Sci. 2007, 104, 18892.
[16] S. R. Bazaz, A. Mihandust, R. Salomon, H. A. N. Joushani, W. Li, H. A. Amiri, F. Mirakhorli, S. Zhand, J. Shrestha, M. Miansari, Lab Chip 2022, 22, 4093.
[17] C. Ni, Z. Zhou, Z. Zhu, D. Jiang, N. Xiang, Anal. Chem. 2022.
[18] Y. Gou, S. Zhang, C. Sun, P. Wang, Z. You, Y. Yalikun, Y. Tanaka, D. Ren, Anal. Chem. 2019, 92, 1833.
[19] S. Shen, C. Tian, T. Li, J. Xu, S.-W. Chen, Q. Tu, M.-S. Yuan, W. Liu, J. Wang, Lab Chip 2017, 17, 3578.
[20] M. Rafeie, S. Hosseinzadeh, J. Huang, A. Mihandoust, M. E. Warkiani, R. A. Taylor, Biomicrofluidics 2019, 13, 34118.
[21] L. Zhao, M. Gao, Y. Niu, J. Wang, S. Shen, Sensors Actuators B Chem. 2022, 369, 132284.
[22] J.-S. Park, S.-H. Song, H.-I. Jung, Lab Chip 2009, 9, 939.
[23] T. S. Sim, K. Kwon, J. C. Park, J.-G. Lee, H.-I. Jung, Lab Chip 2011, 11, 93.
[24] A. J. Chung, D. Pulido, J. C. Oka, H. Amini, M. Masaeli, D. Di Carlo, Lab Chip 2013, 13, 2942.
[25] S. A. Dar, S.-I. Yeh, Microfluid. Nanofluidics 2022, 26, 1.
[26] D. Jiang, C. Ni, W. Tang, D. Huang, N. Xiang, Biomicrofluidics 2021, 15, 41501.
[27] J. M. Martel, M. Toner, Sci. Rep. 2013, 3, 1.
[28] A. Özbey, M. Karimzadehkhouei, Ö. Bayrak, A. Koşar, Microfluid. Nanofluidics 2018, 22, 1.
[29] K. C. M. Lee, J. Guck, K. Goda, K. K. Tsia, Trends Biotechnol. 2021, 39, 1249.
[30] Y. Picó, D. Barceló, ACS omega 2019, 4, 6709.
[31] K. C. M. Lee, M. Wang, K. S. E. Cheah, G. C. F. Chan, H. K. H. So, K. K. Y. Wong, K. K. Tsia, Cytom. Part A 2019.
[32] D. M. D. Siu, K. C. M. Lee, M. C. K. Lo, S. V Stassen, M. Wang, I. Z. Q. Zhang, H. K. H. So, G. C. F. Chan, K. S. E. Cheah, K. K. Y. Wong, Lab Chip 2020.
[33] R. H. Davis, Curr. Trends Futur. Dev. Membr. 2019, 29.
[34] H. S. Santana, J. L. Silva, B. Aghel, J. Ortega-Casanova, SN Appl. Sci. 2020, 2, 1.
[35] S. H. Roelofs, A. van den Berg, M. Odijk, Lab Chip 2015, 15, 3428.
[36] M. E. Warkiani, A. K. P. Tay, G. Guan, J. Han, Sci. Rep. 2015, 5, 1.
[37] A. Gul, J. Hruza, F. Yalcinkaya, Polymers (Basel). 2021, 13, 846.
[38] M. W. Hakami, A. Alkhudhiri, S. Al-Batty, M.-P. Zacharof, J. Maddy, N. Hilal, Membranes (Basel). 2020, 10, 248.
[39] C. K. Chen, J. Zhang, A. Bhingarde, T. Matotek, J. Barrett, B. D. Hardesty, M. M. B. Holl, B. L. Khoo, Chem. Eng. J. 2022, 428, 132614.
[40] N. Xiang, X. Shi, Y. Han, Z. Shi, F. Jiang, Z. Ni, Anal. Chem. 2018, 90, 9515.
[41] N. Xiang, Q. Li, Z. Shi, C. Zhou, F. Jiang, Y. Han, Z. Ni, Electrophoresis 2020, 41, 875.
[42] Y. Fang, S. Zhu, W. Cheng, Z. Ni, N. Xiang, Lab Chip 2022, 22, 3545.
[43] B. Miller, M. Jimenez, H. Bridle, Sci. Rep. 2016, 6, 1.
[44] M. Doan, I. Vorobjev, P. Rees, A. Filby, O. Wolkenhauer, A. E. Goldfeld, J. Lieberman, N. Barteneva, A. E. Carpenter, H. Hennig, Trends Biotechnol. 2018, 36, 649.
[45] N.-K. Chlis, L. Rausch, T. Brocker, J. Kranich, F. J. Theis, Nucleic Acids Res. 2020, 48, 11335.
[46] Y. Zhou, A. Yasumoto, C. Lei, C.-J. Huang, H. Kobayashi, Y. Wu, S. Yan, C.-W. Sun, Y. Yatomi, K. Goda, Elife 2020, 9, e52938.
[47] M. Doan, J. A. Sebastian, J. C. Caicedo, S. Siegert, A. Roch, T. R. Turner, O. Mykhailova, R. N. Pinto, C. McQuin, A. Goodman, Proc. Natl. Acad. Sci. 2020, 117, 21381.
[48] H. Kobayashi, C. Lei, Y. Wu, C.-J. Huang, A. Yasumoto, M. Jona, W. Li, Y. Wu, Y. Yalikun, Y. Jiang, B. Guo, C.-W. Sun, Y. Tanaka, M. Yamada, Y. Yatomi, K. Goda, Lab Chip 2019, DOI 10.1039/C8LC01370E.
[49] H. Kobayashi, C. Lei, Y. Wu, A. Mao, Y. Jiang, B. Guo, Y. Ozeki, K. Goda, Sci. Rep. 2017, 7, DOI 10.1038/s41598-017-12378-4.
[50] Y. Belotti, C. T. Lim, Anal. Chem. 2021, 93, 4727.
[51] G. Pegoraro, T. Misteli, Trends Genet. 2017, 33, 604.
[52] S. Ziegler, S. Sievers, H. Waldmann, Cell Chem. Biol. 2021, 28, 300.
[53] N. Nitta, T. Sugimura, A. Isozaki, H. Mikami, K. Hiraki, S. Sakuma, T. Iino, F. Arai, T. Endo, Y. Fujiwaki, H. Fukuzawa, M. Hase, T. Hayakawa, K. Hiramatsu, Y. Hoshino, M. Inaba, T. Ito, H. Karakawa, Y. Kasai, K. Koizumi, S. W. Lee, C. Lei, M. Li, T. Maeno, S. Matsusaka, D. Murakami, A. Nakagawa, Y. Oguchi, M. Oikawa, T. Ota, K. Shiba, H. Shintaku, Y. Shirasaki, K. Suga, Y. Suzuki, N. Suzuki, Y. Tanaka, H. Tezuka, C. Toyokawa, Y. Yalikun, M. Yamada, M. Yamagishi, T. Yamano, A. Yasumoto, Y. Yatomi, M. Yazawa, D. Di Carlo, Y. Hosokawa, S. Uemura, Y. Ozeki, K. Goda, Cell 2018, 175, 266.
[54] A. A. Nawaz, M. Urbanska, M. Herbig, M. Nötzel, M. Kräter, P. Rosendahl, C. Herold, N. Toepfner, M. Kubánková, R. Goswami, Nat. Methods 2020, 1.

We claim:

1. A microfluidic device for focusing polydisperse particles suspended in a particle-carrying fluid, comprising:
a fluidic channel configured to localize distributions of the polydisperse particles in a cross-sectional area of the fluidic channel.

2. The microfluidic device of claim 1, wherein the fluidic channel is formed to have either a plurality of high aspect ratio (HAR) symmetric orifice structures connected in series by HAR rectangular structures, or a plurality of high aspect ratio (HAR) alternating asymmetric orifice structures connected in series by HAR rectangular structures.

3. The microfluidic device of claim 2, wherein dimensions of the fluidic channel are configured such that a converging secondary flow having four spiral vortices is generated.

4. The microfluidic device of claim 3, wherein each of the spiral vortices drives the polydisperse particles to flow inward following a spiral path to be concentrated into a center of the spiral vortex such that the polydisperse particles are focused by the converging secondary flow without any inertial force.

5. The microfluidic device of claim 1, wherein the fluidic channel has a length between 1 mm and 100 mm.

6. The microfluidic device of claim 1, wherein the polydisperse particles have diameters ranging from 6 μm to 40 μm.

7. The microfluidic device of claim 1, wherein the polydisperse particles are carried by a fluid flowing at a volumetric throughput ranging between 2.4 mL/hr and 30 mL/hr.

8. A high-throughput single-file focusing system for polydisperse particles suspended in a particle-carrying fluid, comprising:
the microfluidic device according to claim 1, for pre-focusing the polydisperse particles; and
an extended HAR rectangular structure coupled to the microfluidic device, receiving the pre-focused polydisperse particles and further confining the polydisperse particles to form a single file on a mid-plane of the extended HAR rectangular structure.

9. The high-throughput single-file focusing system of claim 8, wherein the dimensions of the microfluidic device and dimensions of the extended HAR rectangular structure are configured to have corresponding predetermined ratios.

10. The high-throughput single-file focusing system of claim 8, wherein a focusing efficiency greater than 95% is obtained.

11. A system for continuous particle filtration/enrichment, comprising:
a high-throughput single-file focusing device for polydisperse particles suspended in a particle-carrying fluid comprising:
a microfluidic structure for pre-focusing the polydisperse particles comprising a fluidic channel configured to localize distributions of the polydisperse particles in a cross-sectional area of the fluidic channel; and
an extended HAR rectangular structure coupled to the microfluidic structure for pre-focusing, receiving the pre-focused polydisperse particles and further confining the polydisperse particles to form a single file on a mid-plane of the extended HAR rectangular structure;
wherein the high-throughput single-file focusing device comprises a plurality of outlets coupled in-series to control resistance ratios between the outlets.

12. The system for continuous particle filtration/enrichment of claim 11, wherein the high-throughput single-file focusing device is configured to deplete a mixture of microspheres of a monodisperse sample and a polydisperse sample.

13. The system for continuous particle filtration/enrichment of claim 12, wherein the monodisperse sample includes particles having a diameter of about 6 μm.

14. The system for continuous particle filtration/enrichment of claim 12, wherein the polydisperse sample has particles having diameters ranging between 6 μm and 30 μm.

15. The system for continuous particle filtration/enrichment of claim 12, wherein a filtration efficiency of about 97.5% and a filtration efficiency of about 97.4% are obtained for the monodisperse sample and the polydisperse sample, respectively.

16. A system for in-depth particle analysis, comprising:
a high-throughput single-file focusing device for polydisperse particles suspended in a particle-carrying fluid; and
an imaging flow cytometry coupled with the high-throughput single-file focusing device;
wherein the high-throughput single-file focusing device comprises:
a microfluidic structure for pre-focusing the polydisperse particles comprising a fluidic channel configured to localize distributions of the polydisperse particles in a cross-sectional area of the fluidic channel; and
an extended HAR rectangular structure coupled to the microfluidic structure for pre-focusing, receiving the pre-focused polydisperse particles and further confining the polydisperse particles to form a single file on a mid-plane of the extended HAR rectangular structure.

17. The system for in-depth particle analysis of claim 16, wherein the particles include five types of human cells, including peripheral blood mononclear cells (PBMCs), a leukemia cell line (HL60), two types of lung cancer cell line (H1975, H2170) and a breast carcinoma (MB231).

18. The system for in-depth particle analysis of claim 17, wherein sizes of the cells of the samples range from 5 μm to 30 μm.

19. The system for in-depth particle analysis of claim 17, wherein the cells have heterogenty of size both among cell types and within each cell type.

20. The system for in-depth particle analysis of claim 19, wherein five probability distributions of the cell sizes have means ranging from 7.5 μm to 15.9 μm with corresponding standard deviations (STDs) ranging from 0.9 μm to 2.2 μm.

21. A microfluidic device for achieving a targeted particle distribution for dispersion-free inertial focusing (DIF) of polydisperse particles, comprising:
a HAR orifice structure configured to create a secondary vortex flow with a plurality of converging spiraling vortices, each of the converging spiraling vortices being at a perspective one of each quadrant of the orifice structure.

22. The microfluidic device of claim 21, wherein the HAR symmetric orifice structure is configured to create a pinching effect.

23. The microfluidic device of claim 21, wherein the HAR symmetric orifice structure is optimized by maximizing a repetition frequency such that the secondary flow outruns an inertial force to make zoning effects absent or minimized.

24. The microfluidic device of claim 21, wherein the polydisperse particles are pinched by the secondary vortex flow along long walls of a channel of the HAR symmetric orifice structure.

25. The microfluidic device of claim 21, wherein the particle distribution is shaped and localized outside a residual zone of the channel of the HAR rectangular channel.

26. The microfluidic device of claim 21, wherein the dispersion of the particle distribution is automatically compressed by the downstream inertial focusing to form a single-file DIF of polydisperse particles, free from dispersion.

27. The microfluidic device of claim 21, wherein the particles have an average diameter in a range between 6 μm and 30 μm.

28. The microfluidic device of claim 21, wherein a flow carrying the particles has an average flow rate in a range between 2.4 mL/hr and 30 mL/hr.

29. The microfluidic device of claim 21, wherein the HAR orifice structure is a symmetric structure.

30. The microfluidic device of claim 21, wherein the HAR orifice structure is an asymmetric structure.

31. The microfluidic device of claim 21, wherein a particle focusing efficiency in DIF is quantified by a parameter, loss, which is defined as a ratio of out-of-focus particles to the total number of particles.

32. The microfluidic device of claim 31, wherein the loss of the DIF system is quantified to be about 1.5±2% (mean±standard deviation (std)) across all particle sizes.

33. The microfluidic device of claim 31, wherein the loss of the HAR straight channel is about high as 12±13.9%.

34. The microfluidic device of claim 31, wherein the loss is decreased when particle sizes are larger.

35. A single-file dispersion-free inertial focusing (DIF) system of polydisperse particles, comprising a plurality of the microfluidic devices of claim 21 cascaded to an inlet of a HAR rectangular straight channel with an identical cross-section.
